(19) United States
(12) Patent Application Publication
(10) Pub. No.: US 2010/0021871 A1
(43) Pub. Date: Jan. 28, 2010

(54) TEACHING READING COMPREHENSION

(76) Inventors: Terrence V. Layng, Seattle, WA (US); Victoria Ford, Seattle, WA (US); Marta E. Leon, Seattle, WA (US); Hirofumi Shimizu, Seattle, WA (US); Melinda S. Sota, Seattle, WA (US); Janet S. Twyman, New York, NY (US)

Correspondence Address: FENWICK & WEST LLP, SILICON VALLEY CENTER, 801 CALIFORNIA STREET, MOUNTAIN VIEW, CA, 94041, US

(21) Appl. No.: 12/509,387

(22) Filed: Jul. 24, 2009

Related U.S. Application Data
(60) Provisional application No. 61/083,345, filed on Jul. 24, 2008.

(51) Int. Cl. G09B 17/00

(52) U.S. Cl. 434/178

(57) ABSTRACT

A creation system and method for creating routines for teaching comprehension are described. The system identifies the skill to be taught, determines one or more features for the identified skill and determines a sequence of routines based on the determined one or more features. A performance system and method for performing the determined routines are also described. The performance system identifies the skill to be taught, determines the sequence of routines for the skill and presents the sequence to the learners. The performance system also provides feedback to the learners for their responses and modifies the sequence of routines based of the learners' responses.

### CROSS REFERENCE TO RELATED APPLICATIONS

This application claims priority under 35 U.S.C. §119(e) from U.S. Provisional Patent Application No. 61/083,345, titled “System and Method for Teaching and Testing Comprehension,” filed Jul. 24, 2008, which is incorporated by reference herein in its entirety.

### BACKGROUND OF THE INVENTION

1. Field of Art

The disclosure generally relates to the field of educational techniques. More particularly, the disclosure relates to systems and methods for teaching reading comprehension.

2. Description of the Related Art

Reading and reasoning are among the fundamental skills required in the information age. For example, to navigate the digital world, one must be able to read with a significant level of comprehension, and those who do not read and understand well risk not benefiting or advancing in society. Therefore, providing high-quality instruction to all children is a priority, but is often difficult or time-consuming to accomplish practically and efficiently.

Again, using reading as an example, traditional classroom instruction, under the direction of an instructor, typically takes weeks and months to teach children how to read. These traditional methods require the teacher interact extensively with the child, in order to give the child feedback on what to read, indicate whether words are being spoken correctly or incorrectly, keep the child motivated to keep reading, etc. Thus, it is the teacher, rather than the child, who does the listening, evaluating and correcting. These are among the many reasons why traditional teaching methods are inefficient, time-consuming and cumbersome.

Other reasons why these traditional teaching methods are not fully effective for individuals (both children and adults) include problems due to lack of retention/understanding/comprehension and moving to later subject matter before the individual has fully mastered previous subject matter. Most individuals learn at different paces, but classroom instructions are typically conducted at a single pace. The relation between the response that a learner makes during learning and the feedback that the learner receives is very inexact in group instructions. Children who are slower learners must keep up with the group or risk falling behind in the learning process. Conversely, children who learn faster than the pace of the classroom instruction risk getting bored or disinterested.

Some “on line” courses or instructions modules (e.g. videotapes, audio tapes, software packages etc.) are available outside of a traditional classroom setting to teach individuals certain subjects. These non-traditional techniques are typically used to supplement traditional class-room instructions and/or provide instructions where traditional classroom instructions may not otherwise be available or practical.

However, many of these courses or modules assume certain fundamental learning skills, such as reading, and involve an instructor who reviews assignments and gives feedback. In some cases, feedback is not even available. In others, the learners have to wait for the instructor to review their work and give them feedback. Moreover, the instructor may not be able to provide feedback to each learner as the class size grows in number. Consequently, the students without feedback are slow to gain reading comprehension skills.

Another problem with both traditional classroom instructions and on-line courses is the lack of practice opportunities to master a given repertoire. This is due in part because traditional classroom instructions and on-line courses are tailored towards a group or towards a uniform teaching style, rather than being tailored and specific to the needs of a particular individual. It simply is not efficient or cost effective for these teaching methods to deviate from the norm/pace and provide practice opportunities that are specifically suited for a particular individual: an on-line course module is mass-produced for a general population and is too expensive to include individually customized practice routines; and traditional classroom instruction does not have the time during a school year to provide sufficient customized in-class practice for each individual and instead depends on the individual to practice, if at all, via “homework.”

### SUMMARY OF THE INVENTION

The present invention includes a system and method for creating routines to teach one or more comprehension skills. The present invention also includes a system and method for performing routines to teach one or more comprehension skills. Examples of comprehension skills include literal comprehension skills, inferential comprehension skills, vocabulary skills and summative skills. Additional examples of comprehension skills include using a map, a diagram or a ruler.

The creation system comprises a skill identifier module, an initial analysis module and a routine sequencing module. The skill identifier module determines the skill to be taught to the learner. In one embodiment, the skill identifier module receives the skill through a user interface. In another embodiment, the skill identifier module retrieves the skill from a pre-configured list.

The initial analysis module receives the determined skill and identifies various features for the skill. In one embodiment, the initial analysis module comprises a critical feature identifier module and a varying feature identifier module. The critical feature identifier module determines one or more critical features for the received skill. The varying feature identifier module determines one or more varying features for the received skill. The initial analysis module determines a critical feature and/or a varying feature for the received skill through its critical feature identifier module and/or the varying feature identifier module.

The one or more determined features are transmitted to the routine sequencing module. The routine sequencing module determines one or more sequences of routines including one or more routines based on the received features. These sequences are then stored in a skill sequence database.

The performance system retrieves the stored sequences and presents them to the learner. The performance system comprises a skill identifier module, a routine sequence determination module, a controller and a feedback module. The skill identifier module determines the skill to be taught to the learner. The skill identifier module either receives the skill through a user interface or selects the skill from a predetermined list. The skill identifier module transmits the determined skill to the routine sequence determination module.

The routine sequence determination module receives the identified skill and determines a sequence of one or more routines for the received skill. In one embodiment, the routine sequence determination module retrieves the sequence from the skill sequence database.

The controller then transmits the one or more determined routines from the sequence for presentation to the learner. The learner responds to the routine and the learner's response is received by feedback module.

The feedback module receives the learner's response and determines if the received response is correct. The feedback module then transmits the feedback for the correct or incorrect response for presentation to the learner. In one embodiment, the feedback module also transmits its analysis of learner's response to the routine sequence determination module. The routine sequence determination module, after receiving the analysis, modifies the sequence of routines to be presented to the learner based on the received analysis.

### BRIEF DESCRIPTION OF THE DRAWINGS

The disclosed embodiments have other advantages and features which will be more readily apparent from the detailed description, the appended claims, and the accompanying figures (or drawings).

FIG. 1 illustrates a block diagram of an example system that can implement an embodiment of the invention.

FIG. 2 is a block diagram that illustrates the teaching server according to one embodiment of the present invention.

FIG. 3A is a block diagram that illustrates the creation module according to one embodiment of the present invention.

FIG. 3B is a block diagram that illustrates the execution module according to one embodiment of the present invention.

FIG. 4 is a flow chart that illustrates a method for creating a sequence of one or more routines for teaching various skills to a learner according to one embodiment of the present invention.

FIG. 5 is a flow chart that illustrates a method for teaching various skills to a learner according to one embodiment of the present invention.

FIG. 6A is a flow chart that illustrates the execution controller performing a routine (JB) teaching the learner to identify various types of questions according to one embodiment of the present invention.

FIG. 6B is a flow chart that illustrates another embodiment of execution controller performing a routine sequence for teaching various comprehension skills according to one embodiment of the present invention.

FIGS. 7A-B are a flow chart that illustrates the execution controller performing a routine (Qtf Prep) teaching literal comprehension skill according to one embodiment of the present invention.

FIG. 7C is a flow chart that illustrates the execution controller performing another routine (Qtf) designed to develop the learner's literal comprehension skill according to one embodiment of the present invention.

FIGS. 8A-B are a flow chart that illustrates the execution controller performing a routine (Qti Prep) designed to develop the learner's inferential comprehension skill according to one embodiment of the present invention.

FIGS. 8C-D are a flow chart that illustrates the execution controller performing another routine (Qti) designed to develop the learner's inferential comprehension skill according to one embodiment of the present invention.

FIGS. 9A-B are a flow chart that illustrates the execution controller performing a routine (Qtd Intro) designed to develop the learner's skill for differentiating between problems that require literal or inferential comprehension skills according to one embodiment of the present invention.

FIGS. 9C-D are a flow chart that illustrates the execution controller performing another routine (Qtd) designed to develop the learner's skill for differentiating between problems that require different comprehension skills according to one embodiment of the present invention.

FIG. 10A is a flow chart that illustrates the execution controller performing a routine (Qtd SV) designed to develop the learner's skill for differentiating between problems that require vocabulary or summative skills according to one embodiment of the present invention.

FIGS. 10B-C are a flow chart that illustrates the execution controller performing another routine (QtdC) designed to develop the learner's skill for differentiating between problems that require vocabulary, summative, literal or inferential comprehension skills according to one embodiment of the present invention.

FIG. 11A is a flow chart that illustrates the execution controller performing a first routine (Qts Prep Intro) designed to develop the learner's summative skill according to one embodiment of the present invention.

FIG. 11B is a flow chart that illustrates the execution controller performing a second routine (Qts Prep) designed to develop the learner's summative skill according to one embodiment of the present invention.

FIG. 11C is a flow chart that illustrates the execution controller performing a third routine (Qts Prep) designed to develop the learner's summative skill according to one embodiment of the present invention.

FIG. 11D is a flow chart that illustrates the execution controller performing a fourth routine (Qts Prep) designed to develop the learner's summative skill according to one embodiment of the present invention.

FIG. 11E is a flow chart that illustrates the execution controller performing a fifth routine (Qts) designed to develop the learner's summative skill according to one embodiment of the present invention.

FIGS. 12A-B are a flow chart that illustrates the execution controller performing a first routine (Qtn Prep) designed to develop the learner's vocabulary skill according to one embodiment of the present invention.

FIG. 12C is a flow chart that illustrates the execution controller performing a second routine (Qtn) designed to develop the learner's vocabulary skill according to one embodiment of the present invention.

FIG. 12D is a flow chart that illustrates the execution controller performing a third routine (Qv) designed to develop the learner's vocabulary skill according to the present invention.

FIG. 13A is a flow chart that illustrates the execution controller performing a first word game routine (WG2) designed to develop the learner's vocabulary skill according to one embodiment of the present invention.

FIGS. 13B-C are a flow chart that illustrates the execution controller performing a second word game routine (WG3) designed to develop the learner's vocabulary skill according to one embodiment of the present invention.

FIGS. 13D-E are a flow chart that illustrates the execution controller 352 performing a routine (SE) designed to develop learner's vocabulary skills through associated illustrations and definitions according to one embodiment of the present invention.

FIGS. 14A-B are a flow chart that illustrates the execution controller performing a first routine (Qdc4) designed to develop the learner's skill for differentiating between various comprehension problems and addressing the problem using one of the learner's comprehension skills according to the present invention.

FIGS. 14C-D are a flow chart that illustrates the execution controller performing a second routine (Qdc4C) designed to develop the learner's skill for differentiating between various comprehension problems and addressing the problems using the learner's comprehension skills according to one embodiment of the present invention.

FIG. 15A is a flow chart that illustrates the execution controller performing a third routine (Qdc5) designed to develop the learner's skill for addressing comprehension problems using the learner's comprehension skills according to one embodiment of the present invention.

FIG. 15B is a flow chart that illustrates the execution controller performing a fourth routine (Qdc5C) designed to develop the learner's skill for addressing comprehension problems using the learner's comprehension skills according to one embodiment of the present invention.

FIG. 15C is a flow chart that illustrates the execution controller performing a fifth routine (Qdc6) designed to develop the learner's skill for addressing comprehension problems using the learner's comprehension skills according to one embodiment of the present invention.

FIGS. 15D-E are a flow chart that illustrates the execution controller performing a sixth routine (Qdc7) designed to develop the learner's skill for addressing comprehension problems using the learner's comprehension skills according to one embodiment of the present invention.

FIG. 16A is a flow chart that illustrates the execution controller performing a routine (Rintro or RRintro) designed to teach the learner about using a table of contents, a ruler or a diagram according to one embodiment of the present invention.

FIGS. 16B-C are a flow chart that illustrates the execution controller performing another routine (R) designed to teach a learner about using the table of contents according to one embodiment of the present invention.

FIG. 16D is a flow chart that illustrates the execution controller performing a routine (RM Intro) designed to teach the learner about using a map according to one embodiment of the present invention.

FIG. 17 is a flow chart that illustrates a method for analyzing learner data according to one embodiment of the present invention.

FIG. 18 is a flow chart that illustrates the execution controller performing a routine (Vocab3 or Vocab4) designed to develop a learner's vocabulary skills including pronunciation skills according to one embodiment of the present invention.

FIGS. 19-45C are examples of various stimulus sets used in one or more routines designed to develop a learner's comprehension skills according to one embodiment of the present invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

A system and method for teaching reading comprehension are described. The figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

As used herein any reference to “one embodiment,” “an embodiment,” or “some embodiments” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

Also, some embodiments of the invention may be further divided into logical modules. One of ordinary skill in the art will understand that these modules can be implemented in hardware, firmware and/or software. In one embodiment, the modules are implemented in form of computer instructions stored in a computer readable medium when executed by a processor cause the processor to implement the functionality of the module. Additionally, one of ordinary skill in the art will recognize that a computer or another machine with instructions to implement the functionality of one or more logical modules is not a general purpose computer. Instead, the machine is adapted to implement the functionality of a particular module. Moreover, the machine embodiment of the invention physically transforms the electrons representing the images from one state to another in order to attain the desired images.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Moreover, the specification describes a learner or a user responding to a query or a stimulus set and the teaching system receiving learner's responses. A person of ordinary skill in the art will understand that the learner responds to a query or a stimulus set through a teaching client. An example of the teaching client is a module in a computing device or a computing device configured to perform functions of a teaching client. The learner uses an input device communicatively coupled to the teaching client like a keyboard or a mouse to response to such queries or stimulus sets. The teaching client then transmits the learner's response to appropriate module.

### System Overview

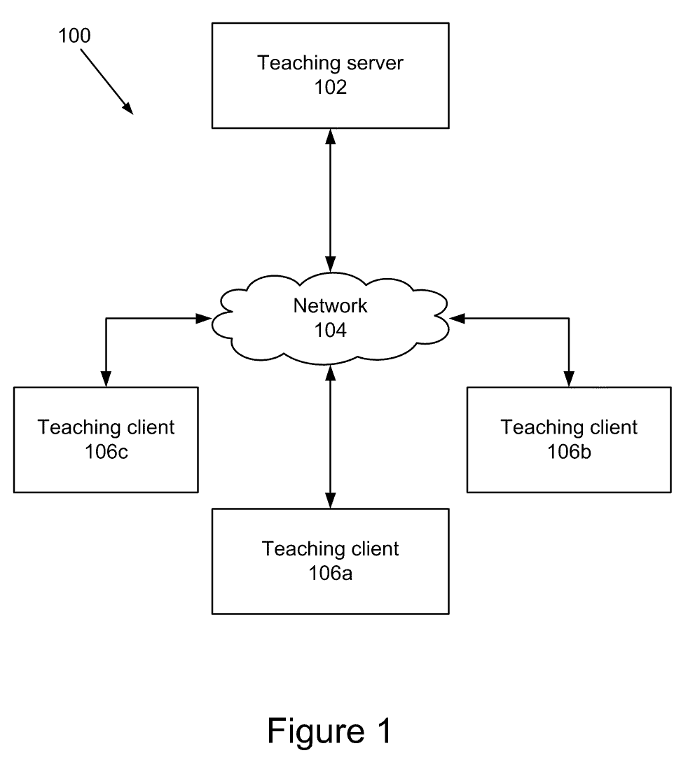

Referring now to FIG. 1, an embodiment of the teaching system 100 comprises: a teaching provider 102, a network 104 and teaching clients 106a-c (generically referred to as teaching client 106). FIG. 1 illustrates a configuration of three clients. One of ordinary skill in the art will understand that the number of clients can vary from one to many. The teaching server 102 is coupled communicatively to the network 104. The teaching clients 106a-c are also communicatively coupled to the network 104.

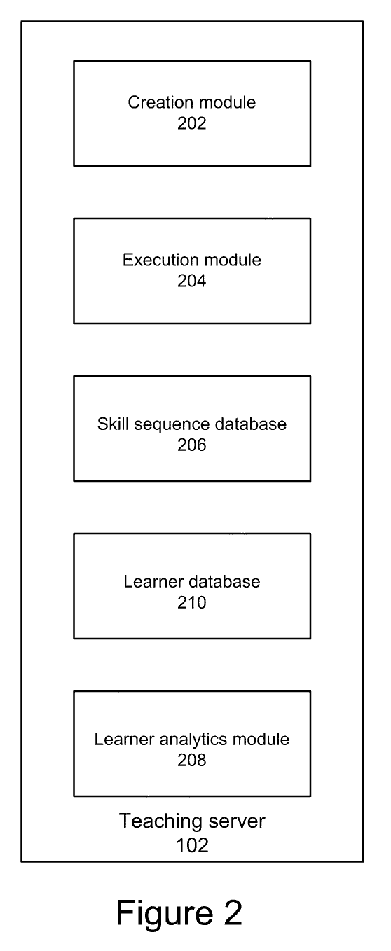

The teaching server 102 can perform any variety of service operations depending on its hardware, software and connectivity. The service operations of the teaching server 102 include but are not limited to creating teaching routines, executing created teaching routines, transmitting instructions to the teaching clients 106a-c according to the executed teaching routines etc. A teaching server 102 is any device with the software running on it (or hardware integrated as part of it) to create and/or execute teaching routines described below. In one embodiment, the teaching server 102 is a hardware server as depicted in FIG. 2. The teaching server 102 is adapted for communication, interaction and cooperation with the teaching client 106.

The teaching client 106 is software operating on a computing device, a hardware module in a computing device, or a blend of software and hardware, and may have any level of computing capability. In one embodiment, the teaching client 106 is a personal computer with an operating system and a browser operable thereon. The personal computer is communicatively coupled to the network 104 such as by an Ethernet card using TCP/IP communication protocol. The teaching client 106 is any client that is designed to communicate with teaching server 102 and perform the steps described in the methods below. The teaching client 106 and the teaching server 102 communicate with each other to teach a learner various comprehension skills by generating and displaying various user interfaces in various routines.

One of ordinary skill in the art will understand that the teaching system 100 is one embodiment of the claimed system that implements the claimed methods. In another embodiment, the teaching server 102 creates the teaching routines and populates the accompanying database with the required data. The teaching routines and the data can then be stored on a computer readable storage medium and transferred to the teaching clients 106a-c through the computer readable storage medium. In such an embodiment, the teaching client 106 need not be communicatively coupled to network 104 and the teaching client can retrieve instructions for the teaching routines through the computer readable storage medium.

FIG. 2 is a block diagram that illustrates the teaching server 102 according to the present invention. The teaching server 102 comprises a creation module 202, an execution module 204, a skill sequence database 206, a learner analytics module 208 and a learner database 210.

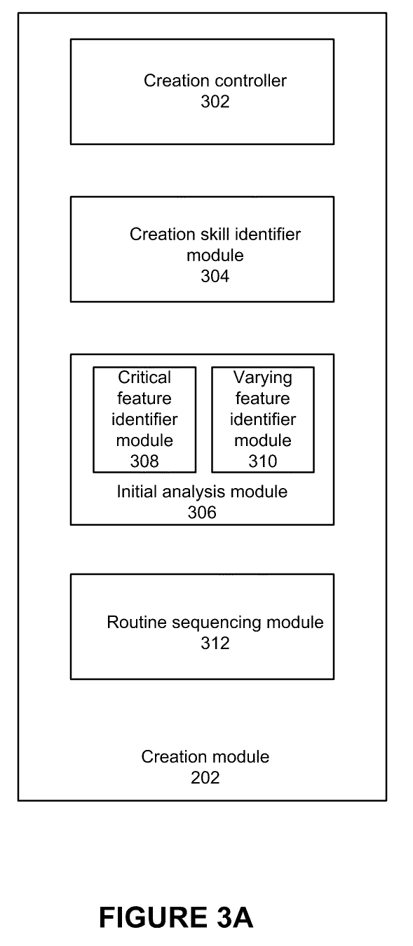

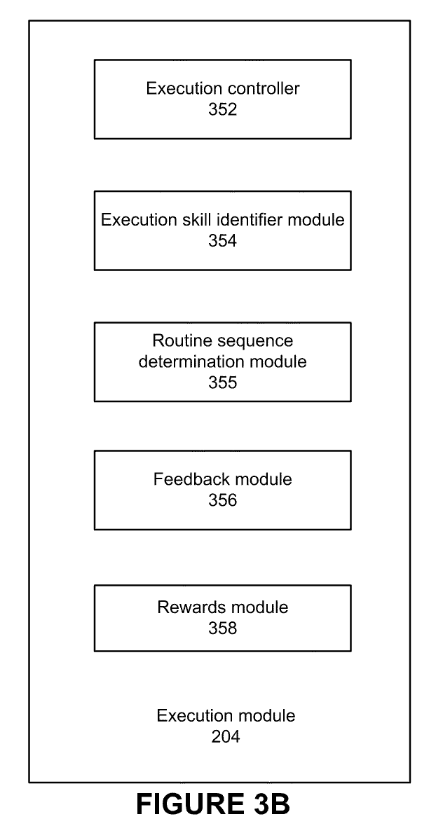

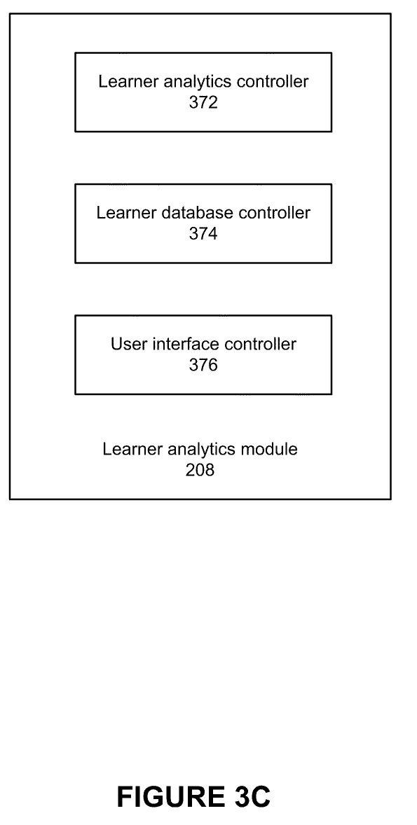

The creation module 202 is configured to create the routine sequences comprising one or more routines to teach various comprehension skills to the learner. The creation module 202 is communicatively coupled to skill sequence database 206 and stores the created routine sequences in skill sequence database 206. In one embodiment, the creation module 202 transmits the skill sequence to execution controller instead of storing the skill sequence in the skill sequence database 206. In such an embodiment, the creation module 202 is communicatively coupled to execution module 204. The creation module 202 is described in detail below with reference to FIG. 3A.

The execution module 204 is configured to execute the routine sequences to teach various comprehension skills to the learner. The execution module 204 is communicatively coupled to skill sequence database 206 and learner database 210. The execution module 204 retrieves for execution the routine sequences from skill sequence database 206 and stores learner's responses to the skill sequence in learner database 210. The execution module 204 is described in detail below with reference to FIG. 3B.

The skill sequence database 206 stores various routine sequences used to teach a learner various comprehension skills. The skill sequence database 206 is communicatively coupled to creation module 202 and execution module 204. The skill sequence database 206 is stored on a persistent or non-persistent storage.

The learner database 210 stores information about various learners responding to the routines and the stored information is used by learner analytics module 208 to analyze the stored data. The learner database 210 is communicatively coupled to execution module 204 and learner analytics module 208. The learner database stores one or more categories of data from the following: learner's id, learner's name, learner's age, learner's sex, various routines presented to the learner, stimulus sets in the routines, passages or questions/answer choices in the presented stimulus sets, critical and/or varying features associated with the presented stimulus set, learner's responses to the stimulus set, the number of trials it took the learner to answer a stimulus set question correctly and whether the learner answered the question correctly without being directed through the analytical steps for determining the answer.

The learner analytics module 208 is configured to analyze data in learner database 210 and the learner analytics module 208 is communicatively coupled to learner database 210. The analysis can be used to inform the educators about the progress of a learner or create or edit stimulus sets better suited for teaching a particular skill. In one embodiment, the learner analytics module 208 transmits its analysis to execution controller 352 and the execution controller 352 adds one or more stimulus sets to a routine based on the received analysis. The learner analytics module 208 is further described in FIG. 3C below.

FIG. 3A is a block diagram that illustrates the creation module 202 according to the present invention. The creation module 202 comprises a creation controller 302, a skill identifier module 304, an initial analysis module 306 and a routine sequence module 312.

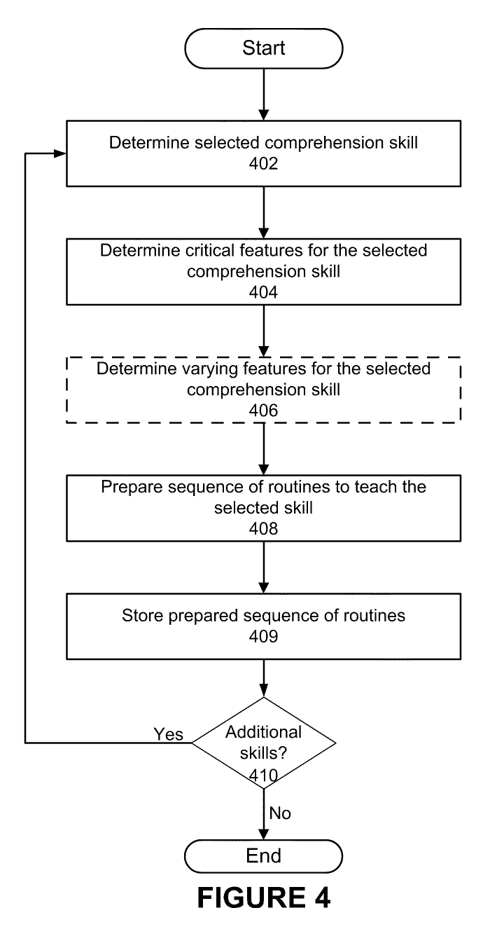

The creation controller 302 is configured to direct other modules in creation module 202 to execute their respective tasks at the appropriate time. Accordingly, the creation controller 302 is communicatively coupled to all other modules in creation module 302. Additionally, the creation controller 302 is communicatively coupled to skill sequence database 206 to store routines created by creation module 202 into the skill sequence database 206. In one embodiment, the creation module 202 is communicatively coupled to execution module 204 to transmit the created routines to the execution module 204. The functions of creation controller 302 are described below in FIG. 4.

The creation skill identifier module 304 is configured to identify the skill that is to be taught to the learner. The creation skill identifier module 304 is communicatively coupled to creation controller 302. Examples of skills to be taught include literal comprehension, inferential comprehension, summative deduction and vocabulary building. In one embodiment, the creation skill identifier module 304 receives the skill to be taught to the learner from the creation controller 302 or through a user interface. In another embodiment, the creation skill identifier module 304 is configured to identify a series of skills in a pre-determined order. For example, the skill identifier module 202 can first identify literal comprehension and after the routine sequence for literal comprehension is built, the creation skill identifier module 304 can next identify the inferential comprehension skill. The creation skill identifier module 304 can keep identifying skills until routine sequences for all the skills have been built.

The initial analysis module 306 is communicatively coupled to creation controller 302 and determines the critical features and varying features for a particular skill. These identified features are later used to build a routine sequence that is aimed to teach the skill to the learner. The initial analysis module 306 comprises a critical feature identifier module 308 and a varying feature identifier module 310.

The critical feature identifier module 308 identifies one or more critical features for an exercise that must be present in the exercise to develop the skill being taught. For example, a critical feature for exercises developing literal comprehension is that the answer for a passage in the exercise must appear in its corresponding passage. An example list of critical features required for various skills is included in Appendix A. It should be noted that all of the critical features listed for a particular skill need not be present in the exercise. For example, the invention may present positive or negative instances or both for a comprehension skill. A positive instance has all of the critical features of the relevant skill. A negative instance lacks one or more of the critical features for that skill. The critical feature identifier module 308 receives a critical feature for a skill through a user interface. In one embodiment, the critical feature identifier module 308 is pre-configured with various critical features associated with a particular skill and the critical feature identifier module 308 identifies critical features for a skill from its pre-configured list.

The varying feature identifier module 310 identifies features that vary for different exercises used to develop the skill being taught. For example, a varying feature for exercises developing literal comprehension skill is the length of the passage accompanying the exercise. The passage can be one or more paragraphs long and the length of the passage can vary from one exercise to another. A list of varying features required for various skills is included in appendix A. The varying feature identifier module 310 receives varying features for a skill through a user interface. In one embodiment, the varying feature identifier module 310 is pre-configured with various varying features associated with a particular skill and the varying feature identifier module 310 identifies varying features for a skill from its pre-configured list.

The routine sequencing module 312 is configured to identify sequence of routines based on the identified critical features and varying features for various skills. The routine sequencing module 312 is communicatively coupled to creation controller 302. In one embodiment, the routine sequencing module 312 also identifies sequence of routines based on the preceding sequence of skills being taught. For example, the routine sequencing module 310 can create a list of one or more routines to teach literal comprehension followed by a list of one or more routines to teach inferential comprehension. Examples of routine sequences are included in Appendix B.

FIG. 3B is a block diagram that illustrates the execution module 204. The execution module 204 comprises an execution controller 352, an execution skill identifier module 354, a routine sequence determination module 355, a rewards module 356 and a feedback module 358.

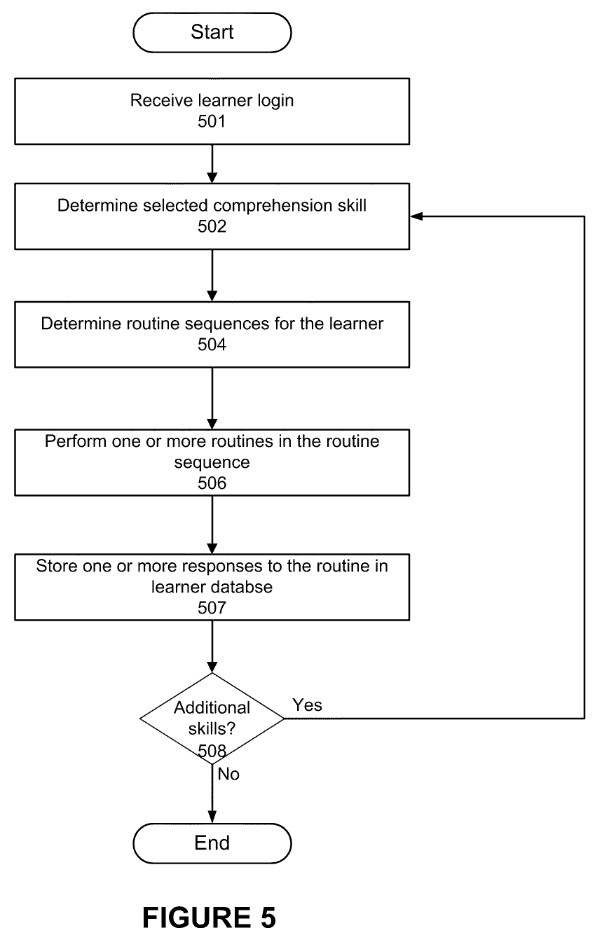

The execution controller 352 is configured to direct other modules in execution module 204 to execute their respective tasks at the appropriate time. Accordingly, the program execution controller 352 is communicatively coupled to all other modules in execution module 204. Additionally, the execution controller 352 is communicatively coupled to skill sequence database 206 for retrieving various routines for teaching the learner. Moreover, the execution controller 352 is communicatively coupled to the teaching client 106 for transmitting various responses to teaching client 106 and receiving the learner's responses to the transmitted routines. In one embodiment, the execution controller 352 receives the routines from creation module 302 and the execution controller 352 is communicatively coupled to the creation module 202. The functions of execution controller 352 are described below in FIGS. 5-15D.

The execution skill identifier module 354 is configured to identify the skill to be taught to the learner and the execution skill identifier module 354 is communicatively coupled to execution controller 352. In one embodiment, the execution skill identifier module 354 receives the skill to be taught to the learner from the execution controller 352 or through a user interface. In another embodiment, the execution skill identifier module 354 is configured to identify a series of skills in a pre-determined order. The execution skill identifier module 354 can keep identifying skills until routine sequences for all the skills have been rendered for a learner. In one embodiment, the execution skill identifier module 354 identifies the skill to be taught to a learner based on the feedback received from the feedback module 356.

The routine sequence determination module 355 is communicatively coupled to the execution controller 352. In one embodiment, the routine sequence determination module 355 is also communicatively coupled to the feedback module 356. The routine sequence determination module 355 is configured to identify a sequence of routines for an identified skill. In one embodiment, the routine sequence determination module 355 is also configured to receive feedback regarding the learner's skill level from the feedback module 356. The routine sequence determination module 355 changes the sequence of routines or adds to the sequence of routines based on the received feedback.

The feedback module 356 is communicatively coupled to execution controller 352 and teaching client 106. In one embodiment, the feedback module 356 is also communicatively coupled to the routine sequence determination module 355. The feedback module 356 is configured to receive learner's responses to one or more queries in a routine, determine if the learner has correctly answered a threshold number of queries for a skill and then provide appropriate feedback to the routine sequence determination module 355. For example, if a threshold for a certain skill is providing correct answers for a minimum of two queries, the feedback module can collect a learner's answers and determine if the learner has answered at least two queries correctly. If not, the feedback module 356 can signal to routine sequence determination module 355 that the learner has not mastered the associated skill and the routine sequence determination module 355 can edit the sequence of skills to be presented to the learner or add additional routines to the routine sequence. Additionally, the feedback module 356 can direct the teaching client 106 to provide visual and audio feedback to the learners regarding their response. For example, the feedback module can present the learners with visual and/or audio feedback informing the learners their answer was correct or incorrect and the reasons why their answer was correct or incorrect. In this manner, the feedback module 356 provides the feedback to the learners and directs the routine sequence determination module 355 in providing a learner with routines tailored to grow the learner's skill set.

The rewards module 358 is configured to store and update a learner's reward points when the feedback module 356 receives a correct or incorrect answer from the learner. The rewards module 358 is communicatively coupled to execution controller 352. The rewards module 358 stores the learner's reward points in a persistent or non-persistent memory (not shown) within the rewards module 358. Alternatively, the rewards module stores the learner's reward points in a rewards points database (not shown). The reward points database is stored in a persistent or non-persistent memory. The rewards module 358 increases the learner's reward points when the feedback module 356 receives a correct answer from the learner. The rewards module 358 either decreases or leaves the reward points unchanged when the feedback module 356 receives an incorrect answer from the learner. In one embodiment, the rewards module 358 increases reward points by increasingly larger increments as the learner answers multiple questions correctly. In yet another embodiment, the feedback module 356 indicates the status of the learner's rewards to the learner.

FIG. 3C is a block diagram that illustrates the learner analytics module 208. The learner analytics module 208 comprises learner analytics controller 372, learner database controller 374 and user interface controller 376.

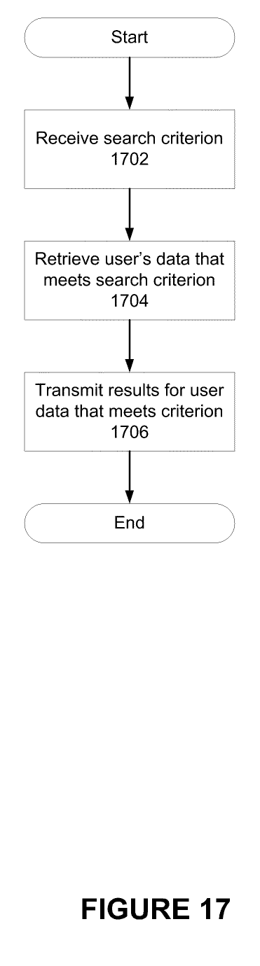

The learner analytics controller 372 is communicatively coupled to learner database controller 374 and user interface controller 376. The learner analytics controller 372 is configured to direct other modules in learner analytics module 208 to execute their respective tasks at the appropriate time. The functions of learner analytics controller 372 are described below in FIG. 17.

The database controller 374 is communicatively coupled to learner analytics controller 372 and learner database 210. The database controller 374 manages data in learner database 210 and performs various queries on the data. For example, the database controller 374 can query learner database 210 for percentage of learners that answered correctly on their first try a question in a routine with certain critical or varying features.

The user interface controller 376 is communicatively coupled to learner analytics controller 372 and a client machine displaying the user interfaces prepared by user interface controller 376. The user interface controller 376 communicates with a user through various user interfaces. The user interface controller 376 prepares user interfaces to receive queries from a user and display the results of the query to the user.

### Method Overview

FIG. 4 is a flow chart that illustrates a method for creating a sequence of one or more routines for teaching various skills to a learner according to the present invention. The creation controller 302 queries the creation skill identifier module 304 and the creation skill identifier module 304 determines 402 the skill to be taught to the learner. The creation controller 302 receives the identified skill, directs the critical feature identifier module 308 and the critical feature identifier module 308 determines 404 one or more critical features for exercises teaching the identified skill. Next, the creation controller 302 optionally directs the varying feature module 310 to determine 406 the varying features for exercises teaching the identified skill. The creation controller 302 then transmits the identified one or more critical features and optionally identified one or more varying features to routine sequencing module 312. Consequently, the routine sequencing module 312 prepares 408 a sequence of one or more routines based on the received one or more critical features and optionally received one or more varying features. The creation controller 302 then stores 409 the created sequence in skill sequence database 206. In one embodiment the creation controller 302 transmits the created skill sequence directly to execution module 204.

The creation controller 302 next determines 410 if sequence for additional skills should be prepared. In one embodiment, the creation controller 302 receives signal through a user interface indicating if sequences for additional skills should be prepared. In another embodiment, the creation controller 302 queries the creation skill identifier module 304 to determine if any additional skills remain in its pre-configured list. In either case, if there are additional remaining skills, steps 402-410 are repeated for those skills. Otherwise, the sequence of routines is completed and the sequence creation method ends.

FIG. 5 is a flow chart that illustrates a method for executing a sequence of one or more routines for teaching various skills to a learner according to the present invention. A learner logs into the teaching system 100 through a teaching client 106. The execution controller 352 receives the login information and stores the login information in the learner database 210. The execution controller 352 next determines 502 the skill to be taught to a learner by querying the execution skill identifier module 354 for the skill. The execution skill identifier module 354 either receives the skill through a user interface, selects the last skill that was being taught to the user before the user suspended the teaching system 100, or the first skill from a pre-determined list. In any case, the execution skill identifier module 354 transmits the selected or received skill to the execution controller 352.

The execution controller 352 transmits the received skill to the routine sequence determination module 355 and queries 504 the routine sequence determination module 355 for a sequence of routines corresponding to the skills. The routine sequence determination module 355 queries the skill sequence database 206 for corresponding routines created by creation module 202. The routine sequence determination module 355 selects a sequence of one or more corresponding routines from the skill sequence database 206 and returns the selected sequence to execution controller 352.

The execution controller 352 then performs 506 the routine sequence. In one embodiment, the execution controller 352 stores 507 in learner database 210 the stimulus sets presented to the learner during the routine sequence. The execution controller 352 also stores the learner's responses to the stimulus sets in the learner database 210. In another embodiment, the execution controller 352 also populates various other data categories in learner database 210 based on the presented stimulus sets and received responses during the routine. The execution controller 352 next queries the execution skill identifier module 354 and determines 508 if additional skills are to be taught to the learner. If yes, the execution controller 352 repeats steps 502-508 for the additional skill. If not, the method illustrated in FIG. 5 ends.

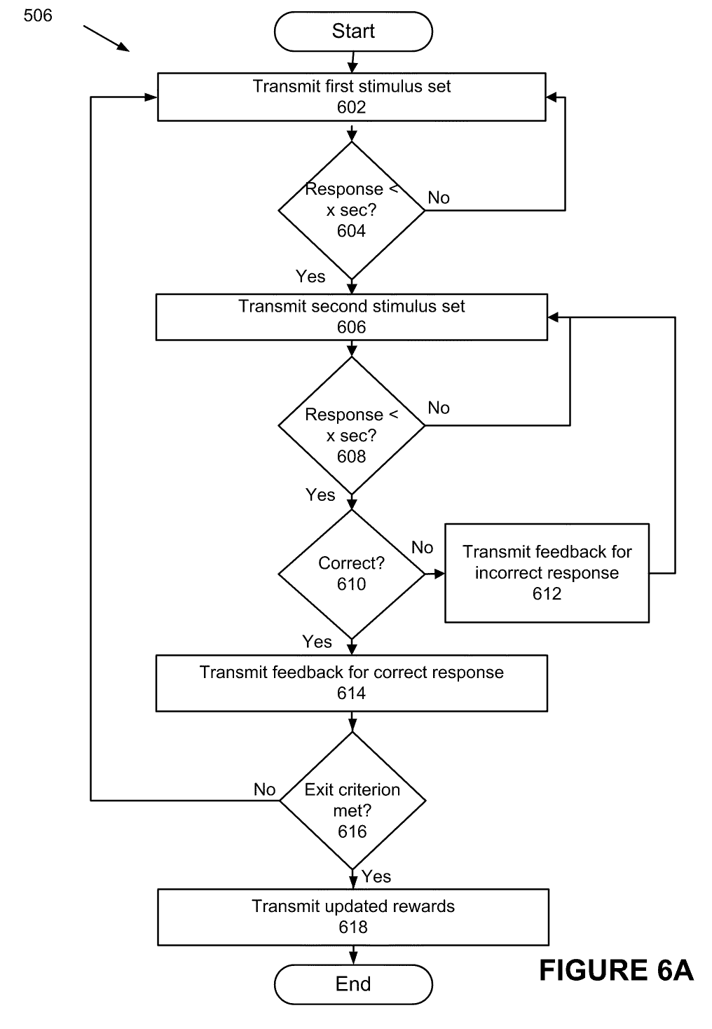

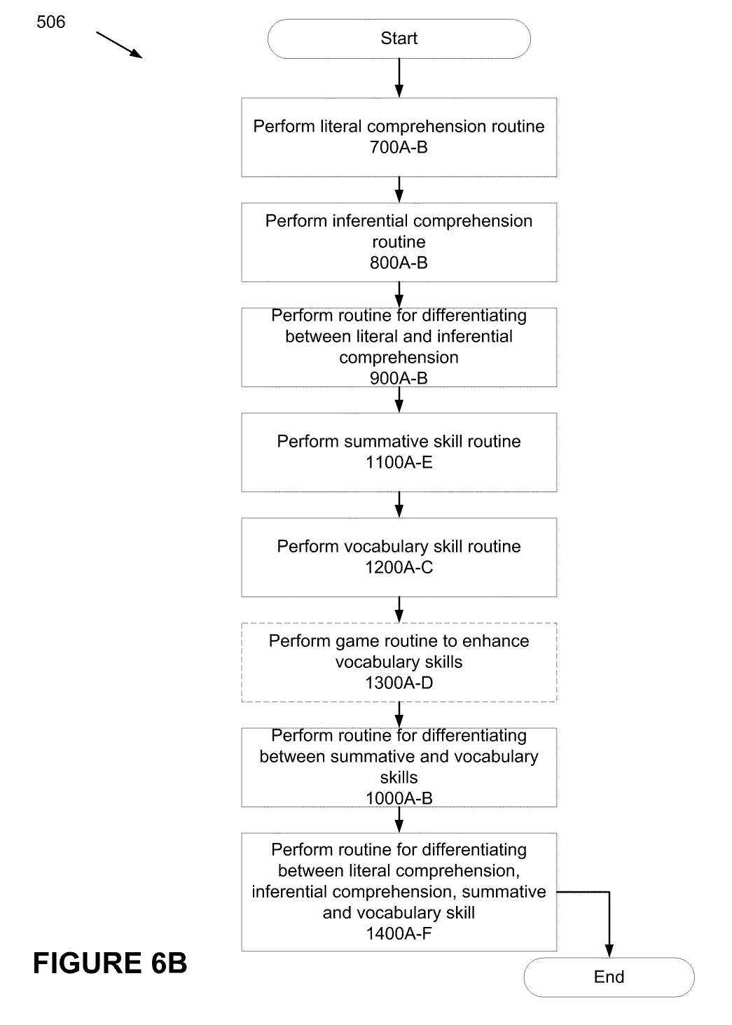

FIG. 6A is a flow chart that illustrates one embodiment of the execution controller 352 performing 506 a routine teaching the learner to identify various types of questions presented to the learner. The execution controller 352 transmits 602 a first stimulus set to the teaching client 106 and directs the teaching client 106 to present the first stimulus set to the learner. The stimulus set can include a passage, a question, answer sets, and/or icons. The stimulus set can be presented in multiple ways. For example, a passage stimulus can include plain text, grayed text, bold text, underlined text, italic text, glowed or highlighted text and/or colored text. Additionally, the presented stimulus set is chosen based on certain critical features or varying features. For example, the execution controller 352 can initially present the learner with a passage that only has one paragraph and the paragraph has few lines. As the learner correctly responds to the initial stimulus sets, stimulus sets with different critical features and/or varying features that may increase the difficulty level of the sequence can be presented to the learner. For example, at a later stage, the learner can be presented with a passage with three paragraphs.

Additionally, the stimulus set can include visual or audio instructions directing the learner to take appropriate action. For example, the instructions can direct the learner to select an icon after the learner has read the passage included in the stimulus set.

After transmitting the first stimulus set, the execution controller 352 determines if it has received the learner's response to the stimulus within a predetermined amount of time (e.g. x seconds). If not, the execution controller 352 repeats steps 602-604.

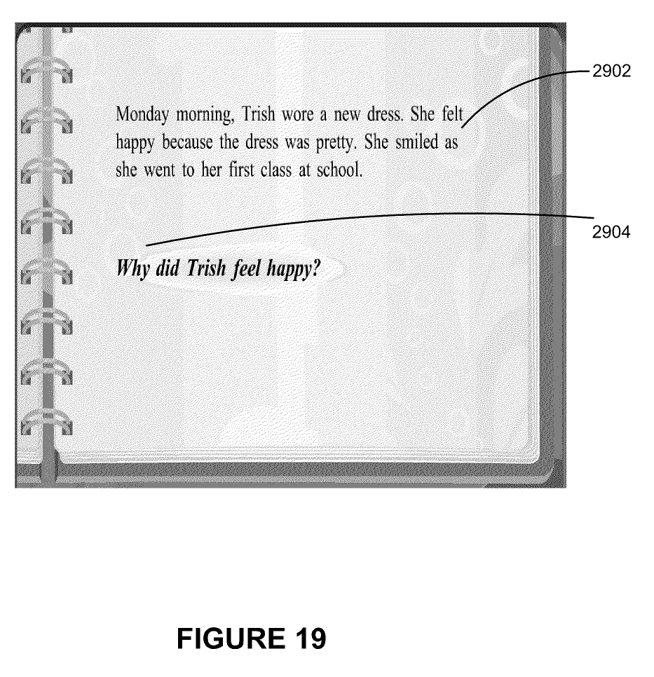

FIG. 19 is an example of the first stimulus set transmitted at step 602. The first stimulus set in FIG. 19 includes passage 2902 and question 2904. The first stimulus set also includes audio or visual instructions (not shown) informing the learner about the question asked. For example, the instructions can inform the learner that “the question asks why something happened. The ‘why’ questions ask for a reason.” The instructions then direct the learner to select the question 2904 after the learner has read the passage 2902 and question 2904. If the learner does not select the question 2904 within a predetermined time, the instructions again direct the learner to select the question 2904.

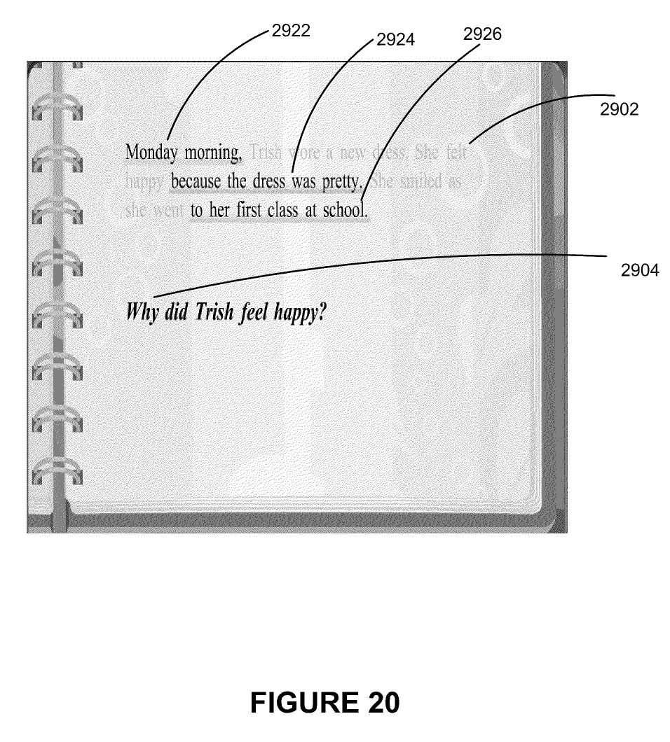

Referring to FIG. 6A, after the execution controller 352 receives the learner's response, the execution controller 352 transmits 606 a second stimulus set to the teaching client 106 and directs the teaching client 106 to present the second stimulus set. Referring to FIG. 20, the second stimulus set, for example, includes passage 2902, question 2904, and highlighted sentences 2922, 2924, 2926. The second stimulus set also includes audio or visual instructions (not shown) that direct the learner to read the question and select the highlighted part of the passage that corresponds to the question.

The execution controller 352 then determines 608 if the learner's response to second stimulus set is received in a pre-determined amount of time. If not, the execution controller 352 again transmits 606 the second stimulus set to the teaching client 106 and/or directs the teaching client 106 to present the second stimulus set to the learner.

If the learner's response is received, the execution controller 352 queries the feedback module 356 and determines 610 if the learner correctly answered the question presented in the second stimulus set. If not, the execution controller 352 directs the feedback module 356 to transmit 612 feedback for the incorrect answer to the teaching client 106. The feedback can include visual and/or audio instructions informing the learner that the learner answered the question incorrectly and/or the reasons why the learner's answer is incorrect. Moreover, at step 612, in addition to feedback for the incorrect answer, the execution controller 352 adds another stimulus set to the routine that comprises passage/question/instructions of the same type as the current passage/question/instructions in the first stimulus set and second stimulus set. These additional sets are later used in step 616 as described below.

After the feedback is transmitted, the execution controller 352 again transmits 606 the second stimulus to teaching client 106 and/or directs the teaching client 106 to present the second stimulus to the learner again. The execution controller 352 then repeats steps 608, 610, 612, 606 and 608 until the received learner's answer is the correct answer.

If the learner correctly answers the question, the execution controller 352 directs the feedback module 356 to transmit 614 feedback for the correct answer to the teaching client 106. The feedback can include visual and/or audio instructions informing the learner that the learner answered the question correctly and/or the reasons why the learner's answer is correct.

The execution controller 352 then determines 616 if the exit criterion for routine of FIG. 6 has been met. The exit criterion can be based on error rate, percentage of correct responses, percentage of completed routines, time factors, number of consecutive correct response or a combination of above mentioned factors. An example exit criterion can be receiving a correct answer for every type of question (when, where, what, why, who and how). If the exit criterion is not met, the execution controller 352 repeats steps 602-616 with another stimulus set. This additional stimulus set is either the stimulus set added at step 612 or a stimulus set for a question type not presented earlier. If the exit criterion is met, the execution controller 352 updates rewards based on the received learner's responses, transmits 618 the updated rewards to the teaching client 106 and directs the teaching client 106 to present the updated rewards to the learner. The rewards keep the learner engaged in the routine and encourages learner to respond to various stimulus sets correctly.

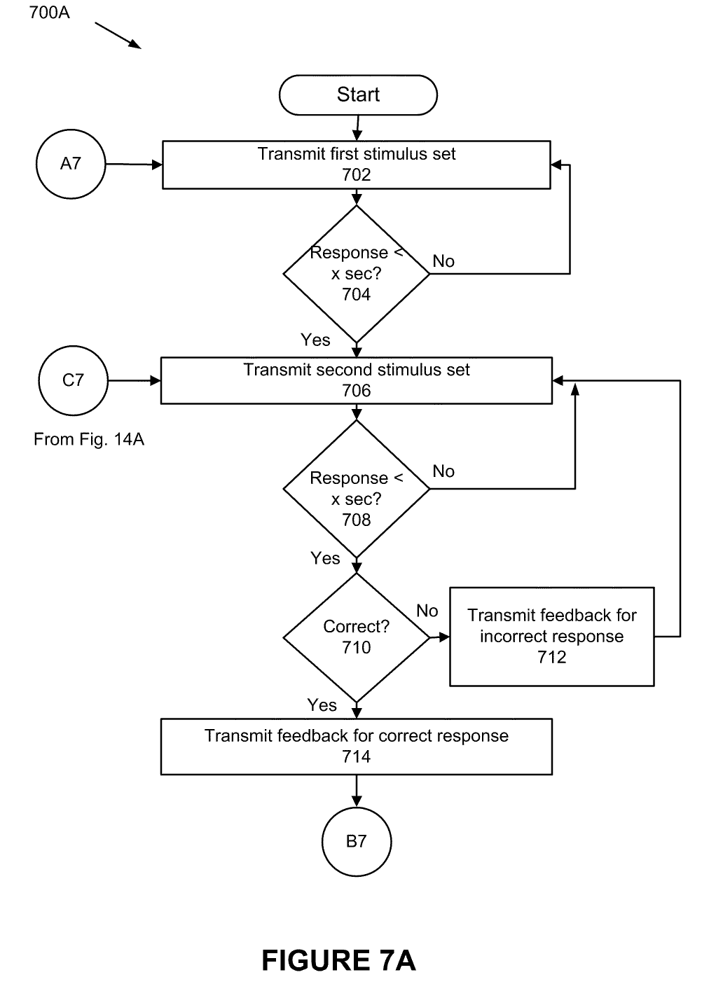

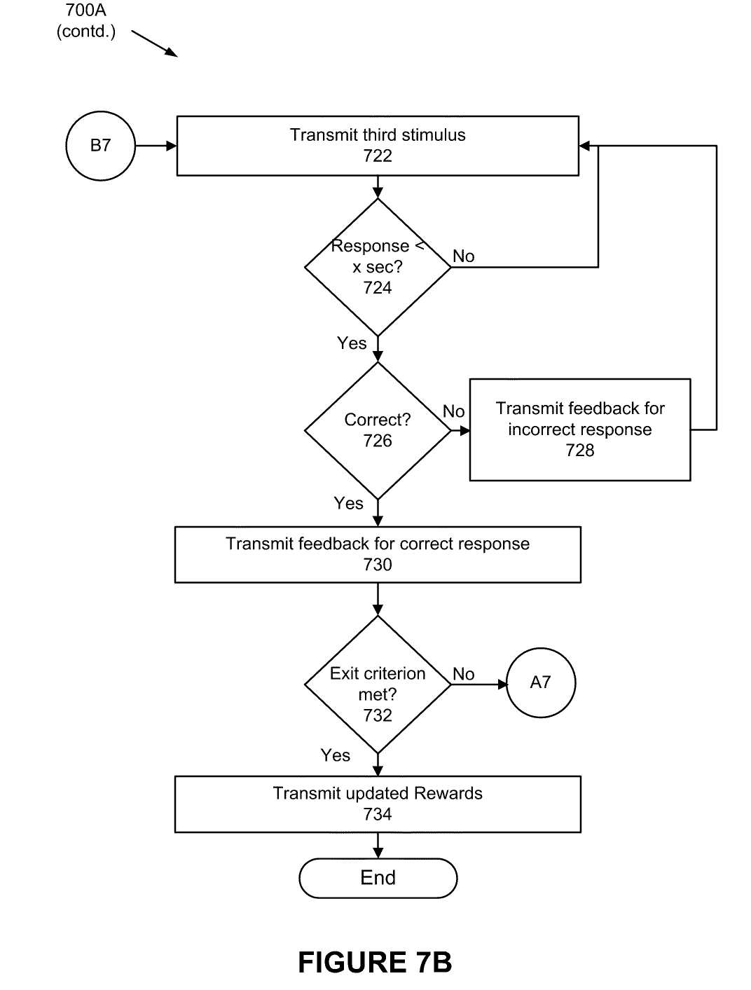

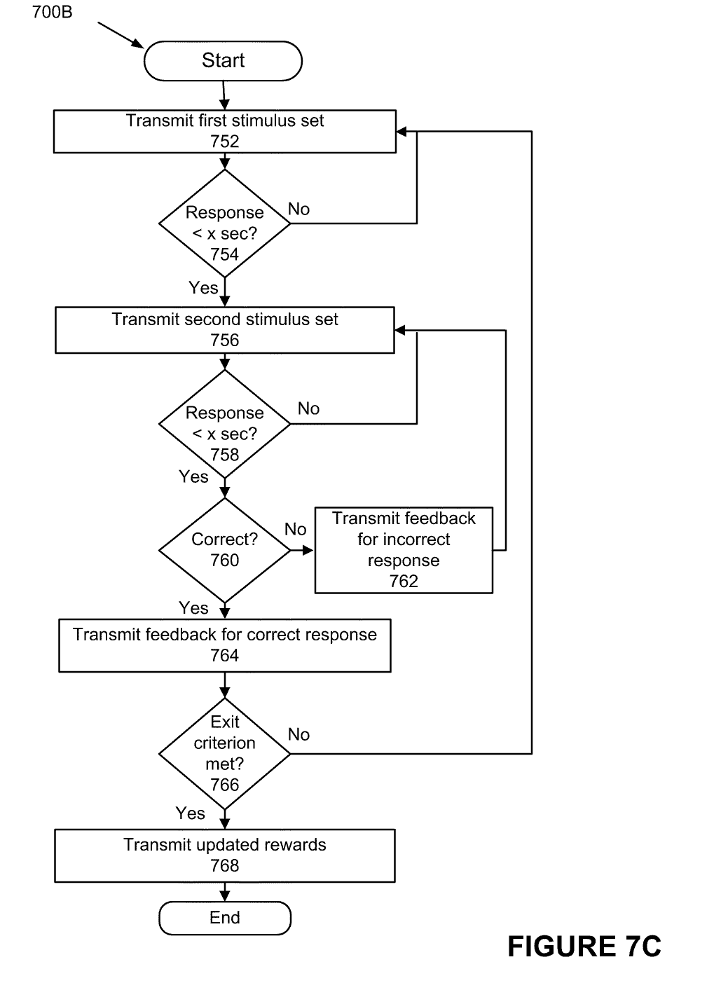

FIG. 6B is a flow chart that illustrates another embodiment of execution controller 352 performing 506 a routine sequence for teaching various comprehension skills. The execution controller 352 performs 700A-B one or more routines for teaching literal comprehension and then performs 800A-B one or more routines for inferential comprehension. Next, the execution controller 352 performs 900A-B one or more routines teaching how to differential between questions requiring literal comprehension and inferential comprehension skills. Subsequently, the execution controller 352 performs 1100A-E one or more routines for teaching summative skill and then performs 1200A-C one or more routines for teaching vocabulary skills. Next, the execution controller 352 optionally performs 1300A-D one or more game routines to enhance a learner's vocabulary skills. The execution controller 352 then performs 1000A-B one or more routines teaching how to differentiate between questions requiring summative skills and vocabulary skills. Eventually, the execution controller 352 performs 1400A-F one or more routines teaching how to differentiate between questions requiring literal comprehension, inferential comprehension, vocabulary and summative skills. These routines are described in FIGS. 7A-16D below.

FIGS. 7A-B are a flow chart that illustrates the execution controller 352 performing 700A a routine teaching the learner literal comprehension skill. The execution controller 352 transmits 702 a first stimulus set to the teaching client 106 and directs the teaching client 106 to present the first stimulus set to the learner.

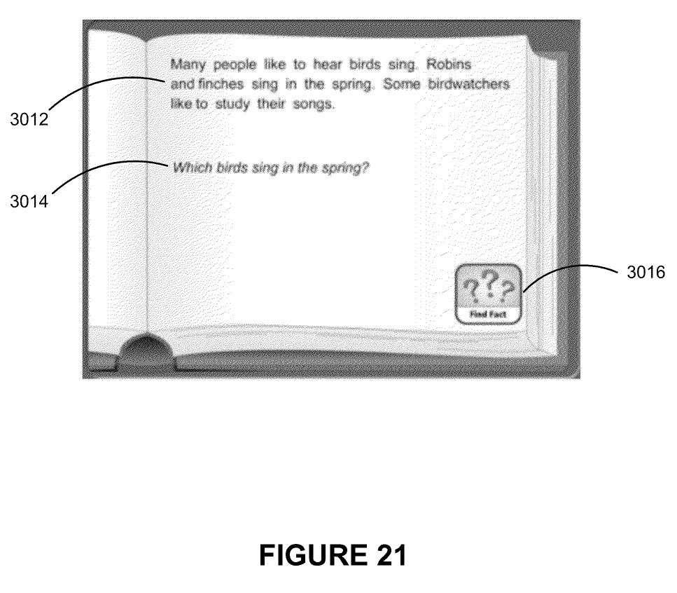

FIG. 21 is an example of the stimulus set transmitted in step 702. In this example, the stimulus set includes a passage 3012, a question 3014, a find fact icon 3016 and audio or visual instructions (not shown). The passage 3012 includes one paragraph with three lines and presents the learner with at least three facts (one in each line of the passage) and the question 3014 queries the learners to locate a particular fact present in the passage 3012. The stimulus set also includes instructions (not shown) asking the learner to select the find fact icon 3016 after the learner has read passage 3012 and question 3014.

Referring to FIG. 7A again, after transmitting 702 the first stimulus set, the execution controller 352 waits to receive the learner's response from the teaching client 106. In the example stimulus set of FIG. 21, the expected learner's response would be selection of find fact icon 3016. Accordingly, the execution controller 352 in that example waits for learner's selection of the find fact icon 3016. Next, the execution controller 352 determines 704 if the learner's response is received in a pre-determined amount of time. If not, the execution controller 352 again transmits 702 and directs the teaching client 106 to present the first stimulus set. In one embodiment, the teaching client retains the previously transmitted stimulus set and therefore the execution controller 352 does not transmit the stimulus set again and only directs the teaching client 106 to present the stimulus set.

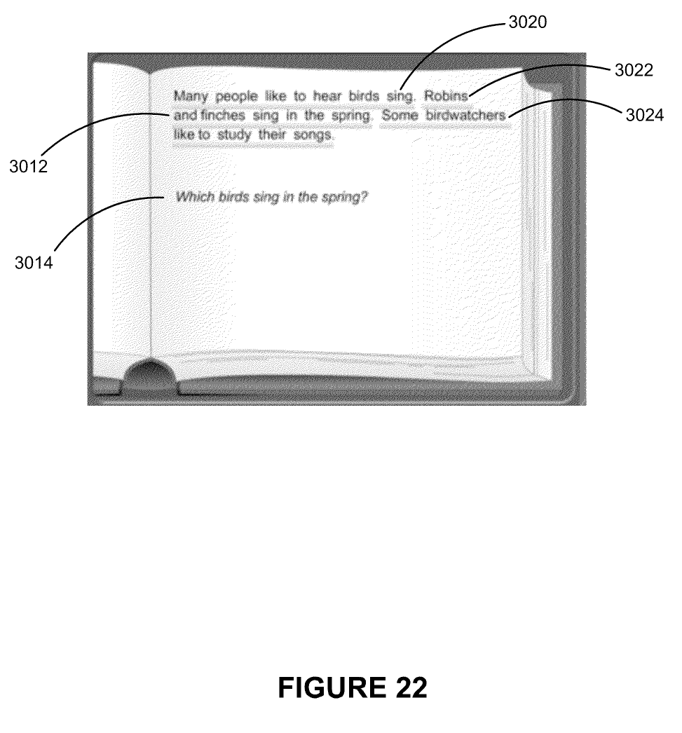

If the execution controller 352 does receive the response, the execution controller 352 transmits 706 the second stimulus set to the teaching client 106 and directs the teaching client 106 to present the second stimulus set. Referring to FIG. 22, the second stimulus set, for example, includes the passage 3012 and question 3014 from FIG. 21. However, the sentences 3020-3024 in passage 3012 are now highlighted to indicate different facts presented in the passage. The accompanying instructions in this second stimulus set direct the learner to select one of the highlighted sentences 3020-3024 that includes the fact that answers question 3014.

The execution controller 352 then determines 708 if the learner's response to second stimulus set is received in a pre-determined amount of time. If not, the execution controller 352 again directs the teaching client 106 to present 706 the second stimulus set.

If the learner's response is received, the execution controller 352 queries the feedback module 356 and determines 710 if the learner correctly answered the question presented in the second stimulus set. If not, the execution controller 352 directs the feedback module 356 to transmit 712 feedback for the incorrect answer to the teaching client 106. The feedback can include visual and/or audio instructions informing the learner that the learner answered the question incorrectly and/or the reasons why the learner's answer is incorrect. After the feedback is transmitted, the execution controller 352 again transmits 706 the second stimulus to teaching client 106 and/or directs the teaching client 106 to present the second stimulus to the learner again. The execution controller 352 then repeats steps 708 and 710.

If the learner correctly answers the question, the execution controller 352 directs the feedback module 356 to transmit 714 feedback for the correct answer to the teaching client 106. The feedback can include visual and/or audio instructions informing the learner that the learner answered the question correctly and/or the reasons why the learner's answer is correct.

Referring to example in FIG. 22, the correct answer for the second stimulus is selection of line 3022. If line 3020 or line 3024 is selected, the feedback for incorrect answers is transmitted to the teaching client 106. If instead line 3022 is selected, the feedback for the correct answer is transmitted to the teaching client 106.

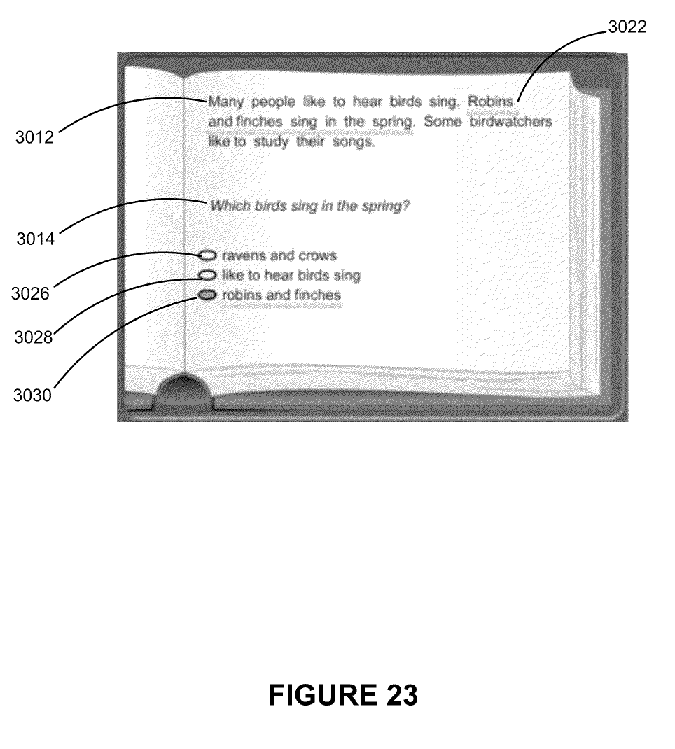

Referring to FIG. 7B, the execution controller 352 next transmits 722 a third stimulus to the teaching client 106. An example of third stimulus is depicted in FIG. 23. This third stimulus in FIG. 23 includes passage 3012, highlighted line 3022 that includes the facts for answering question 3014, question 3014 and three answer choices 3026-3030. As discussed earlier, the creation module 202 creates various routines with stimulus sets that include one or more critical or varying features. Here, the two incorrect answer choices 3026, 3028 include two or fewer critical features for literal comprehension. The answer choice 3026 includes only the second critical feature for literal comprehension exercises: the answer choice meets the criterion specified in the question. The answer choice 3028 includes two of the three critical features for literal comprehension exercises: the answer choice appears in the passage 3012 and the answer choice has topographic correspondence with passage text. However, answer choice 3028 does not include the third critical feature for literal comprehension because it does not meet the criterion specified in question. On the other hand, answer choice 3030 has all three of the above mentioned critical features and therefore answer choice 3030 is the correct answer.

After transmitting 722 the third stimulus set, the execution controller 352 executes steps 724-730. These steps are similar to others described above and entail: a) determining whether the learner responds within the predetermined time frame (724), b) determining whether the learner's response was correct (726), and c) transmitting the appropriate feedback for the correct or incorrect response, including feedback about why the incorrect response was incorrect with respect to one or more missing critical features (728 and 730). Even though the feedback may not be presented at each step of the exercise, the feedback directs the learner into developing an analytical framework like the one described in the paragraph above by noting which critical attribute is missing from the (incorrect) answer selected by the learners, where applicable. At step 728, in addition to feedback for the incorrect answer, the execution controller adds to the routine another passage/question/answer set of the same type as the current passage/question/answer set. This additional set is later transmitted as described below.

After transmitting 730 feedback for the correct answer, the execution controller 352 queries the feedback module 356 and determines 732 if the exit criterion for the exercise has been met. The exit criterion can be based on error rate, percentage of correct responses, percentage of completed routines, time factors, number of consecutive correct responses or a combination of above mentioned factors. An example of the exit criterion is receiving one correct answer for a problem with a particular varying feature, not preceded by an error.

If the exit criterion is not met, the execution controller 352 returns to step 702 of FIG. 7A and repeats steps 702-732. However, the stimulus sets have content from the passage/question/answer set added in response to the incorrect answer at step 728. Conversely, if the exit criterion is met, the execution controller 352 directs the rewards module 358 to update the reward points for the learner and transmits 734 for display the updated reward points to the teaching client 106.

FIG. 7C is a flow chart that illustrates the execution controller 352 performing 700B another routine designed to develop the learner's literal comprehension skill according to an embodiment of the present invention. This sequence, unlike the sequence illustrated in FIG. 7A-B, does not direct the learner through each step by highlighting various facts in the passage and having the learner select the fact that answers the question. Instead, this sequence assumes that the learner has developed that skill set. In one embodiment, the sequence illustrated in FIG. 7C is presented to the learner after the sequence illustrated in FIGS. 7A-B.

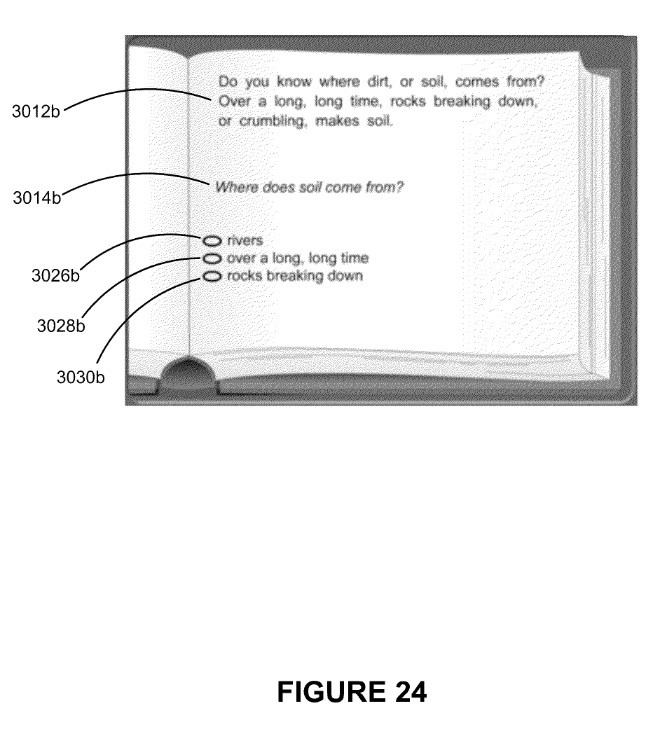

Referring to FIG. 7C, the execution controller 352 transmits 752 the first stimulus to the teaching client 106 and directs the teaching client 106 to present the first stimulus to the learner. An example of first stimulus set for this routine is illustrated in FIG. 24. The first stimulus, for example, can include passage 3012b, question 3014b and audio or visual instructions (not shown) directing the learner to select the find facts icon (not shown) in FIG. 24. The execution controller 352 then waits to receive the learner's response. If the response is not received 754 in a pre-determined amount of time the execution controller 352 again transmits and/or directs the teaching client 106 to present the first stimulus.

After a response is received, the execution controller 352 transmits 756 the second stimulus to the teaching client 106 and directs the teaching client 106 to present the second stimulus to the learner. The second, as illustrated in FIG. 24, for example, can include passage 3012b, question 3014b and answer choices 3026b-3030b. The answer choices in this sequence illustrate another difference between routine illustrated in FIG. 7C and routine illustrated in FIGS. 7A-B. The correct answer choice 3030b includes all three of the critical features: the answer appears in the passage, the answer meets the criterion specified in the question, and the answer does not have a one-to-one topographic correspondence with the words in the passage. The incorrect answer choice 3026b includes two critical features (it meets the criterion specified in the question and does not have a one-to-one topographic correspondence with the words in the passage), but lacks the first critical feature because it does not appear in the passage, and incorrect answer choice 3028b includes only one critical feature (the answer appears in the passage) but lacks the other two critical features. Accordingly, this routine teaches the learner to choose the answer with most critical feature if none of the answers have all of the critical features.

After transmitting 756 the second stimulus, the execution controller 352 performs steps 758-768. These steps are similar to steps 724-734 described in FIG. 7B.

FIGS. 7A-B and FIG. 7C illustrate two sequences for teaching literal comprehension. The two sequences help a learner develop literal comprehension skills by identifying the critical features present in the answer choices for the passages. One of ordinary skill in the art will understand that a variety of sequences can be developed by varying the number of critical features present in the answer choices or number of varying features present in the passage, question or the answer choices.

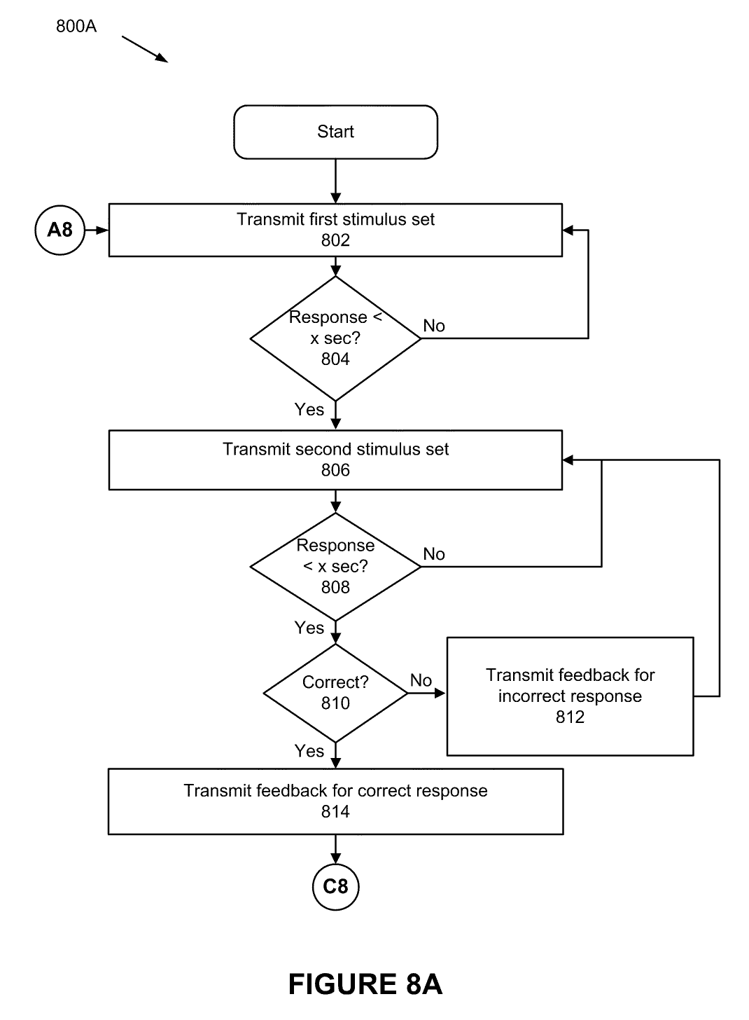

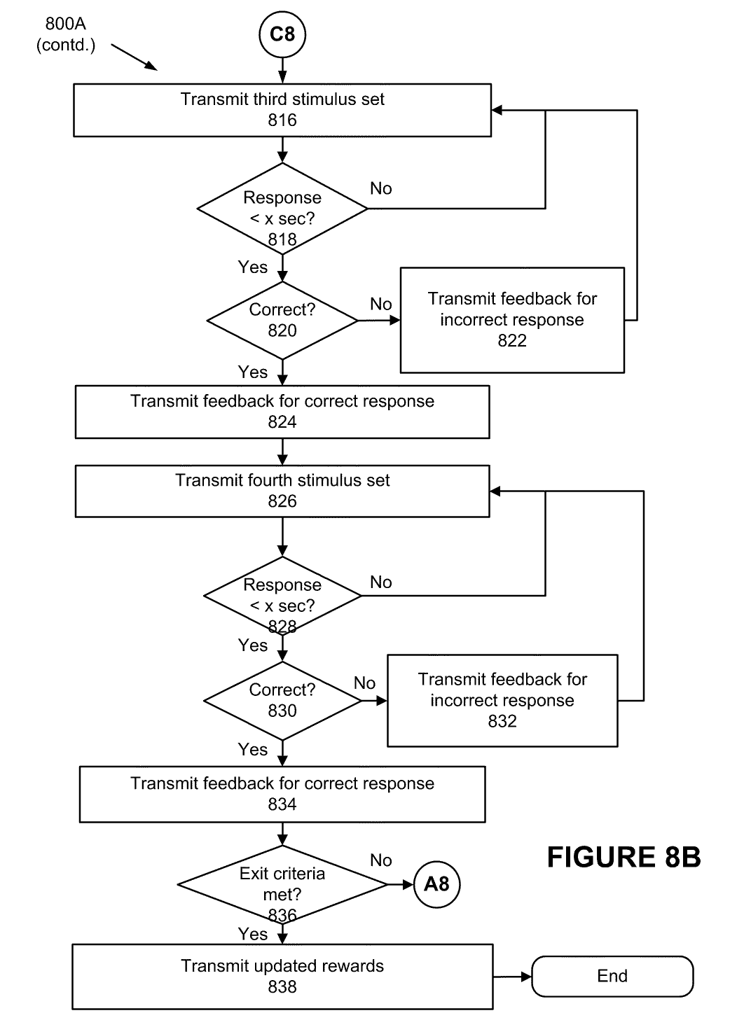

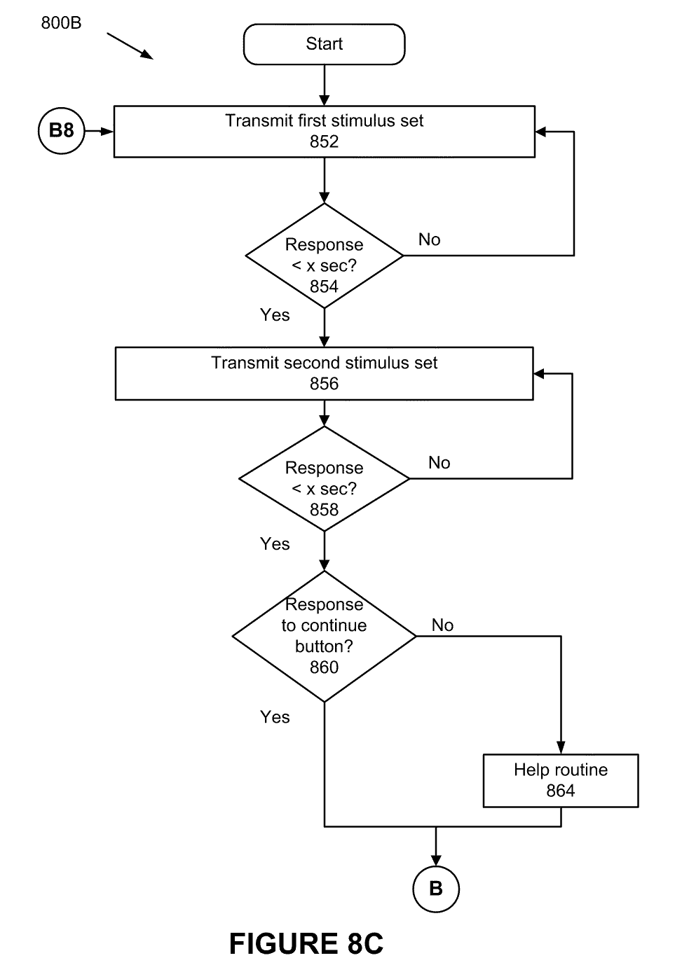

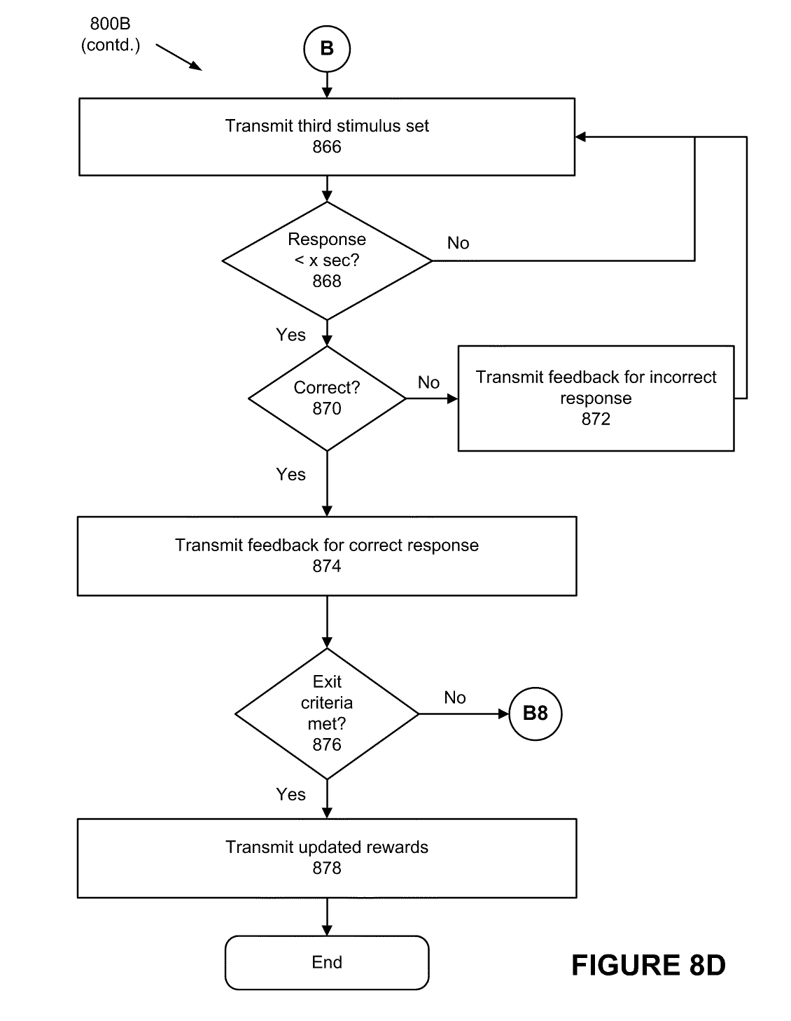

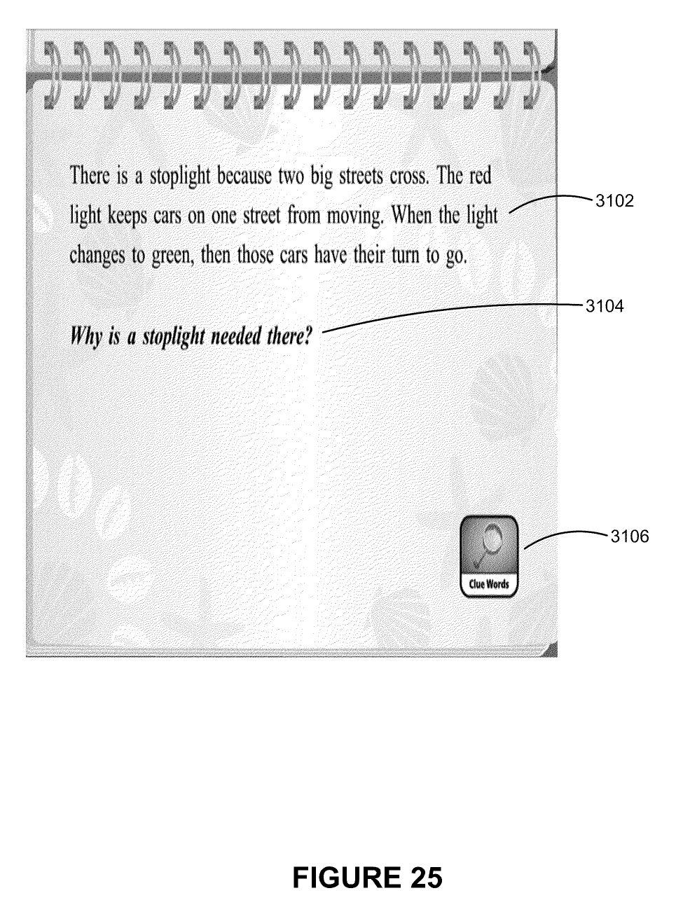

FIGS. 8A-B are a flow chart that illustrates the execution controller 352 performing 800A a routine designed to develop the learner's inferential comprehension skill according to an embodiment of the present invention. The execution controller 352 transmits 802 to the teaching client 106 a first stimulus set and directs the teaching client 106 to present the stimulus to the learner. The stimulus set can be presented to the learner visually and/or audibly. For example, in FIG. 25, the first stimulus set includes a passage 3102, a question 3104 and a find a clue word icon 3106.

The execution controller 352 then waits to receive a learner's response from the teaching client 106. In the example stimulus set of FIG. 25, the expected learner's response would be selection of the clue word icon 3106. Accordingly, the execution controller 352 in that example waits for learner's selection of the find a clue word icon. Next, the execution controller 352 determines 804 if the learner's response is received in a pre-determined amount of time. If not, the execution controller 352 again transmits 802 and/or directs the teaching client 106 to present the first stimulus set.

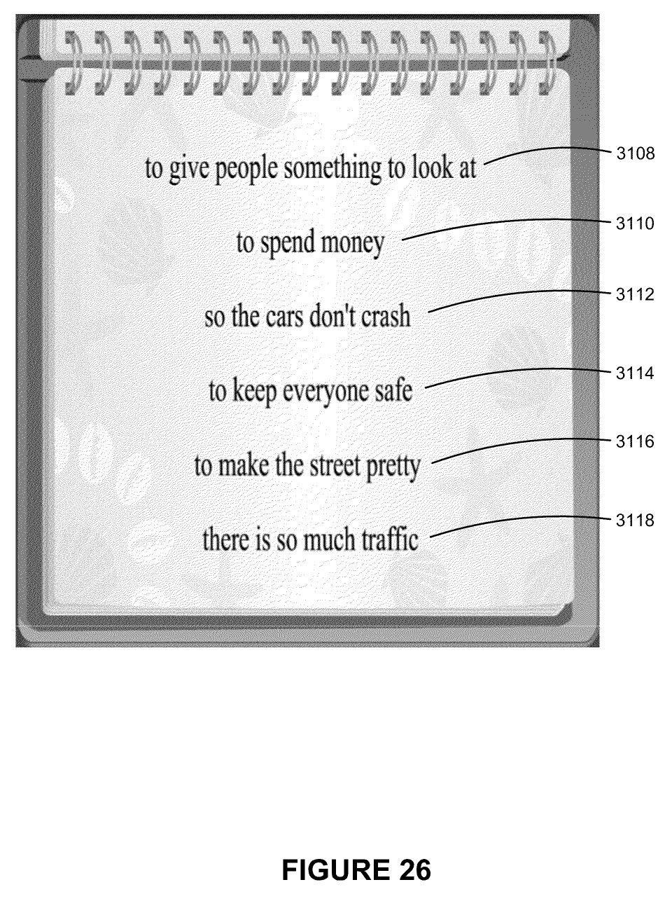

If the execution controller 352 does receive the response, the execution controller 352 transmits 806 to the teaching client 106 a second stimulus set. Referring to FIG. 26, for example, the second stimulus set can include the related word sets 3108-3118 and audio or visual instructions (not shown). Key elements of the question 3102 are emphasized through instructions. For example, “Why is a stoplight needed there? The question is about reasons for having a stoplight. Choose the related words that make you think about reasons for having a stoplight.”

The execution controller 352 then determines 808 if the learner's response to second stimulus set is received in a pre-determined amount of time. If not, the execution controller 352 again directs the teaching client 106 to present 806 the second stimulus set.

If the learner's response is received, the execution controller 352 queries the feedback module 356 and determines 810 if the learner correctly answered the question presented in the second stimulus set. If not, the execution controller 352 directs the feedback module 356 to transmit 812 feedback for the incorrect answer to the teaching client 106. The feedback can include visual and/or audio instructions informing the learner that the learner answered the question incorrectly and/or the reasons why the learner's answer is incorrect. After the feedback for incorrect answer is transmitted, the execution controller 352 again transmits 806 the second stimulus to teaching client 106 and/or directs the teaching client 106 to present the second stimulus to the learner again. The execution controller 352 then repeats steps 808, 810, 812 and 806 again until the received learner's answer is the correct answer.

If the learner correctly answers the question, the execution controller 352 directs 814 the feedback module 356 to transmit feedback for the correct answer to the teaching client 106. The feedback can include visual and/or audio instructions informing the learner that the learner answered the question correctly and/or the reasons why the learner's answer is correct.

Referring to example in FIG. 26, the correct answer for the second stimulus is selection of word sets 3112, 3114 and 3118. If an incorrect word set like word set 3108 is selected, the feedback for incorrect answers is transmitted to and displayed on the teaching client 106. If instead word sets 3112, 3114 and 3118 are selected, the feedback for the correct answer is transmitted to and displayed on the teaching client 106.

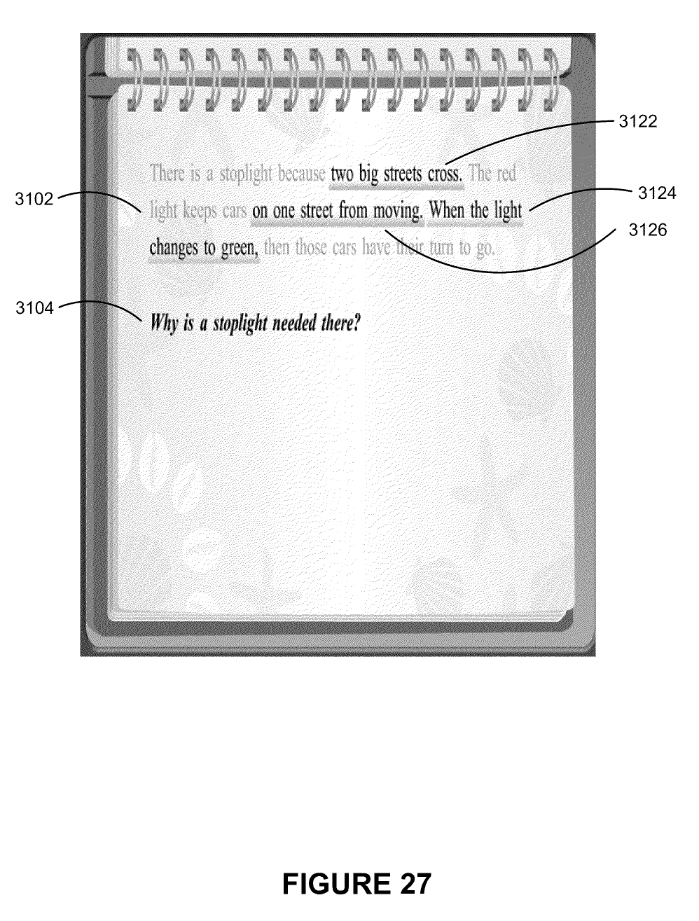

Referring to FIG. 8B, the execution controller 352 next transmits 816 a third stimulus to the teaching client 106. An example of this third stimulus is depicted in FIG. 27. The third stimulus in FIG. 27 includes the passage 3102, question 3104, highlighted clue words 3122- 3126, and audio or visual instructions (not shown) on selecting the clue words that correctly answer question 3104.

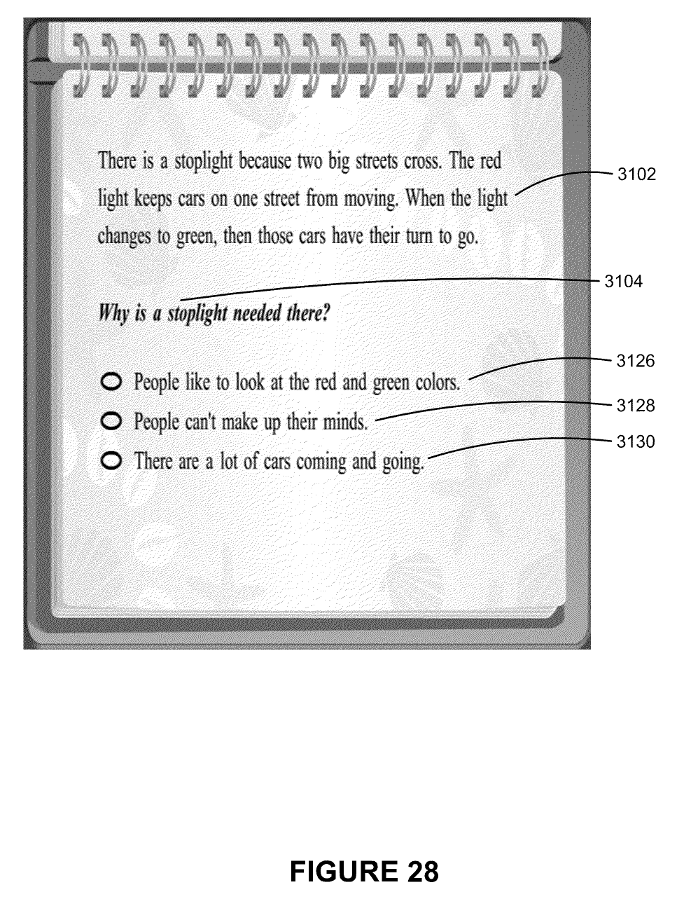

Steps 818-824 are then performed. These steps are similar to steps 808-814 described above. In example of FIG. 27, the correct answer at step 820 would be clue words 3122. After transmitting the feedback for correct answer at step 824, the execution controller 352 transmits 826 the fourth stimulus set and directs the teaching client 106 to present the stimulus set to the learner. An example of the fourth stimulus is included in FIG. 28. The fourth stimulus, in FIG. 28, includes passage 3102, question 3104, answer choices 3126-3130 and audio or visual instructions (not shown) directing the learner to select the answer that is similar to clue words 3122.

The pattern of answer choices 3126-3130 is again based on the critical features for the skill being taught. Here, the incorrect answer choices 3126, 3128 include two or fewer critical features identified for inferential comprehension skill whereas the correct answer choice includes all three critical features. Both incorrect answers 3126, 3128 include two critical features: answer category match meet question criterion and the answer words do not have one-to-one correspondence with passage words. However, the third critical feature is absent from these answer choices. The category for incorrect answers 3126, 3128 does not appear in the passage and therefore the incorrect answer does not include the third critical feature. On the other hand, the correct answer choice 3130 includes all three critical features and therefore answer choice 3130 is the correct answer.

Steps 828-838 are then performed. These steps are similar to steps 724-734 described above. The routine illustrated in FIGS. 8A-B help learners develop the skill of locating words in passages that answer the question. Although the words in the answer have mostly the same words as the passage, the answer words are not identical to the passage words. The routine helps learner to identify the category of passage words and answer words and match those categories to infer the correct answer.

FIGS. 8C-D are a flow chart that illustrates the execution controller 352 performing 800B routine designed to develop the learner's inferential comprehension skill according to another embodiment of the present invention. This sequence is similar to the sequence illustrated in FIGS. 8A-B. However, some of the steps in Figs. A-B are absent from the sequence described in FIG. 8C-D because the latter is designed to move learners toward more independent performance by removing some of the earlier instructional prompts. Moreover, this sequence also provides the learner with a help feature that helps the learner identify words that fit into the category of the question's topic.

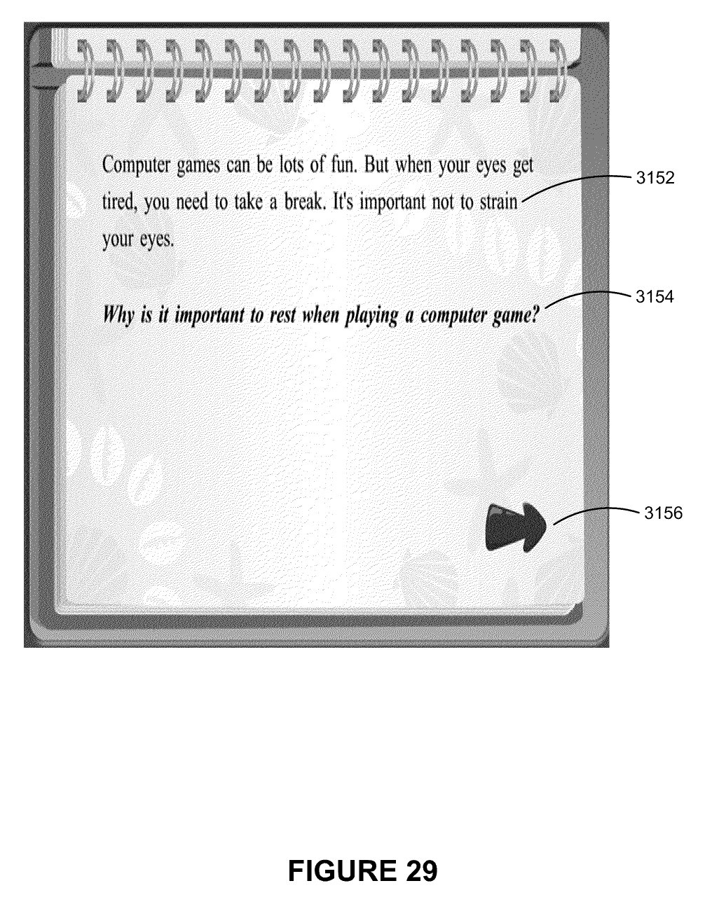

The execution controller 352 transmits 852 the first stimulus set to the teaching client 106 and directs the teaching client 106 to present the first stimulus to the learner. An example of the first stimulus is depicted in FIG. 29. The first stimulus can include a passage 3152, question 3154, proceed icon 3156 and instructions (not shown) directing the learner to select the proceed icon 3156 after the learner has read the passage 3152 and the question 3154.

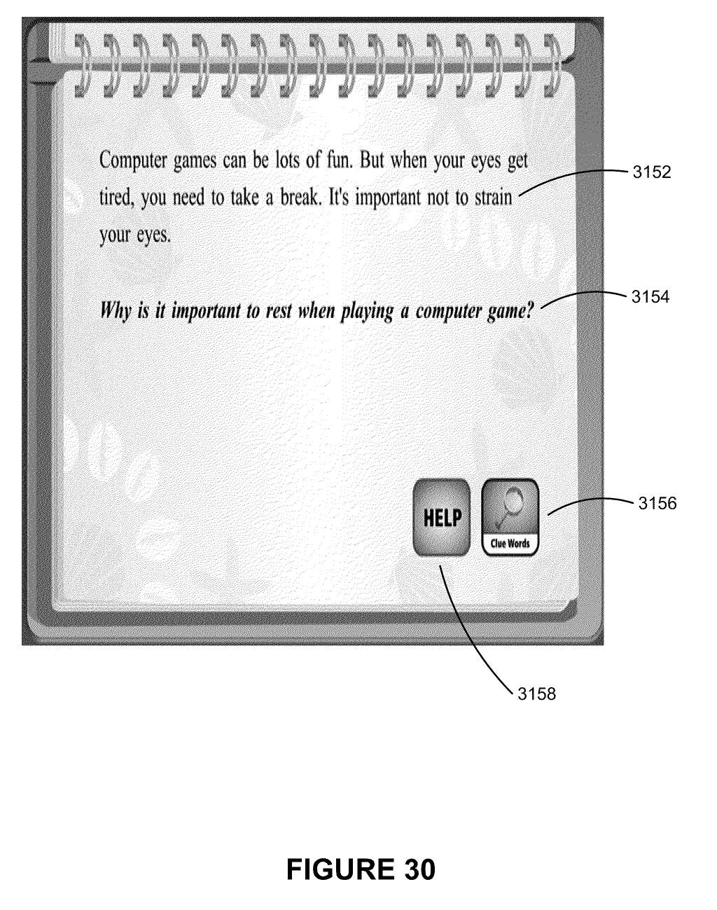

The execution controller 352 next determines 854 if the learner's response has been received from the teaching client 106 within a pre-determined amount of time. If not, steps 852 and 854 are repeated. Otherwise, the execution controller 352 transmits 856 the second stimulus set. An example of second stimulus set is depicted in FIG. 30. The second stimulus in FIG. 30 includes passage 3152, question 3154, a help icon 3158 and the proceed icon 3156.

The execution controller 352 next determines 858 if the learner's response has been received from the teaching client 106 within a pre-determined amount of time. If not, step 856 and 858 are repeated. Otherwise, the execution controller 352 determines 860 if the received response indicates selection of proceed icon 3156.

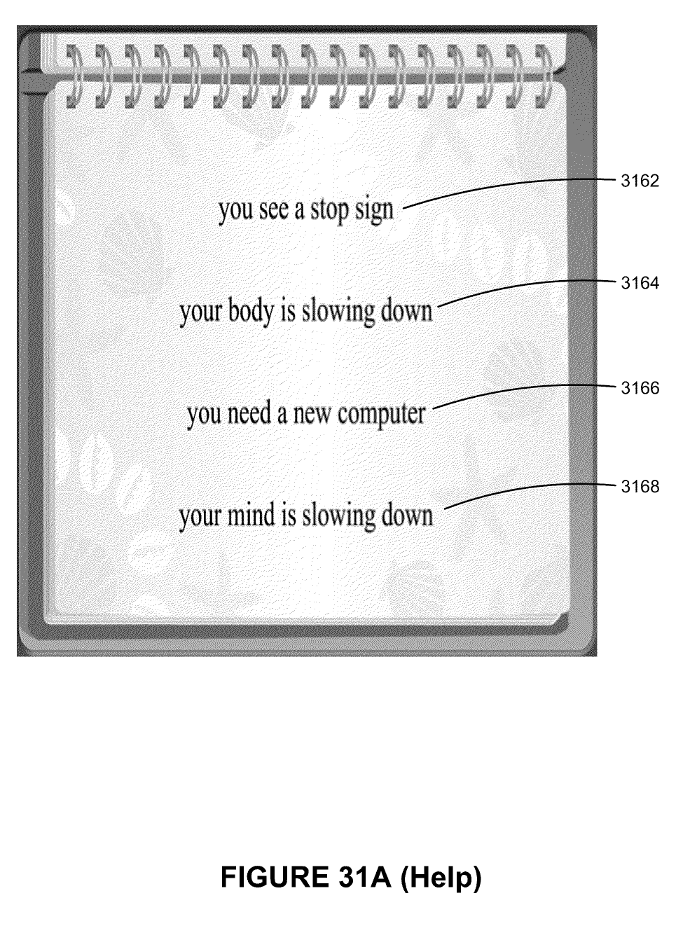

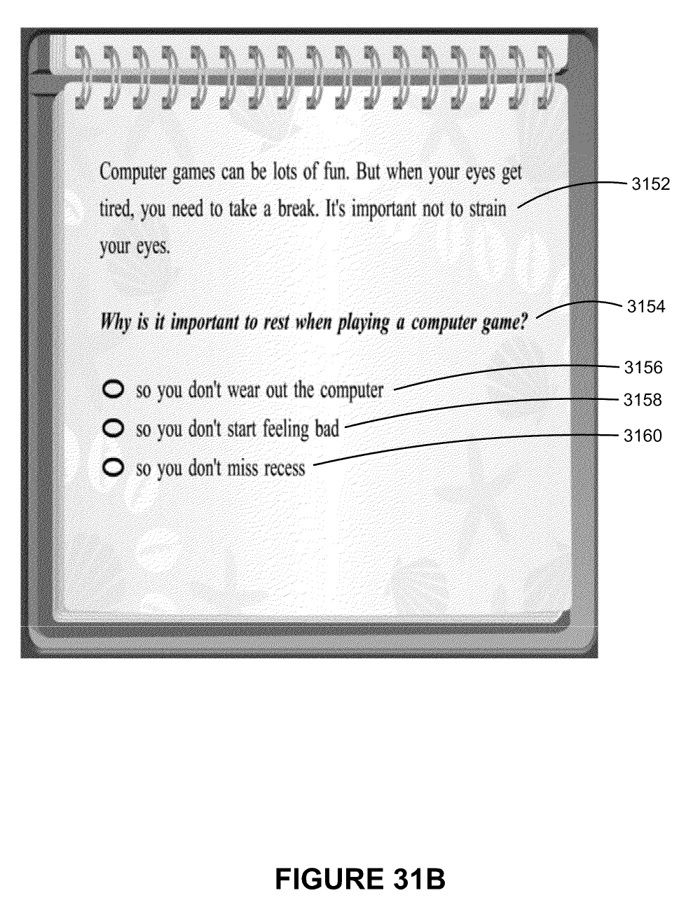

If the received response indicates that the proceed icon 3156 has not been selected, the execution controller 352 determines that the help icon was selected and therefore performs 864 the help routine. An example of help routine is displaying word sets like related word sets 3108-3118 in FIG. 26. FIG. 31A includes the word sets 3162-3168 that correspond to question 3152 and therefore word sets 3162-3168 can be displayed if help icon 3158 is selected. Audio or visual instructions similar to the instructions in stimulus set of FIG. 26 can also be presented.

After performing 864 the help routine or if the received response in step 860 indicates that the proceed icon 3156 in FIG. 30 has been selected, the execution controller transmits 866 the third stimulus set to the teaching client 106 and directs the teaching client 106 to present the third stimulus set to the learner. An example of the third stimulus set is depicted in FIG. 31B. The third stimulus set, in FIG. 31B, includes the passage 3152, question 3154 and three answer choices 3156-3160.

The execution controller then performs steps 868-878. These steps are similar to steps 724-734 described above.

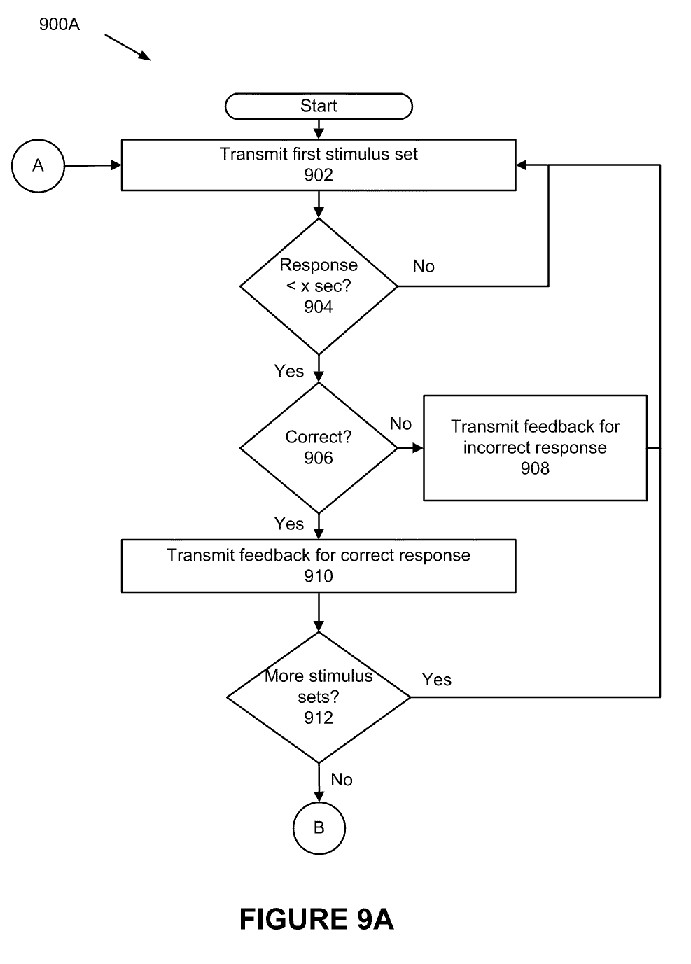

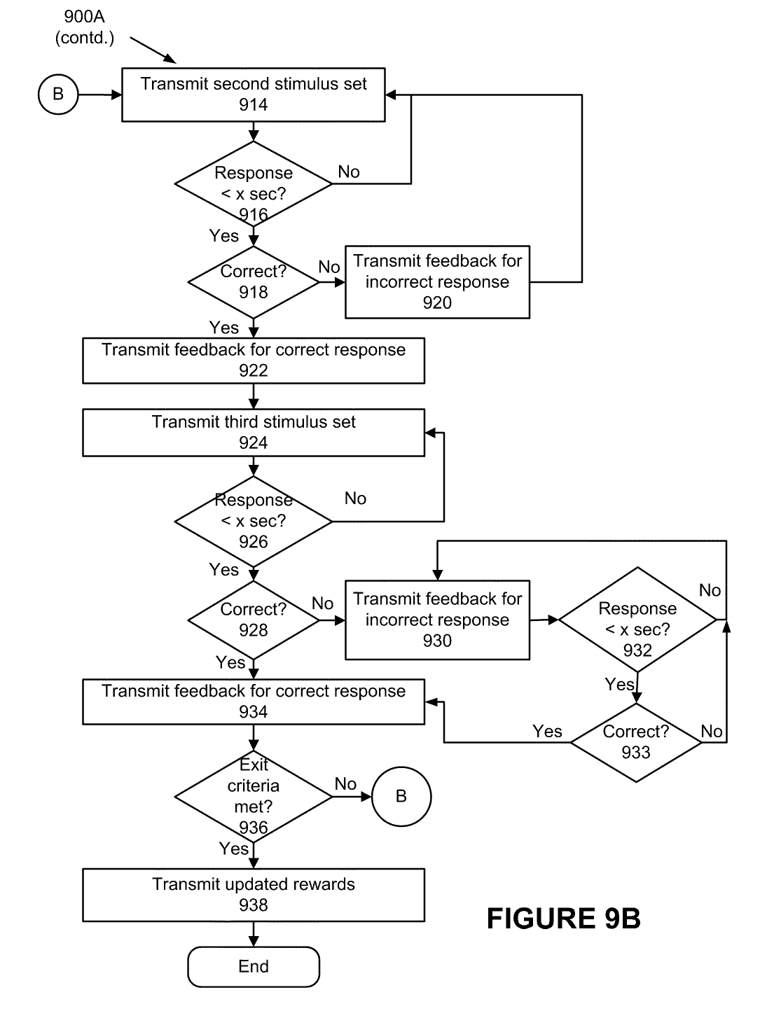

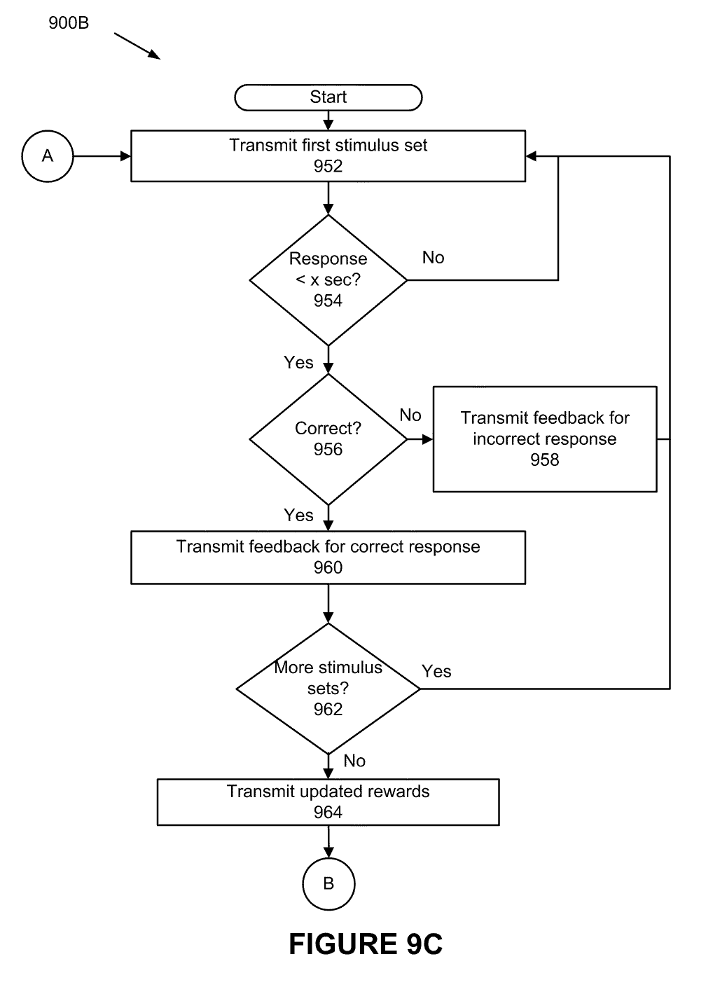

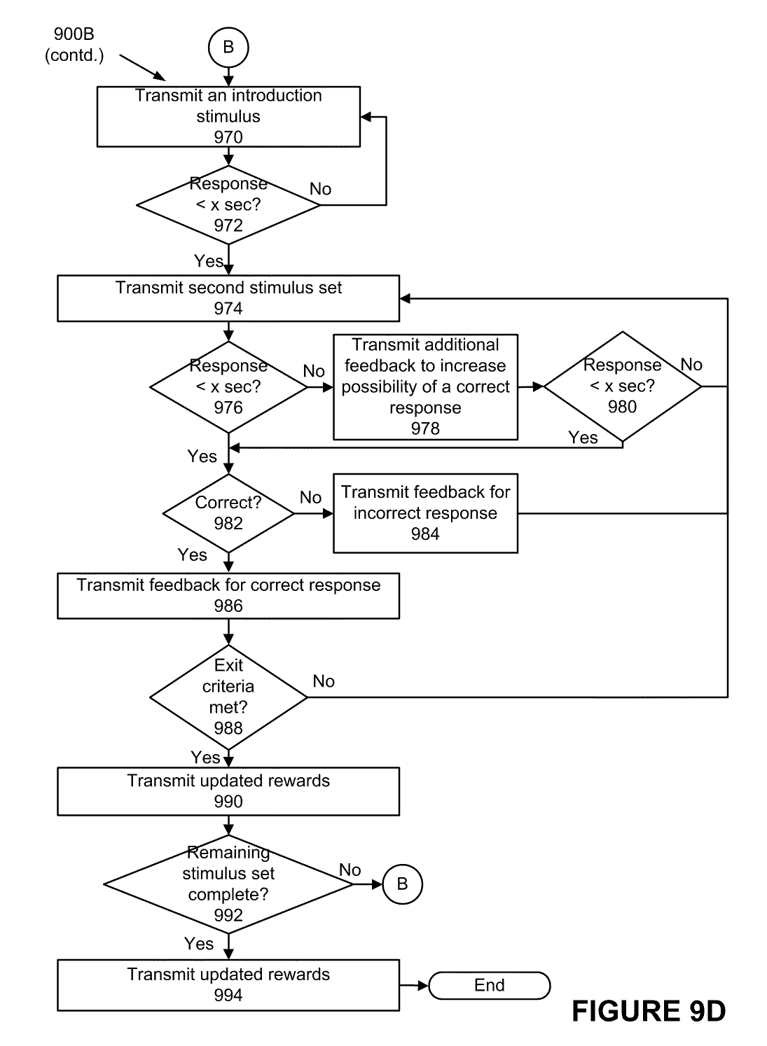

FIGS. 9A-B are a flow chart that illustrates the execution controller 352 performing 900A routine designed to develop the learner's skill for differentiating between problems that require literal or inferential comprehension skills. The execution controller transmits 902 a first stimulus set to the teaching client 106 and directs the teaching client 106 to present the stimulus set to the learner. The execution controller 352 then determines 904 if it has received a response for the first stimulus from the teaching client 106. If not, the execution controller 352 again transmits the first stimulus and/or directs the teaching client 106 to present the first stimulus to the learner. If the execution controller 352 receives a response, the execution controller 352 next queries the feedback module 356 and determines 906 if the received response is correct. If incorrect, the execution controller 352 transmits 908 the feedback for the incorrect response. If correct, the execution controller 352 transmits 910 the feedback for correct response to the user.

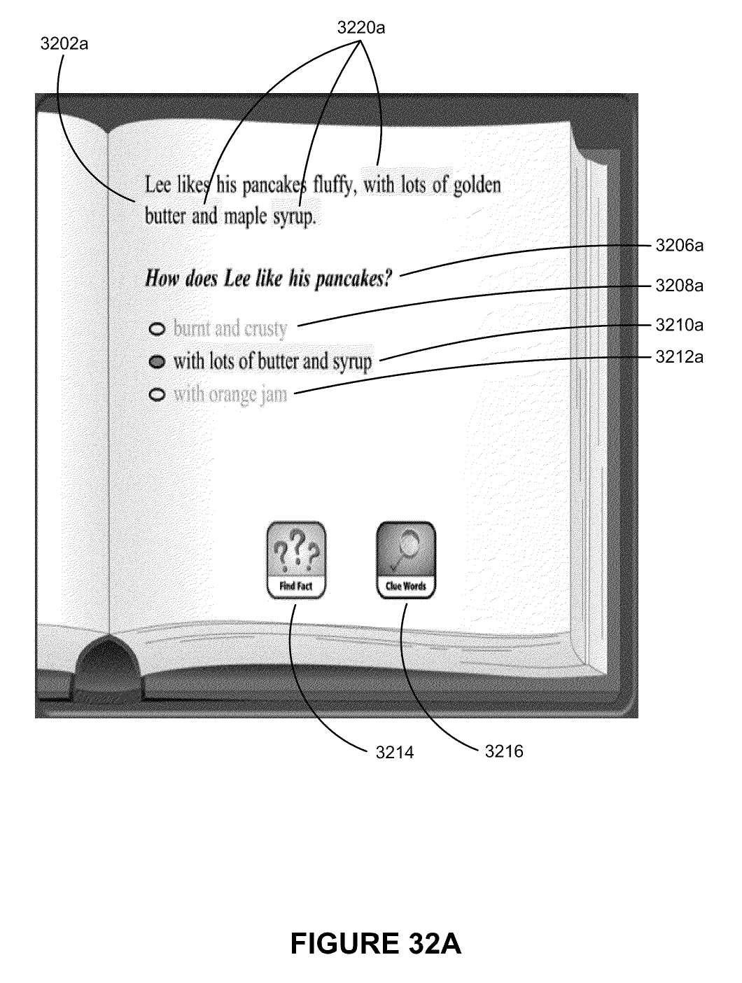

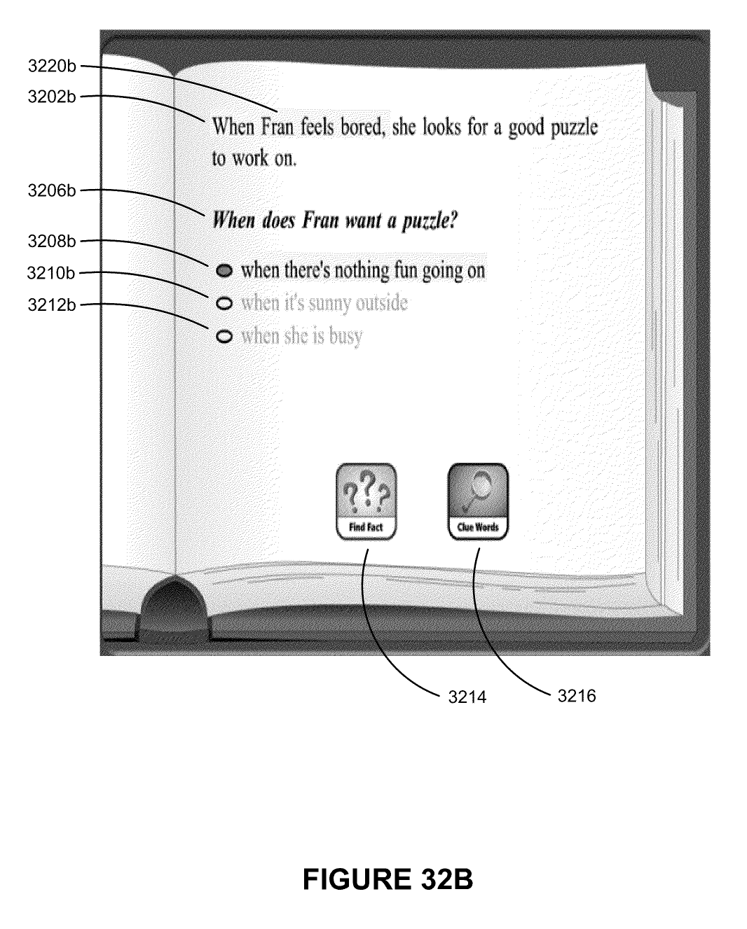

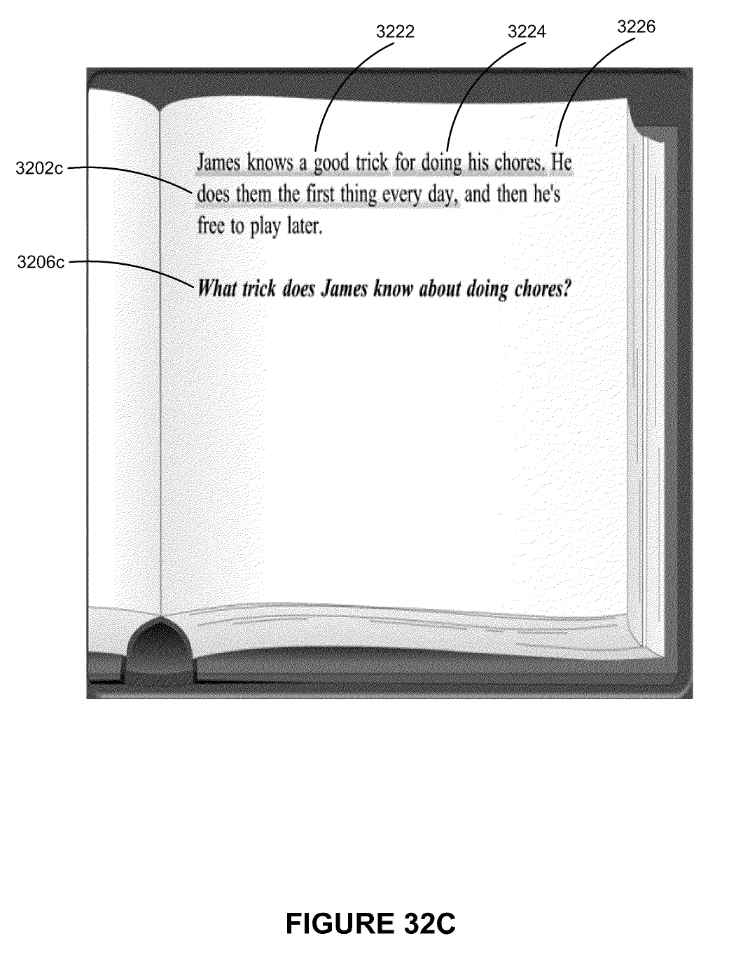

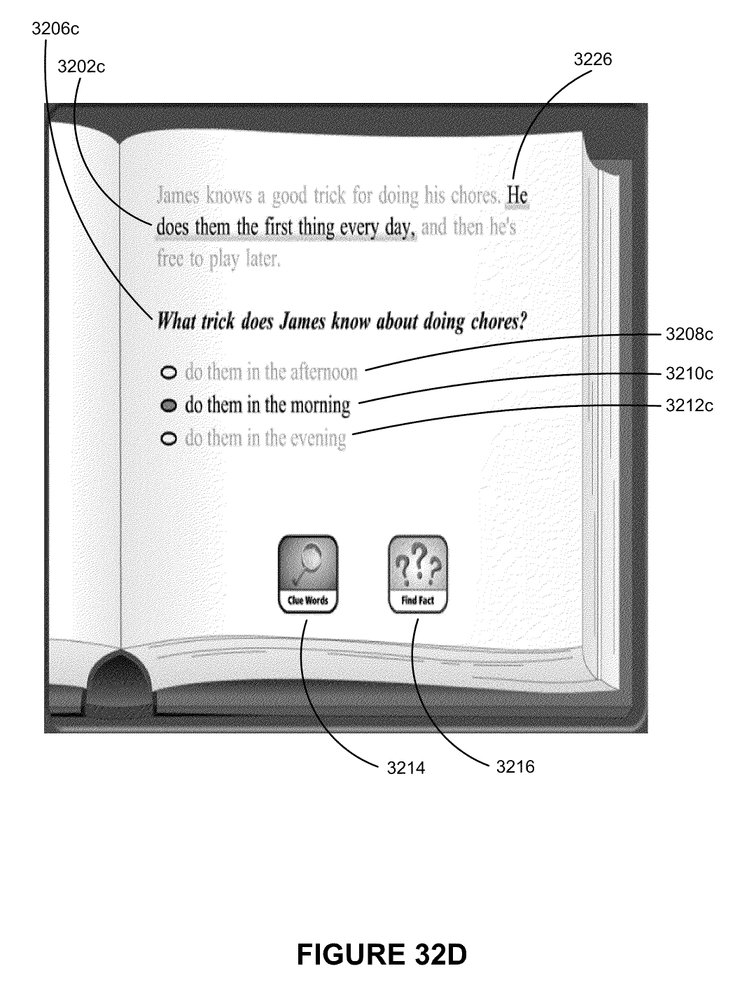

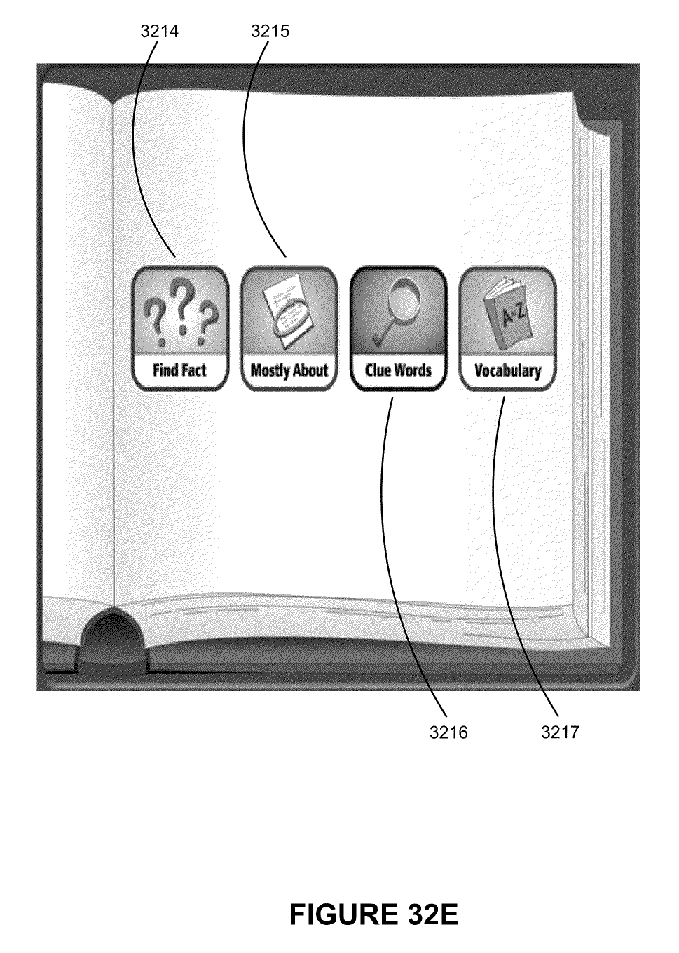

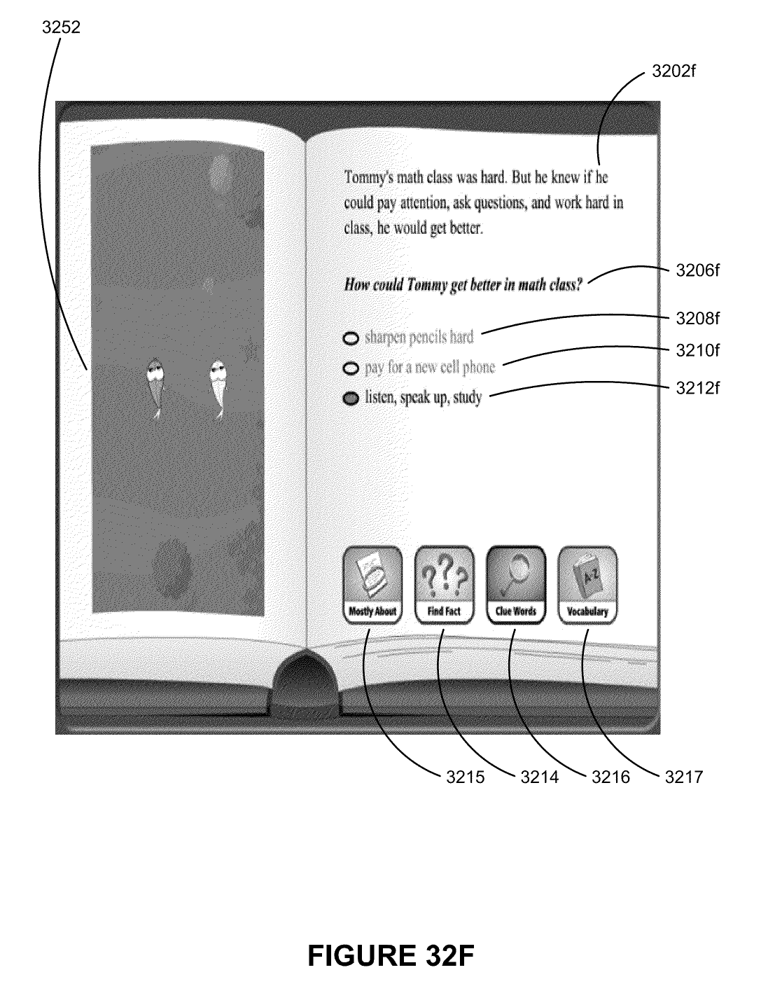

For example, referring to FIG. 32A, the first stimulus can include a passage 3202a, question 3206a, answer choices 3208a-3212a with correct answer choice 3210a already selected, highlighted portion of the passage 3220a that corresponds to the correct answer, find fact icon 3214 and find clue words icon 3216. The first stimulus also includes audio or visual instructions (not shown) directing the learner to determine whether the words in the answer choice 3210a appear in the passage 3202a. The instructions can further direct the learner that if the answer words appear in the passage, then the current question requires literal comprehension skills. If not, the current question requires inferential comprehension skills. The learner can then determine the skill required for the problem and then respond by selecting the appropriate icon. Feedback is then presented to learner on whether the learner was correct or incorrect and the reasons why the learner was correct or incorrect.

After transmitting 910 the feedback for correct response, the execution controller 352 determines 912 if additional stimulus sets remain to be presented. If yes, steps 902-912 are repeated for additional stimulus sets that prompt the learner to correctly identify the skill required to answer the question in each stimulus. An example of additional stimulus is depicted in FIG. 32B. The stimulus set in FIG. 32B requires the learner to identify that the required skill to answer question 3206b is inferential comprehension. If no additional sets remain, the execution controller 352 moves to the second phase of the routine.

In the second phase, the execution controller 352 performs steps 914-922 for second stimulus. These steps are similar to steps 902-910. An example of second stimulus is depicted in FIG. 32C. Referring to the example of FIG. 32C, the second stimulus can include passage 3202c, word sets 3222, 3224, 3226 and question 3206c. The second stimulus also includes instructions directing the learner to select the word set that helps answer the question 3206c.

After a correct answer is received from the teaching client 106, the execution controller 352 performs steps 924-934 for third stimulus. Steps 924-926 are similar to steps 914-916 described above. An example of the third stimulus set is illustrated in FIG. 32D. Referring to the example of FIG. 32D, the third stimulus can include passage 3202c, selected word set 3226, question 3206c, answer choices 3208c-3212c, find fact icon 3216 and clue word icon 3214. The third stimulus set also includes audio or visual instructions (not shown) that direct the learner to determine whether answering question 3206c requires inferential or literal comprehension skill. The instructions then direct the learner to select an icon 3214, 3216 corresponding to the determined skill.

At step 928, if the correct answer choice is not received, the execution controller 352 transmits 930 feedback for incorrect answer, adds a stimulus set like the stimulus sets in FIGS. 32A-32D to the routine of FIGS. 9B and 9C and waits for the teaching client 106 to transmit an answer choice again. If the answer choice is not received 932 within a pre-determined time, the execution controller 352 again transmits 930 to and/or directs the teaching client 106 to present the feedback from step 930. Otherwise, the execution controller determines 933 if the received response is correct. Appropriate response from step 930 or step 934 is transmitted depending on whether the received response is correct or not.

After transmitting the feedback for the correct response, the execution controller 352 determines 936 if the learner's responses meet the exit criterion. One example of exit criterion is receiving correct response at steps 918 and 928 at first try instead of getting the correct answer in a subsequent try after getting feedback for the incorrect response. Other example factors to determine exit criterion have been described above. If exit criterion is not met, the execution controller 352 starts from step 914 and uses stimulus sets added at step 930. If exit criterion is met, the execution controller 352 updates the reward points for the learner and transmits 938 the updated rewards to the teaching client 106.

FIGS. 9C-D are a flow chart that illustrates the execution controller 352 performing 900B another routine designed to develop the learner's skill for differentiating between problems that require different comprehension skills. The execution controller 352 performs steps 952-962 for a first set of stimuli. These steps are similar to steps 902-912 described above.

The stimulus sets for steps 952-962 are designed to familiarize the user with various icons. An example of the stimulus set used in steps 952-962 is depicted in FIG. 32E. This stimulus set comprises find fact icon 3214, clue words icon 3216, and additional icons like mostly about icon 3215 and vocabulary icon 3217. The stimulus set also comprises instructions (not shown) that direct the user to select find fact icon 3214 or clue words icon 3216 according to the differences in critical features between literal and inferential comprehension skills. The correct answer for this stimulus is the selected icon corresponding to the icon demanded in the instructions. Various other stimulus sets can be created by moving the icons around and instructing the user to select a particular icon.

After all stimulus sets have been presented, the execution controller 352 updates the rewards based on the number of correct answers received, transmits 964 updated rewards to the teaching client 106 and directs the teaching client 106 to present the rewards to the learner.

Referring to FIG. 9D, the execution controller 352 transmits 970 an introduction stimulus to the teaching client 106 and directs the teaching client 106 to present the introduction stimulus. The execution controller 352 then determines 972 if the execution controller 352 has received the learner's response to introduction stimulus from teaching client 106. If the response is not received within a pre-determined amount of time, the execution controller 352 again transmits the introduction stimulus and/or directs the teaching client 106 to present the introduction stimulus to the learner. If the response is received, the execution controller 352 performs step 974.

The introduction stimulus is meant to keep the learner engaged. An example of the introduction stimulus is depicted in FIG. 32F. The introduction stimulus 3252 in FIG. 32F comprises two fish in a stream. The learner is instructed to select one of the fish and as the learner correctly answers later questions in various stimuli, the learner's fish advances ahead and eventually wins the race. Like rewards, this introduction stimulus encourages the learner to do better and stay engaged in the routines.

After receiving the response from the teaching client 106, the execution controller 352 transmits 974 a second stimulus set to the teaching client 106 and directs the teaching client 106 to present the second stimulus. The execution controller 352 then determines 976 if it has received learner's response to the second stimulus in a pre-determined amount of time. If not, the execution controller 352 transmits 978 additional feedback to the teaching client 106 and directs the teaching client 106 to present the feedback. The execution controller then determines 980 if it has received the learner's response after the additional feedback. If not, steps 974-980 are repeated until learner's response is received.

Referring to the example in FIG. 32F, an example of second stimulus comprises passage 3202f, question 3206f, answer choices 3208f-3212f with correct answer 3212f already selected, and icons 3214-3217. The second stimulus also comprises audio or visual instructions (not shown) that direct the learner to review various parts in the second stimulus, determine the type of question asked and select one of the icons 3214-3217 accordingly. The second stimulus therefore encourages the learner to determine if the words in correct answer 3212f are present in passage 3202f. Based on this determination the second stimulus encourages the learner to determine that the second stimulus comprises an inferential comprehension question because the words in the correct answer are not present in passage 3202f. Additional stimulus sets can help learner further practice on how to differentiate between questions requiring different skills. For example, a third stimulus set wherein the answer words are present in the passage helps the learner determine that the stimulus set comprises a literal comprehension question.

After receiving response from teaching client 106 in step 976, the execution controller 352 performs steps 982-990. These steps are similar to others described above and entail: a) determining whether the learner's response was correct (982); b) transmitting the appropriate feedback for the correct or incorrect response, including feedback about why the incorrect response was incorrect with respect to one or more missing critical features (986 and 984); and c) evaluating whether the exit criterion for the instructional sequence was met (988), whereupon either the rewards for meeting the exit criterion are presented or more stimulus sets are presented as necessary to meet the exit criterion. The execution controller 352 then determines 992 if there are any remaining stimulus sets to be transmitted and presented on the teaching client 106. The remaining stimulus sets can include the additional stimulus sets like the third stimulus set discussed in the paragraph above. If additional stimulus sets remain, steps 970-992 are repeated for each stimulus set. Otherwise, the execution controller 352 transmits 994 the updated rewards to the teaching client 106 and directs the teaching client 106 to present the rewards.

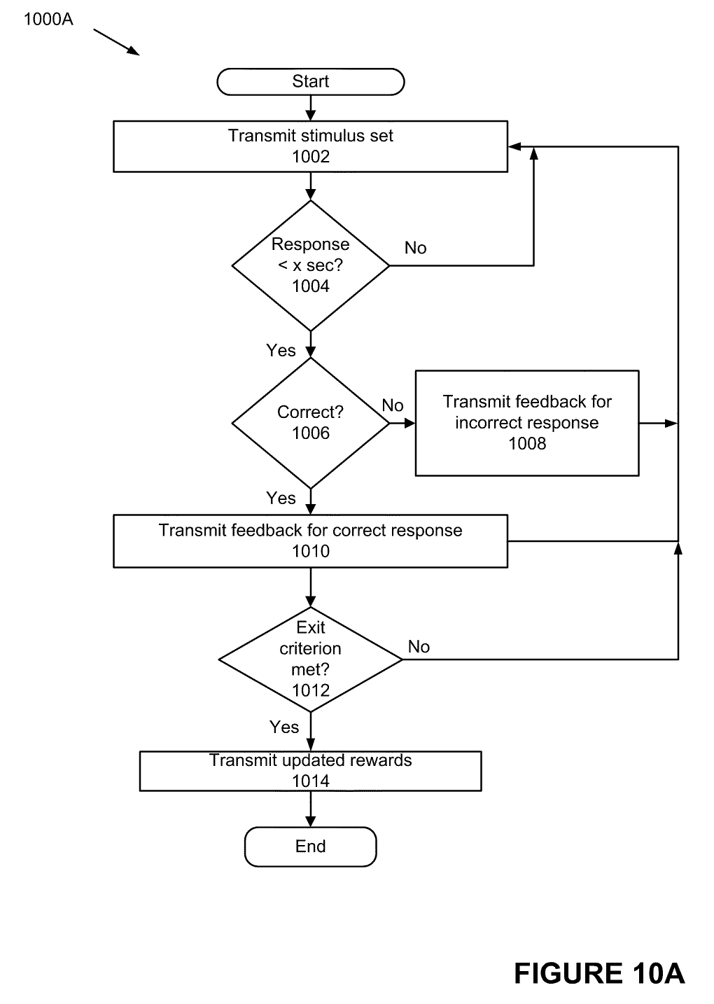

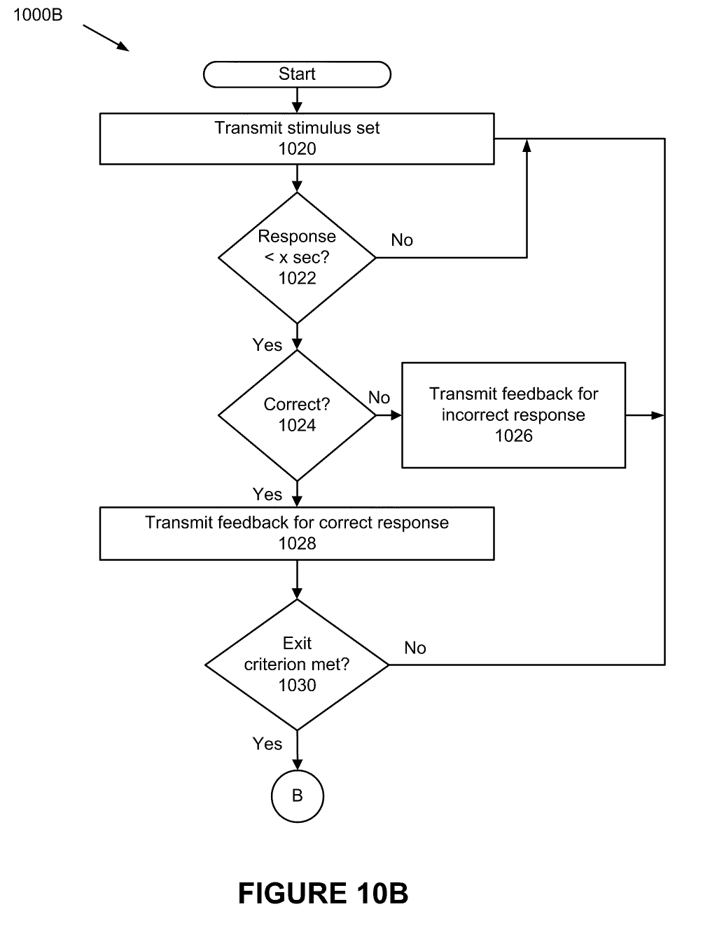

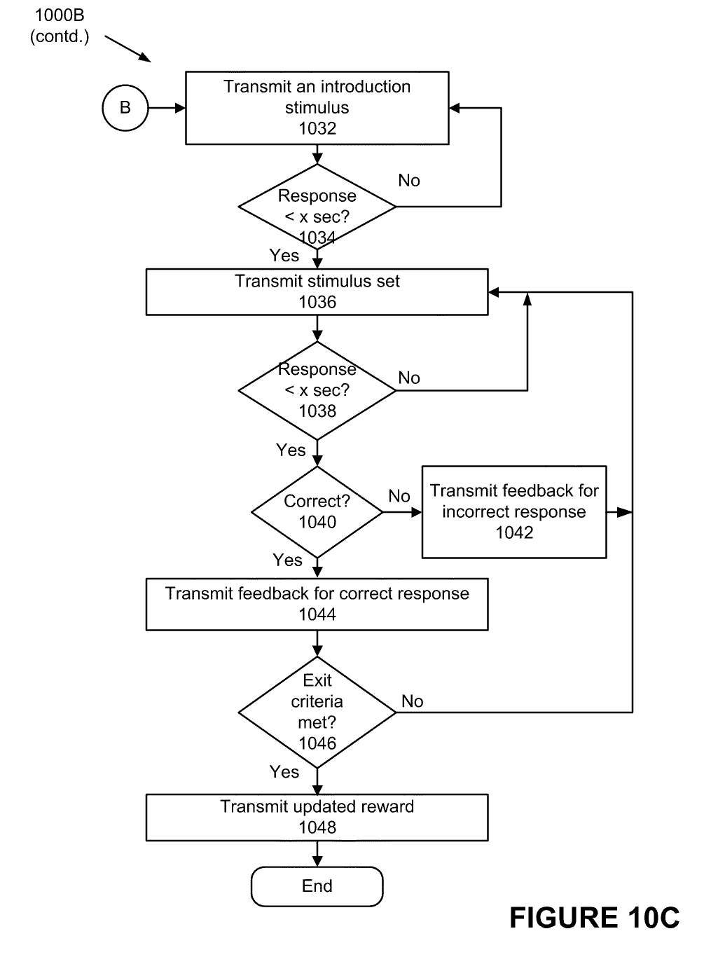

FIG. 10A is a flow chart that illustrates the execution controller 352 performing 1000A routine designed to develop the learner's skill for differentiating between problems that require vocabulary or summative skills. The vocabulary skill helps the learner infer the meaning of an unknown word from the context of the passage.

In FIG. 10A, the execution controller 352 performs steps 1002-1014. These steps are similar to steps 722-734 described above. However, unlike steps 722-734, if the exit criterion is not met at step 1012, the execution controller 352 performs steps 1002 (equivalent of step 722).

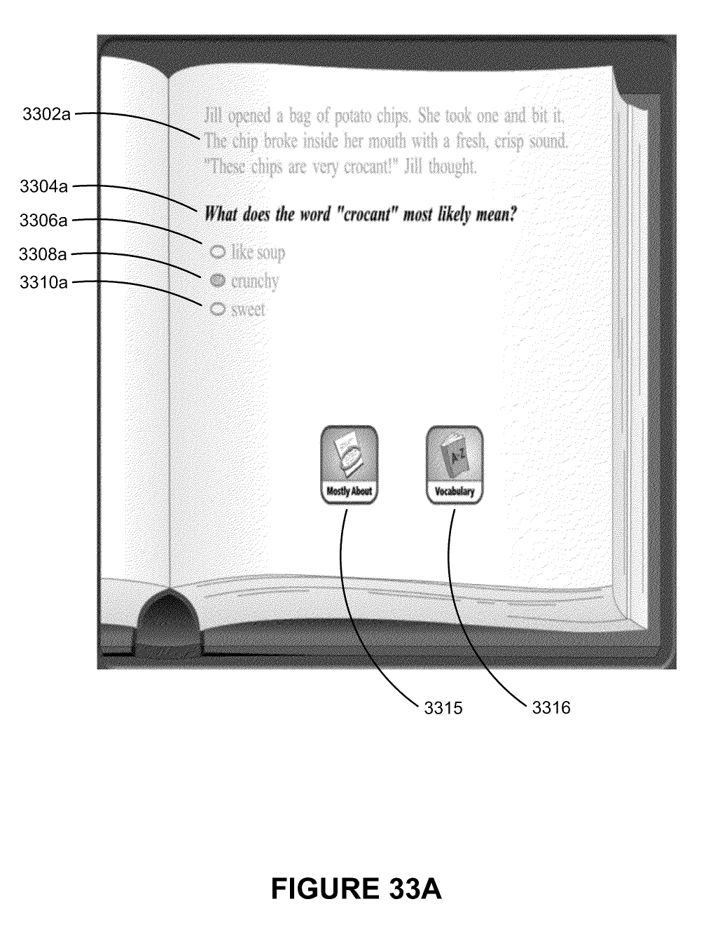

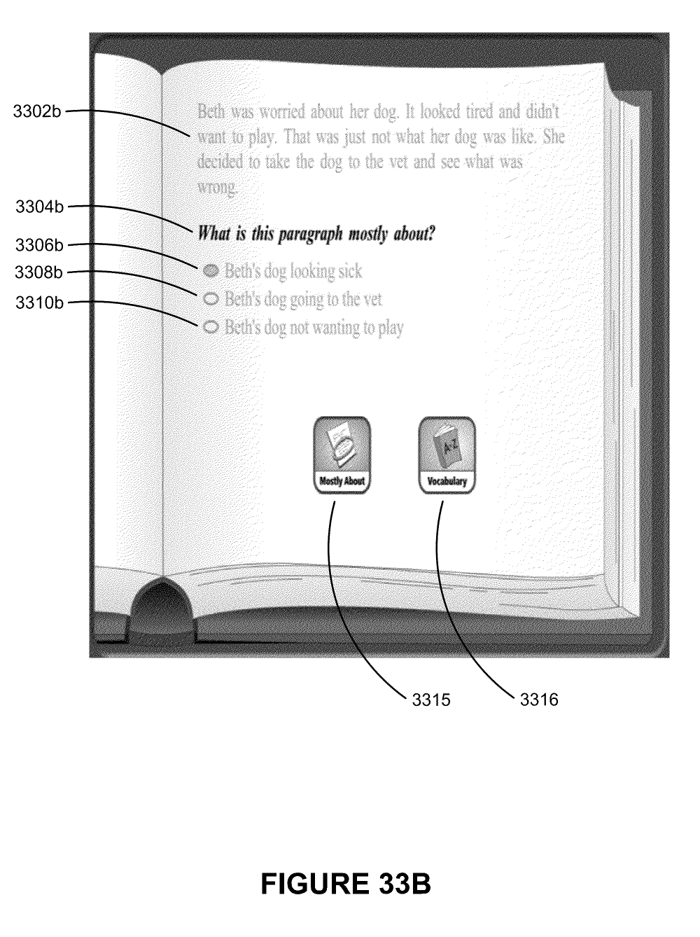

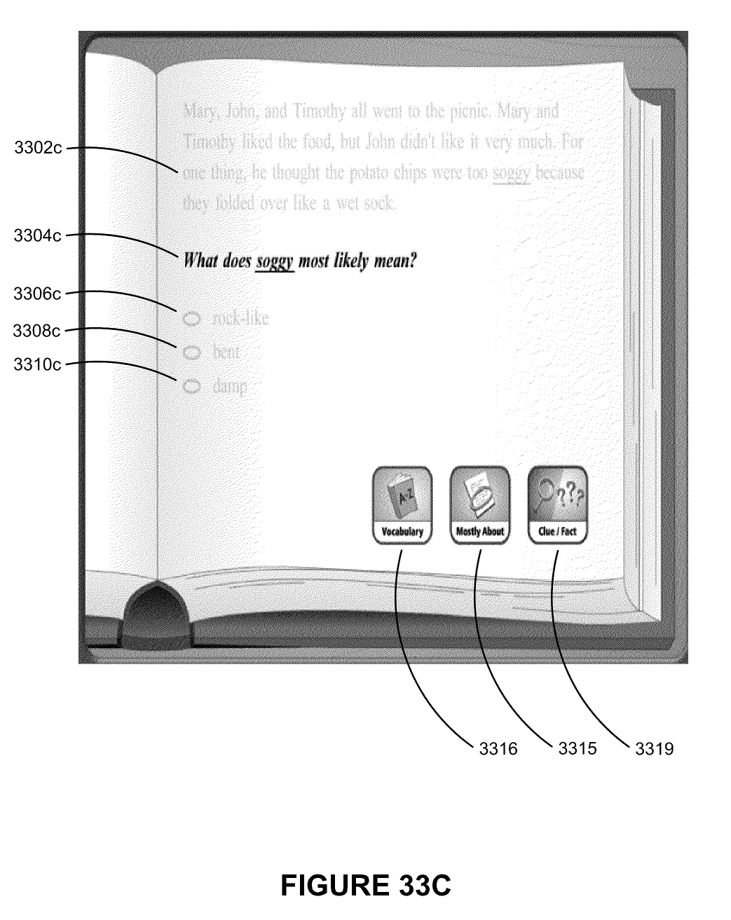

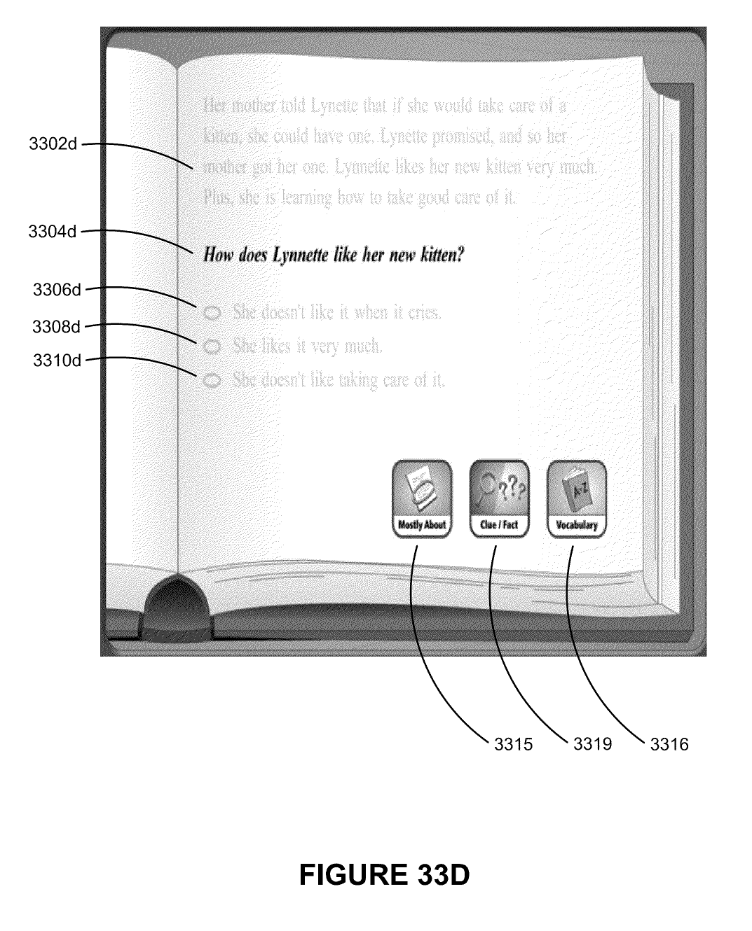

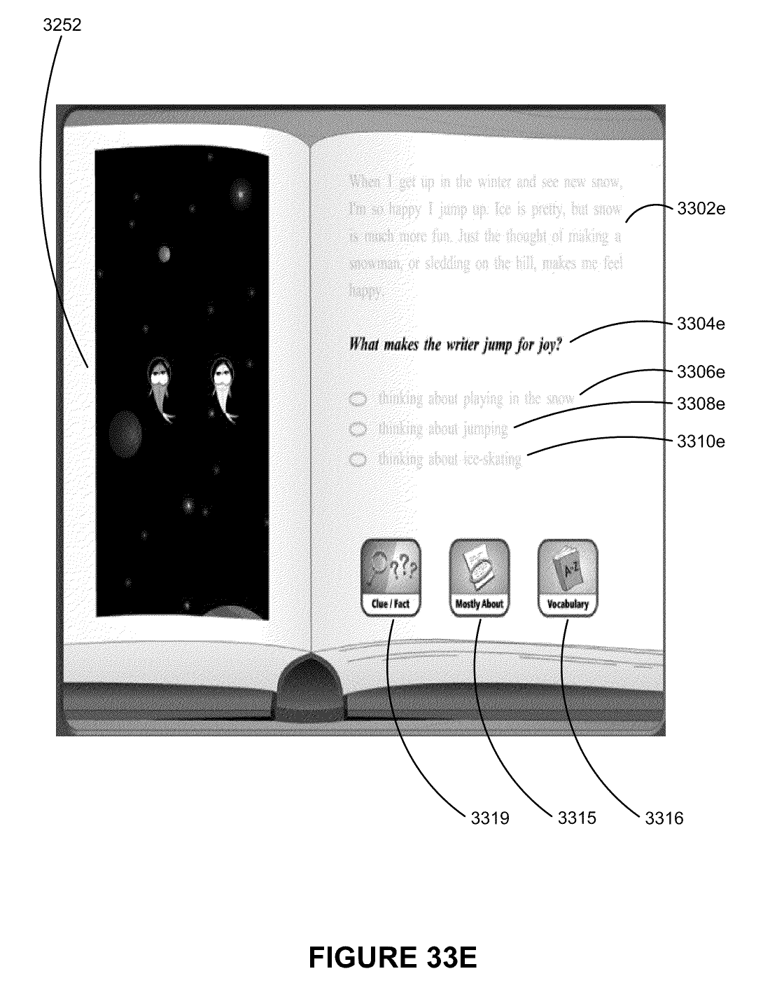

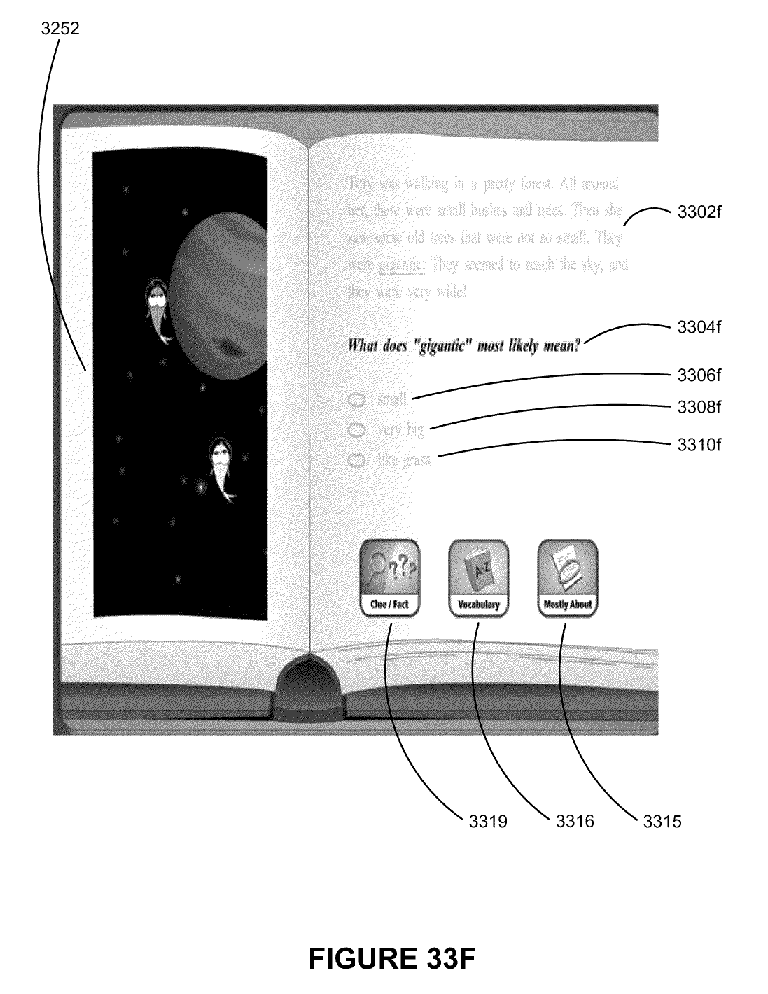

The stimulus sets used for steps 1002-1010 are designed to help the learner learn how to differentiate between questions that require summative skill and questions that require vocabulary skills. The stimulus sets in FIG. 33A and FIG. 33B are two examples of stimulus sets that can be used for this purpose. The stimulus set in FIG. 33A comprises a passage 3302a, question 3304a, answer choices 3306a-3310a, vocabulary icon 3316 and summative or mostly about icon 3315. The stimulus set also includes audio or visual instructions (not shown) directing the learner to read one or more parts of the stimulus set and determine the skill that helps answering question 3304a. The instructions then direct the learner to select the icon corresponding to the answer. The correct answer for the stimulus set of FIG. 33A is selection of vocabulary icon 3316. FIG. 33B includes a second stimulus set similar to stimulus set in FIG. 33A and the correct answer for the second stimulus set is selection of mostly about icon 3315. In one embodiment, the difficulty level of questions in later stimulus sets increase after the learner has responded to the easier questions.

FIGS. 10B-C are a flow chart that illustrates the execution controller 352 performing 1000B another routine designed to develop the learner's skill for differentiating between problems that require vocabulary, summative, literal or inferential comprehension skills. The execution controller 352 performs steps 1020-1030. These steps are similar to others described above and entail: a) presenting a stimulus set and determining whether the learner responds within the predetermined time frame (1020 and 1022); b) determining whether the learner's response was correct (1024); c) transmitting the appropriate feedback for the correct or incorrect response, including feedback about why the incorrect response was incorrect with respect to one or more missing critical features (1026 and 1028); and d) determining whether the exit criterion for this instructional sequence was met, whereupon either a new section of the sequence is introduced or more stimulus sets are presented as necessary to meet the exit criterion.

The stimulus sets used for steps 1020-1030 are designed to help the learner differentiate between questions that require summative skill, vocabulary skill, literal comprehension skill or inferential comprehension skill. An example of such stimulus sets is depicted in FIG. 33C. The stimulus set in FIG. 33C comprises passage 3302c, question 3304c, answer choices 3306c-3310c, vocabulary icon 3316, mostly about icon 3315 and clue/fact icon 3319. The stimulus set also includes visual or audio instructions (not shown) that direct the learner to read one or more parts of the stimulus set and determine the skill required to answer the question 3304c. The learner is then instructed to select the appropriate icon corresponding to the required skill. Accordingly, the learner is instructed to select vocabulary icon 3316 if the question 3304c requires vocabulary skill, mostly about icon 3315 if the question 3304c requires summative skill, and clue/fact icon 3319 if the question 3304c requires literal comprehension skill or inferential comprehension skill. The correct answer for question 3304c is selection of vocabulary icon 3316.

FIG. 33D depicts another stimulus set that can be used for steps 1020-1030. The correct answer for question 3304d in this stimulus set is clue fact icon 3319.

After the execution controller 352 determines 1030 that the exit criterion has been met at step 1030, the execution controller 352 performs steps 1032-1048. These steps are similar to steps 970-990 described above. However, steps 1032-1048 do no have the equivalent of steps 978-980. If at step 1038, the execution controller 352 determines that a response has not been received, the execution controller performs step 1036 (equivalent of step 974) instead of performing any intermediate equivalents of steps 978-980.

The stimulus sets used for steps 1020-1030 are designed to help the learner develop the skill of determining if the question in the stimulus set requires summative skill, vocabulary skill, literal comprehension skill or inferential comprehension skill. Examples of such stimulus sets are depicted in FIG. 33E and FIG. 33F. These stimulus sets are similar to the stimulus sets in FIGS. 33C-D. FIGS. 33E-F also include the introduction stimulus set 3252 transmitted at step 1032 (stimulus set 3252 has been described above).

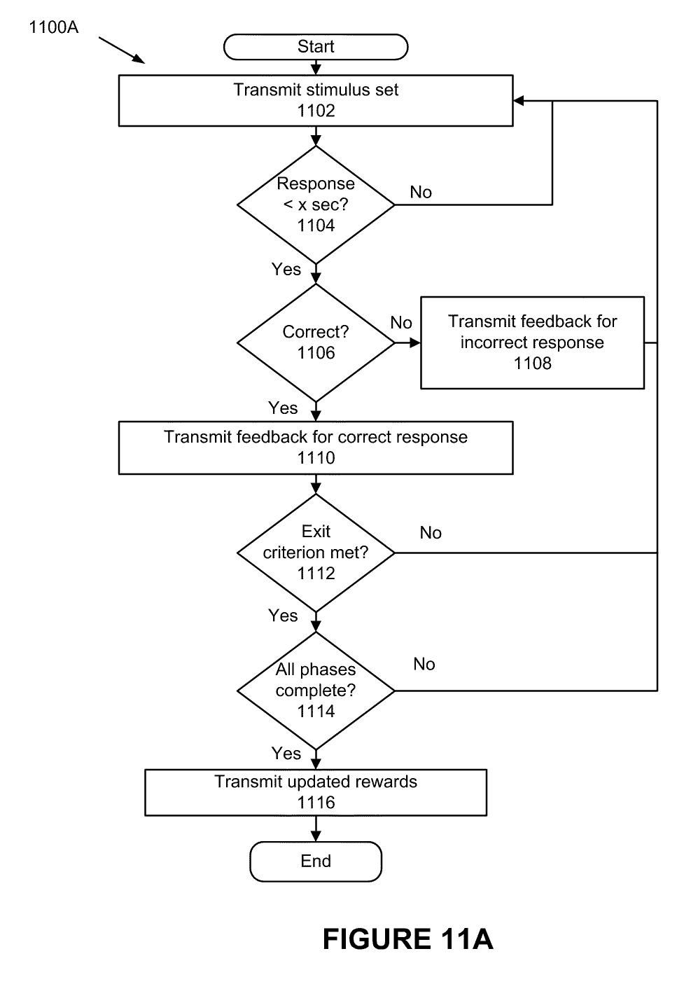

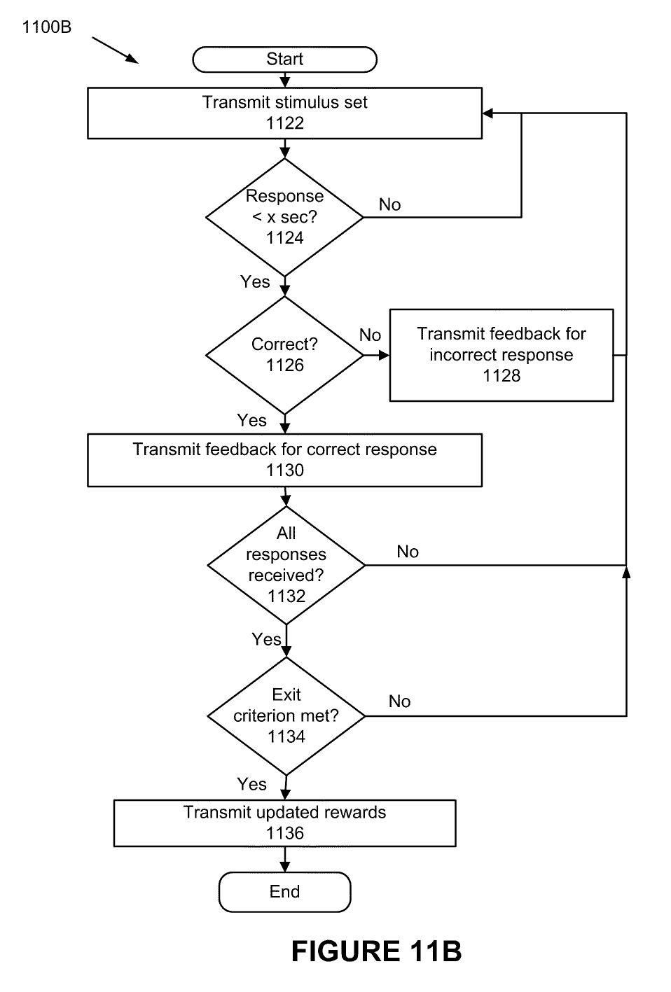

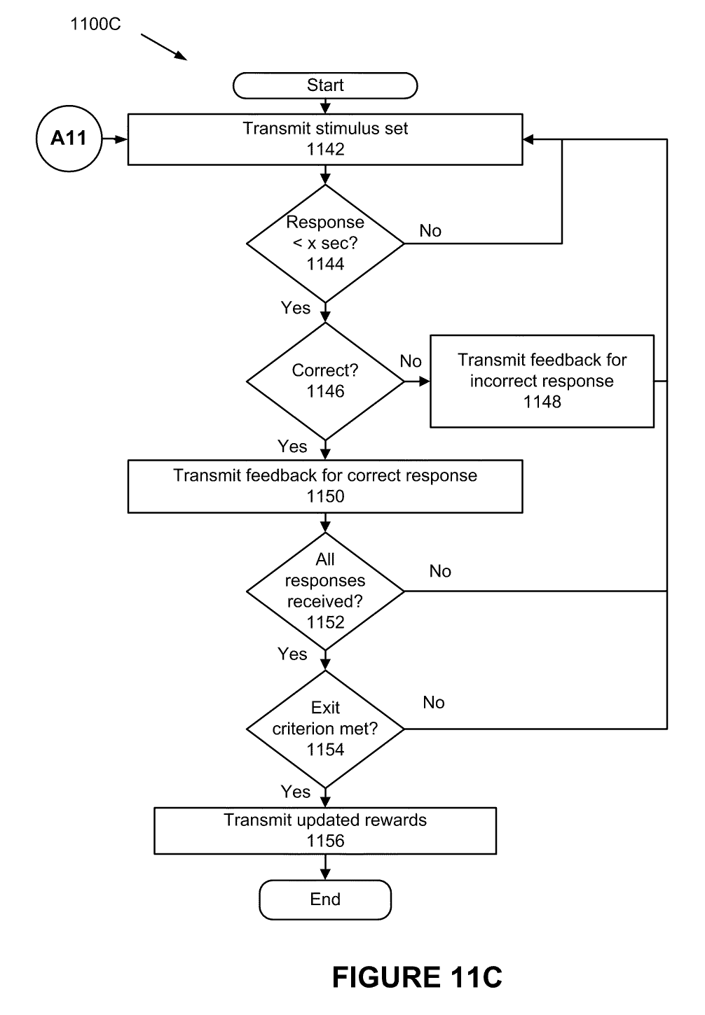

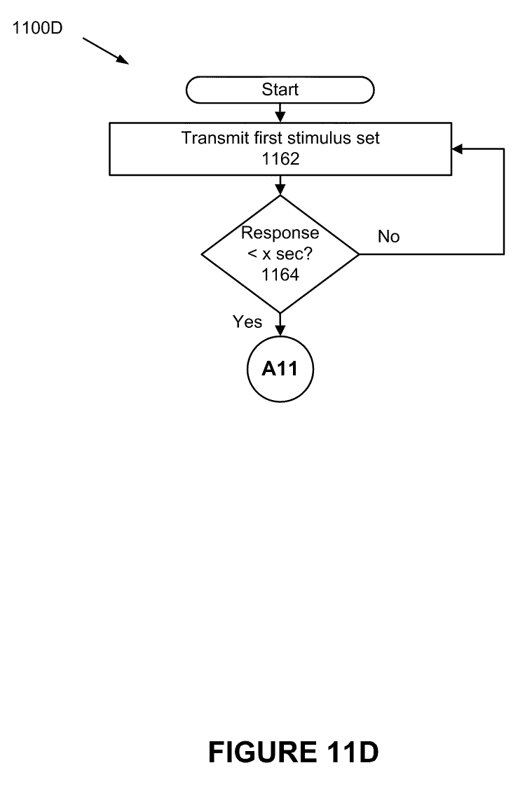

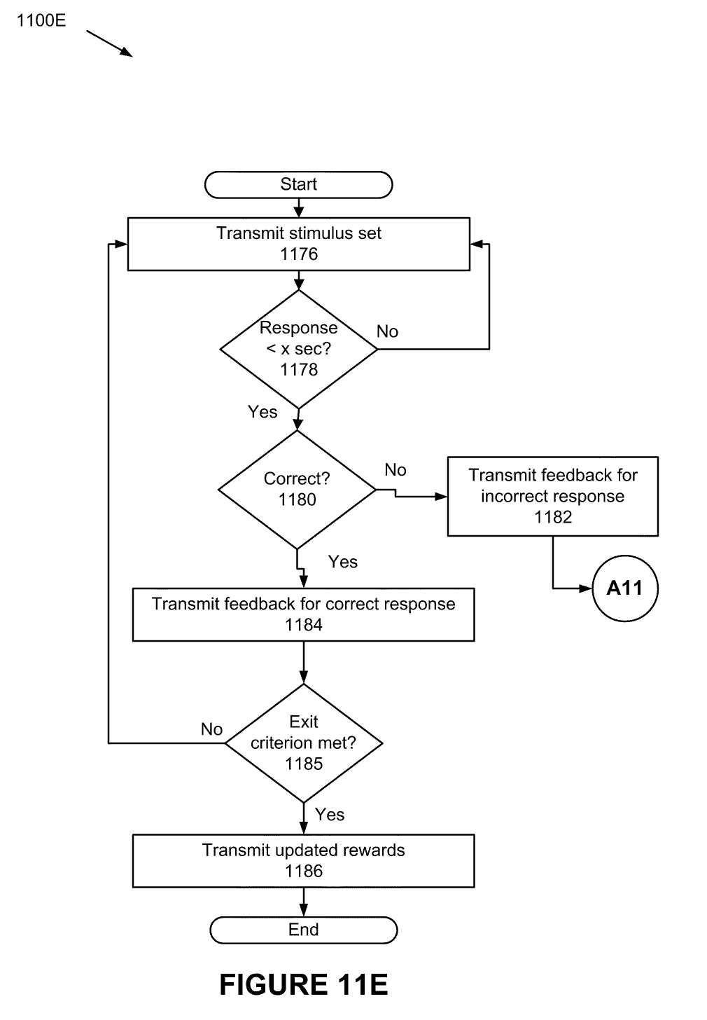

FIG. 11A is a flow chart that illustrates the execution controller 352 performing 1100A a first routine designed to develop the learner's summative skill. The skill addressed by this routine is a component skill of summative comprehension and consists of the ability to determine the theme of very short portions of text (i.e. to establish a thematic category matching between text and theme). The program execution controller 352 performs steps 1102-1112. These steps are similar to steps 1020-1030 described above. Steps 1102-1112 represent one phase and the execution controller 352 performs steps 1102-1112 for a number of phases. After the exit criterion for a phase is satisfied at step 1112, the execution controller 352 determines if all phases are complete. If not, the execution controller 352 repeats steps 1102-1112 for the next phase. If all phases are complete, the execution controller 352 transmits 1116 the updated rewards to the teaching client 106 and directs the teaching client 106 to present the rewards to the learner.

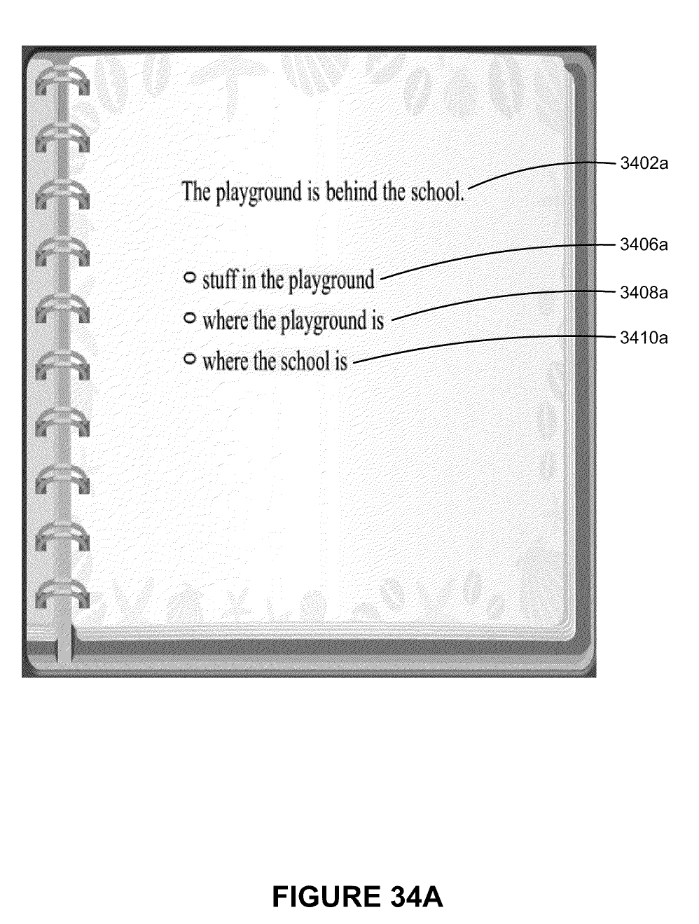

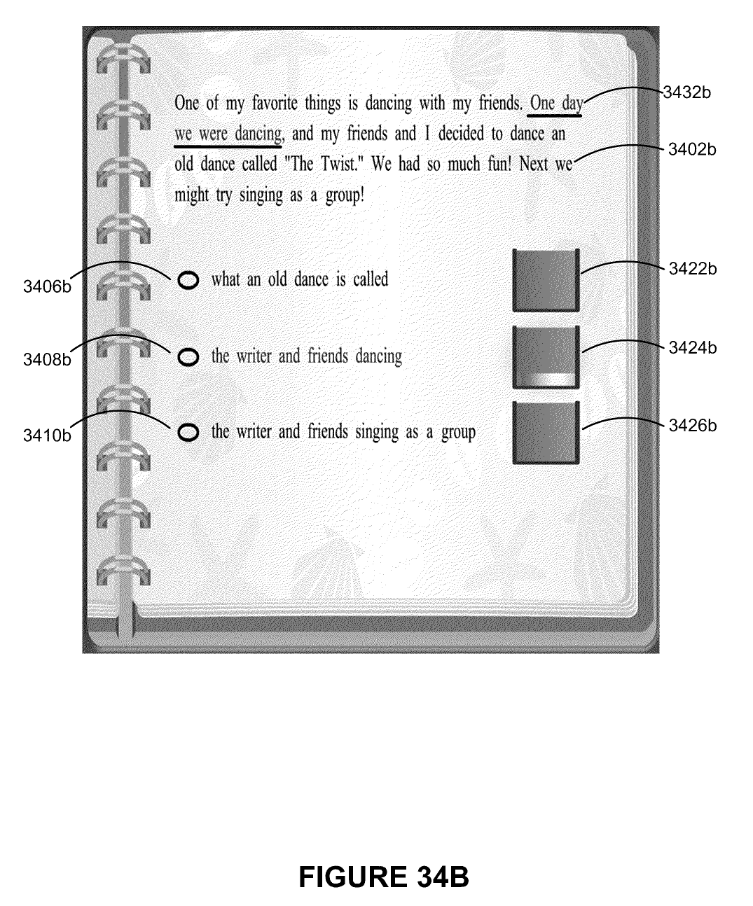

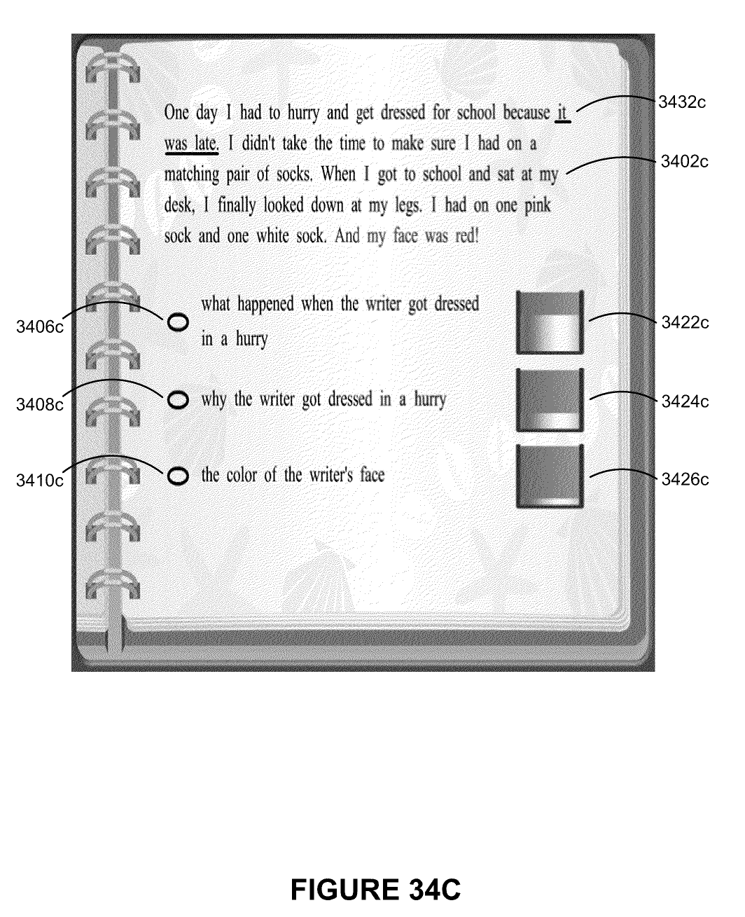

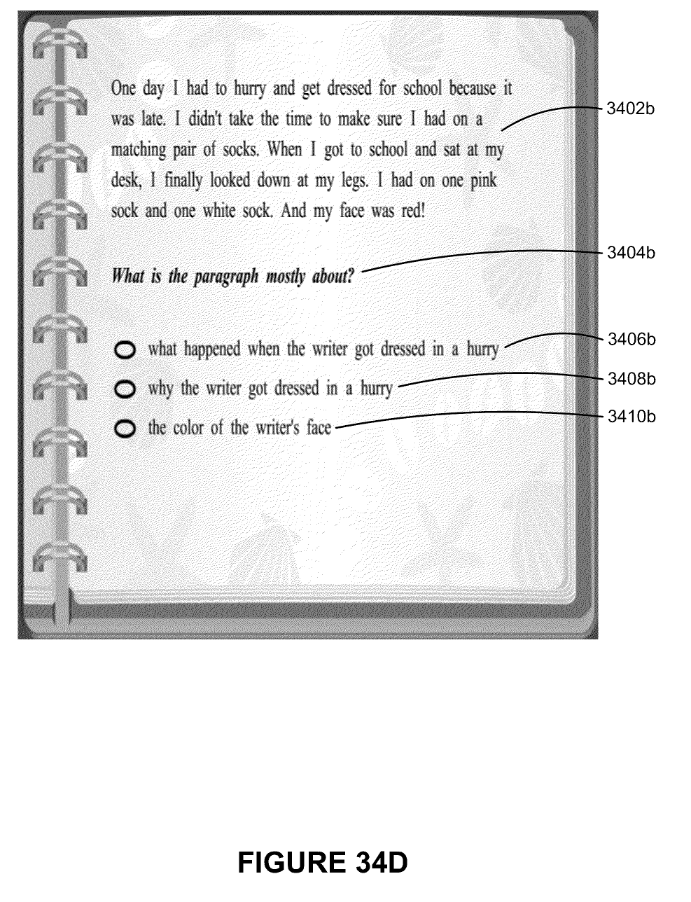

FIG. 34A depicts an example of the stimulus set used for steps 1102-1112. The stimulus set includes a passage line 3402a and three answer choices 3406a-3410a. The stimulus set also includes audio or visual instructions (not shown) directing the user to determine what the passage line 3402a is mostly about. The instructions further direct the learner to select one of the answer choices 3406a-3410a based on the learner's previous determination. Similar stimulus sets with additional levels of complexity can be used for steps 1102-1112 in various phases. For example, the complexity of the stimulus sets can be increased by increasing the number of passage lines 3402a.

FIG. 11B is a flow chart that illustrates the execution controller 352 performing 1100B a second routine designed to develop the learner's summative skill. The execution controller 352 performs steps 1122-1130. These steps are similar to others described above and entail: a) presenting a stimulus set and determining whether the learner responds within the predetermined time frame (1122 and 1124); b) determining whether the learner's response was correct (1126); and c) transmitting the appropriate feedback for the correct or incorrect response (1128 and 1130). Next, the execution controller 352 determines 1132 if all responses from the teaching client 106 have been received. If not, the execution controller 352 performs steps 1122-1132 again.

FIG. 34B depicts an example of the first stimulus set transmitted to teaching client 106 at step 1122. The sequence beginning on step 1122 is designed to teach the learner to relate each portion of a passage with its corresponding theme, thus determining which of the themes provided as possible answers appear in the passage given. This example of the first stimulus set includes passage 3402b, highlighted sentence 3432b, answer choices 3406b-3410b and corresponding answer buckets 3422b-3426b. The stimulus set also includes audio or visual instructions (not shown) informing the learner that highlighted line 3432b is related to answer choice 3406b. The instructions then direct the learner to click on answer bucket 3424b corresponding to correct answer 3406b. The instructions then display the content of highlighted line 3432b transferring to the answer bucket 3432b. Next, another line (not shown) in passage 3402b is highlighted, and the instructions inform the learner about the answer choice related to the highlighted line and then direct the learner to select the bucket corresponding to the answer choice. This process can be repeated for additional lines from the passage 3402b. The instructions then inform the learner to select the answer choice corresponding to the bucket that is filled the most. After the learner selects the answer, the rewards are updated based on the answer being correct or incorrect.

Once the execution controller 352 determines 1132 that all responses for the stimulus set have been received, the execution controller 352 determines 1134 if the exit criterion has been met. The exit criterion, for example, can be all of learner's response being correct without any intermediary incorrect responses. Moreover, the exit criterion can be based on factors described above. If the exit criterion is not met, the execution controller 352 performs steps 1122-1134. Otherwise, the execution controller 352 updates the rewards and transmits 1136 the updated rewards to the teaching client 106.

FIGS. 11C is a flow chart that illustrates the execution controller 352 performing 1100C a third routine designed to develop the learner's summative skill. The execution controller 352 performs steps 1142-1156 and these steps are similar to steps 1122-1136 described above. However, the stimulus set for FIG. 11C differs from stimulus set of FIG. 11B.

FIG. 34C depicts an example of stimulus set used in FIG. 11C. Unlike the stimulus set in FIG. 11B, this stimulus does not inform the learner about the bucket that matches the highlighted line. The learners now have to match the bucket themselves. The stimulus set in FIG. 34C comprises passage 3402c, highlighted line 3432c, answer choices 3406c-3410c and corresponding answer buckets 3422c-3426c. The stimulus set also includes audio or visual instructions (not shown) directing the learner to determine the answer choice that matches the highlighted line 3432c. The instructions then instruct the learner to drag the highlighted line 3432c to the bucket corresponding to the matching answer choice. After receiving the learner's selection, another line (not shown) in passage 3402c is highlighted, and the instructions similar to instructions for highlighted line 3432c are presented to the learner. This process can be repeated for additional lines from the passage 3402c. The instructions then inform the learner to select the answer choice corresponding to the bucket that is filled the most. After the learner selects the answer, the rewards are updated based on the answer being correct or incorrect.

FIG. 11D is a flow chart that illustrates the execution controller 352 performing 1100D a fourth routine designed to develop the learner's summative skill. The execution controller 352 transmits the first stimulus set to the teaching client 106 and directs the teaching client 106 to present the stimulus set to the learner. The execution controller 352 then determines if it has received a learner's response from the teaching client 106 in a pre-determined amount of time. If not, the execution controller 352 transmits the first stimulus set to the teaching client 106 again and/or again directs the teaching client 106 to present the first stimulus set. The execution controller repeats steps 1162-1164 until a response is received. After a response is received at step 1164, the execution controller 352 performs steps 1142-1156 described above.

FIG. 34D depicts an example of the first stimulus set used in method of FIG. 11D. The first stimulus in FIG. 34D comprises a passage 3402b, question 3404b and three answer choices 3406b-3410b. The first stimulus also includes visual or audio instructions (not shown) directing the learner to determine what the passage 3402b is mostly about. Based on that determination, the instructions direct the learner to choose the correct answer from available answer choices 3406b-3410b. If the learner does not respond in a pre-determined time, the instructions again prompt the learner to determine and choose one of the answer choices 3406b-3410b. After receiving a learner's answer choice, a second stimulus is presented to the learner (as depicted in FIG. 11C). The second stimulus is depicted in FIG. 34C and described above. The second stimulus is used to direct the learner through the process of getting the correct answer for the mostly about question asked in the method of FIG. 11C. In this manner, the analytical process of getting to the right answer is reaffirmed for the learner.

FIG. 11E is a flow chart that illustrates the execution controller 352 performing 1100E a fifth routine designed to develop the learner's summative skill. The execution controller 352 transmits 1176 a stimulus set to the teaching client 106 and directs the teaching client 106 to present the stimulus to the learner. The execution controller 352 then determines 1178 if it has received a learner's response from the teaching client 106 in a pre-determined amount of time. If not, the execution controller transmits 1176 the stimulus set to the teaching client 106 again and/or again directs the teaching client 106 to present the stimulus set. The execution controller repeats steps 1176-1178 until a response is received.

After a response is received at step 1178, the execution controller 352 determines 1180 if the received response is correct. If not, the execution controller 352 transmits 1182 the feedback for incorrect response to the teaching client 106 and directs the teaching client 106 to present the feedback to the learner. The execution controller 352 then performs steps 1142-1156 described above.

On the other hand, if the execution controller 352 determines 1180 that the received response is correct, the execution controller 352 transmits 1184 feedback for the correct response and directs the teaching client 106 to present the feedback. Next, the execution controller 352 determines 1185 if the exit criterion for the method of FIG. 11E has been met. The exit criterion is based on one or more factors described above. If the exit criterion has not been met, the execution controller 352 repeats steps 1176-1185. Otherwise, the execution controller 352 updates the rewards for the received answer, transmits 1186 the updated rewards to the teaching client 106, and directs the teaching client 106 to present the rewards to the learner.

The method illustrated in FIG. 11E is therefore similar to the method illustrated in FIG. 11D. The difference between the two methods is when the execution controller 352 directs the learner through the analytical framework of getting to the correct choice. The execution controller 352 in FIG. 11D directs the learner through the analytical process regardless of whether the learner answered the question correctly or incorrectly. On the other hand, the execution controller 352 in FIG. 11E does not direct the learner through the analytical process if the learner answers the question correctly.

In sum, the methods illustrated in FIG. 11A-E help the learners develop their summative skills gradually with the execution controller 352 presenting fewer instructions to the learner on how to determine the correct answer as the learners develop their summative skills.

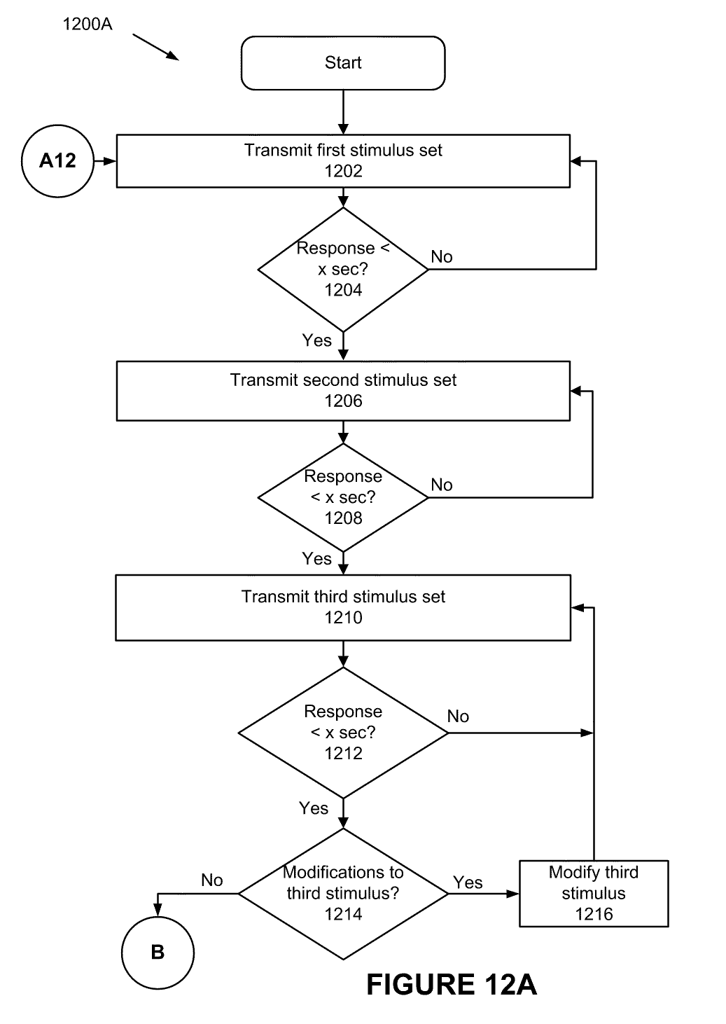

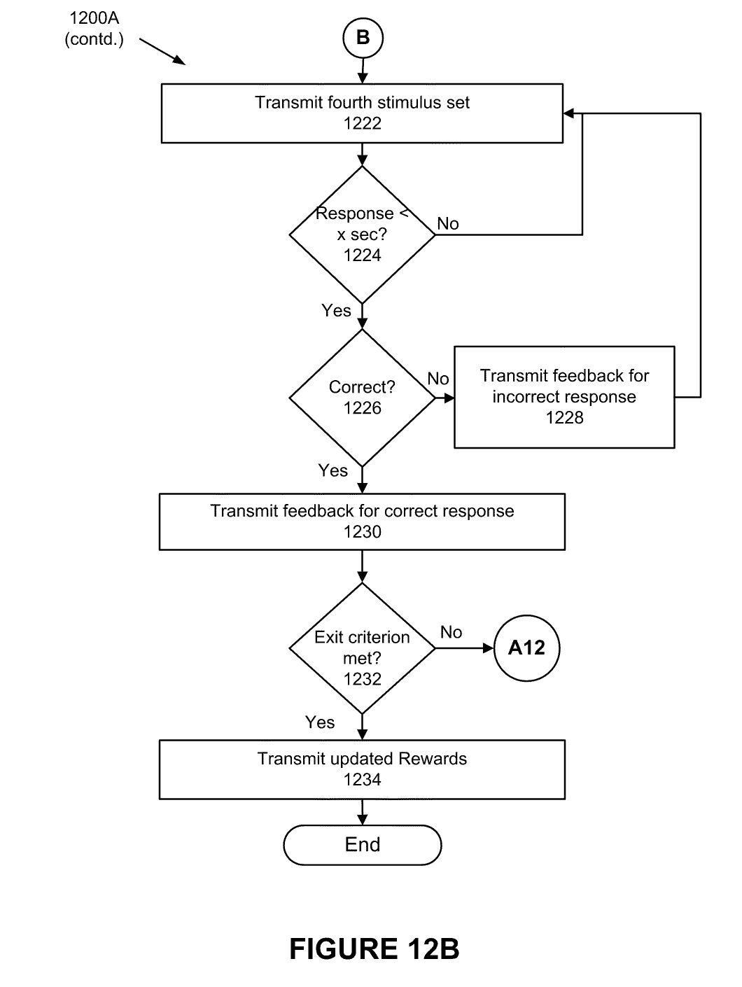

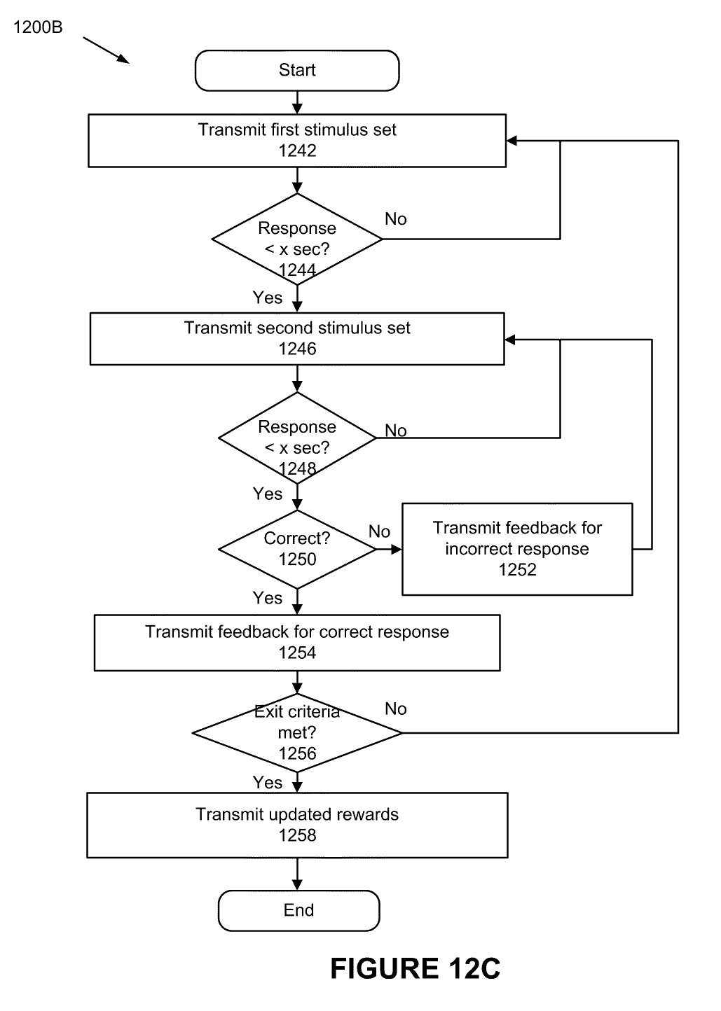

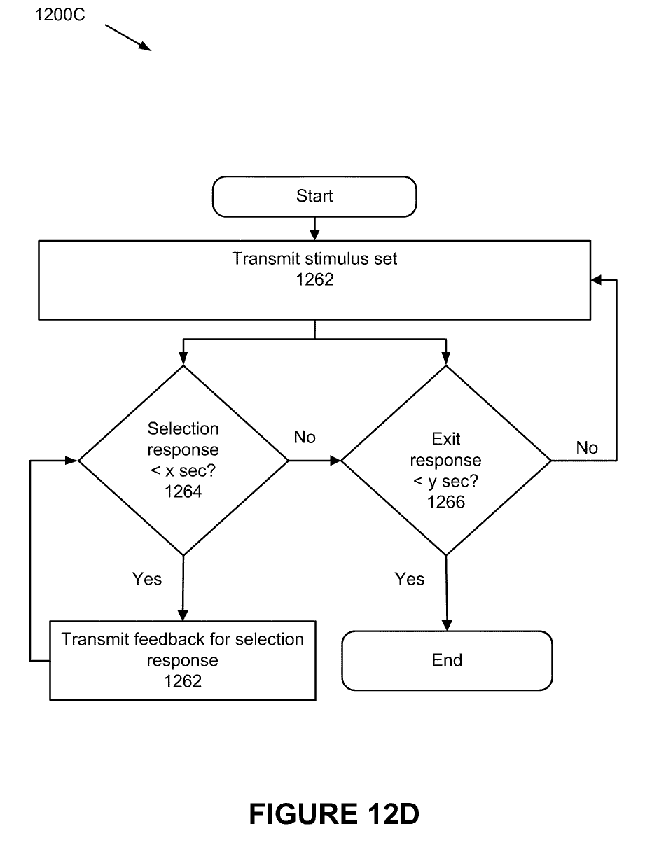

FIGS. 12A-B are a flow chart that illustrates the execution controller 352 performing 1200A a first routine designed to develop the learner's vocabulary skill, or the ability to derive the meaning of one or more words from the context. The routine helps the learner determine a word's meaning through its context in the passage. The execution controller 352 performs steps 1202-1204 for the first stimulus, steps 1206-1208 for the second stimulus and steps 1210-1212 for the third stimulus. These pairs of steps are similar to steps 1176-1178 described above. After receiving the response from the teaching client 106 in step 1212, the execution controller 352 determines 1214 if the third stimulus needs to be modified. If yes, the execution controller 352 modifies 1216 the third stimulus and repeats steps 1210-1216 until no more modifications are required for the third stimulus.

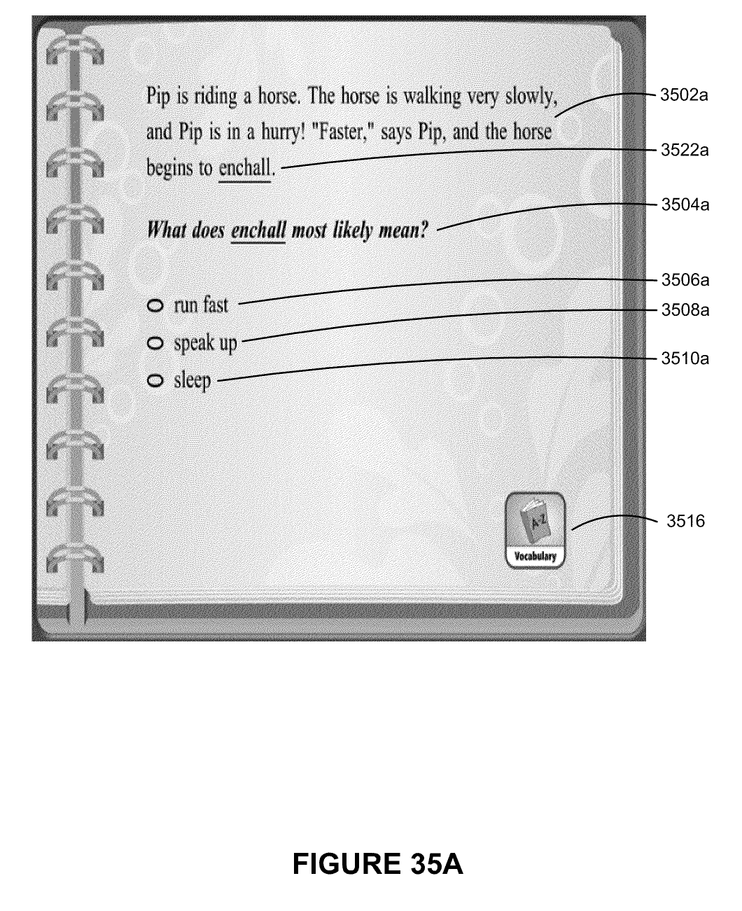

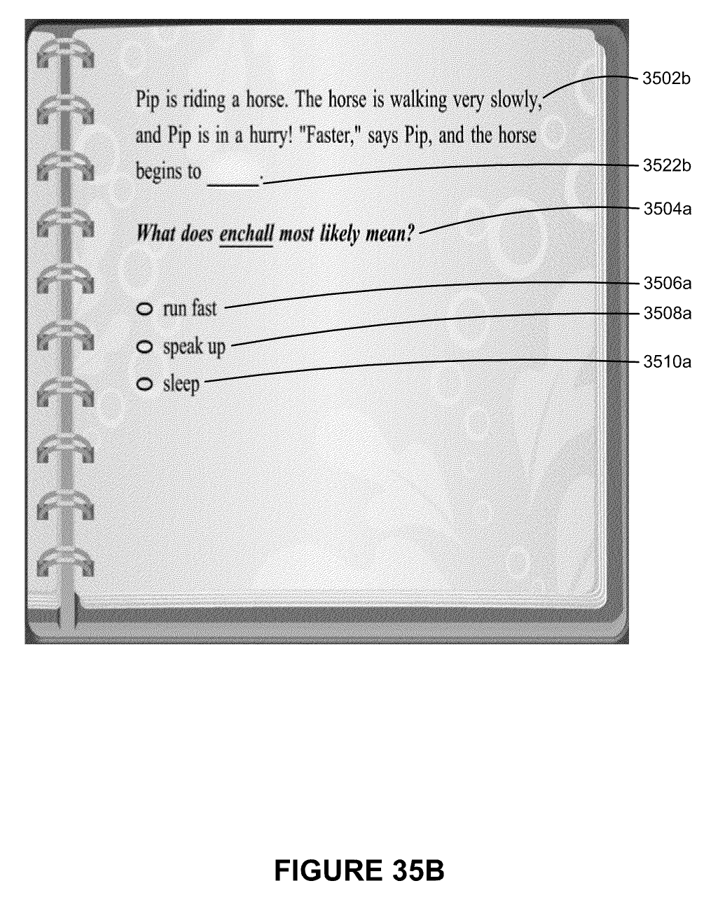

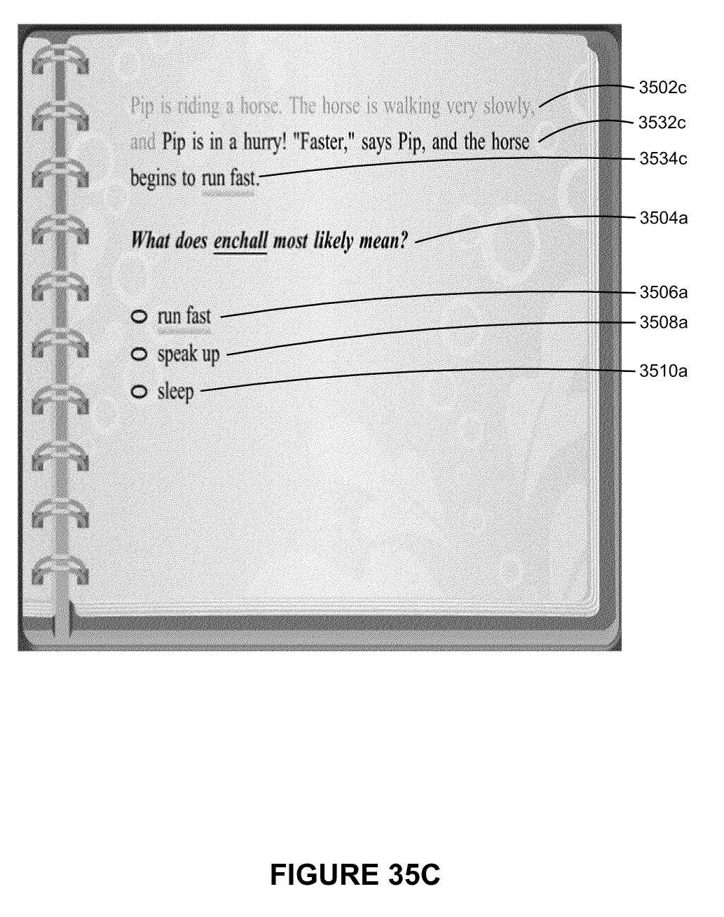

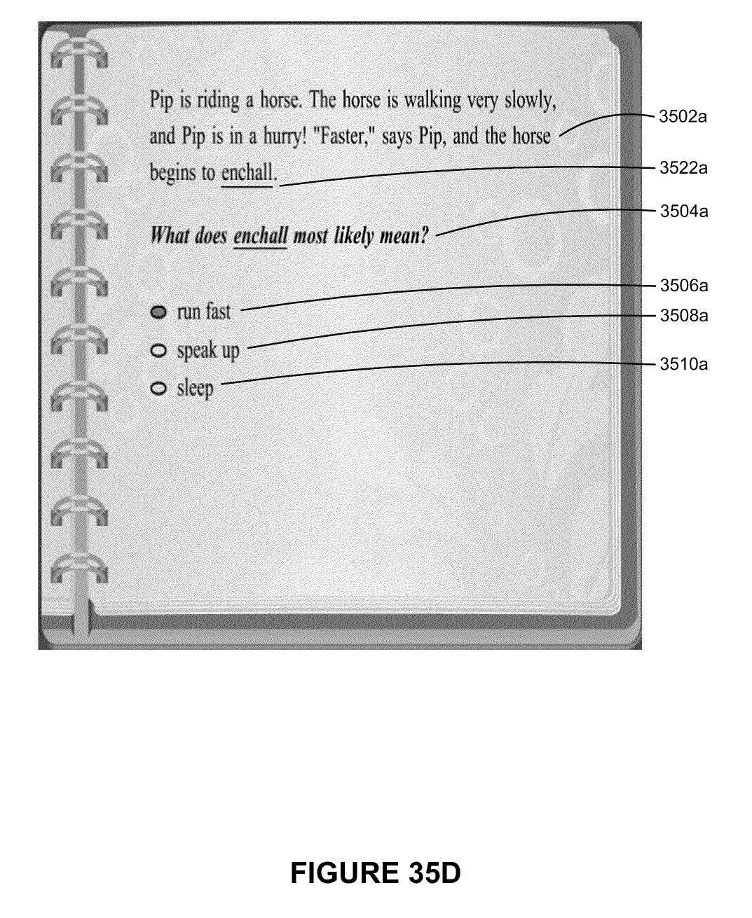

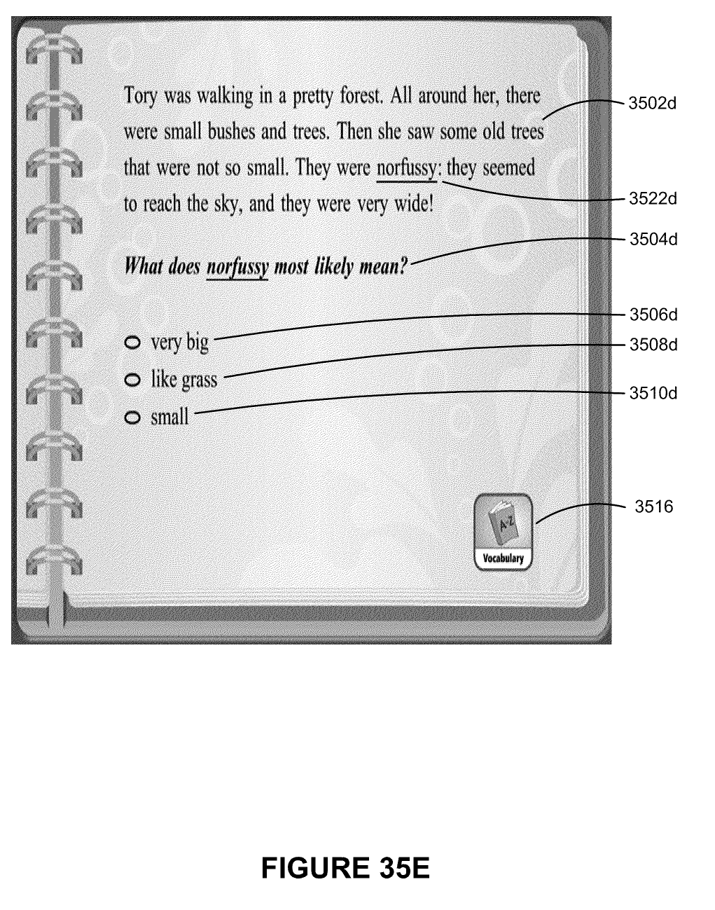

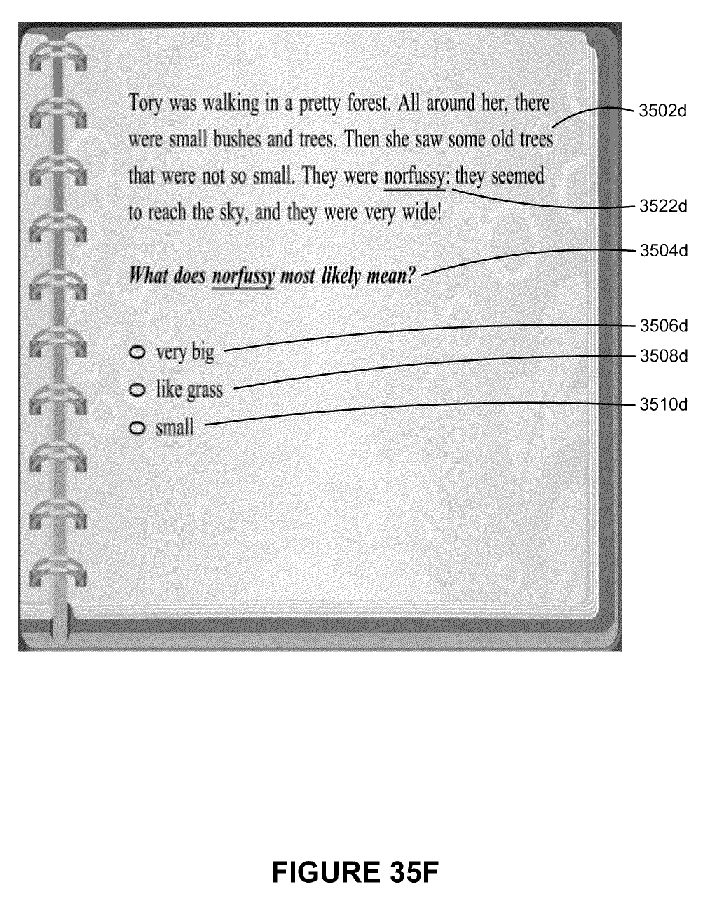

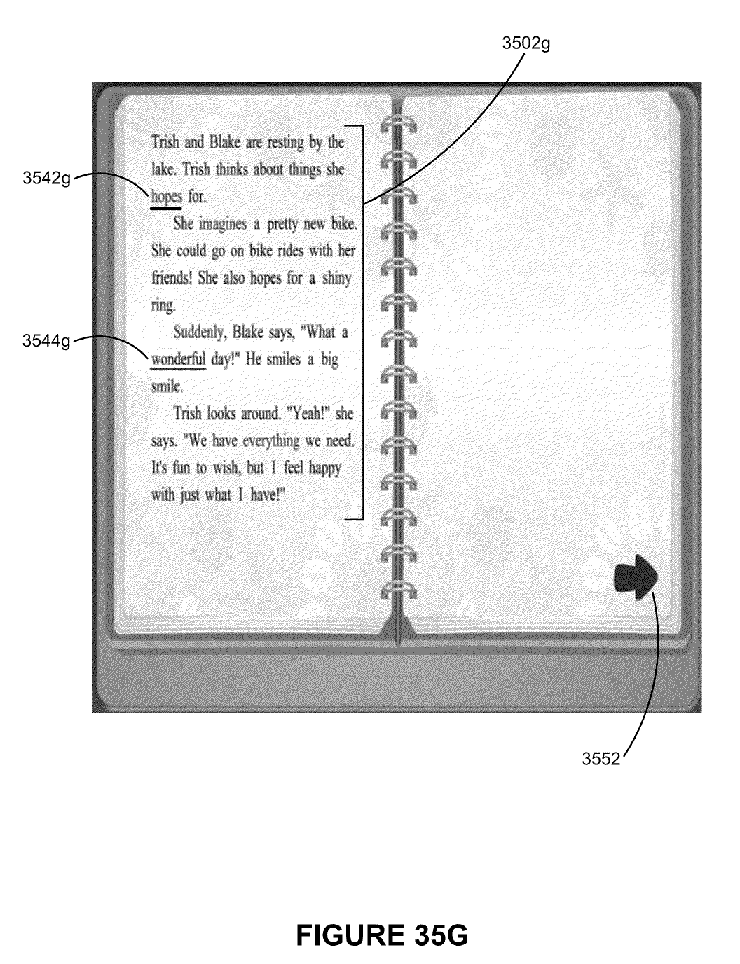

FIGS. 35A-C depict examples of first, second and third stimulus. The first stimulus in FIG. 35A comprises passage 3502a, highlighted made-up word 3522a (e.g. “enchall”), question 3504a, answer choices 3506a-3510a and vocabulary icon 3516. The first stimulus also comprises visual or audio instructions (not shown) directing the learner to read the passage 3502a, question 3504a, the three answer choices 3506a-3510a and then select the vocabulary icon 3516.

After the learner selects the vocabulary icon 3516, the second stimulus set is presented to the learner. An example of second stimulus set is depicted in FIG. 35B. The second stimulus set comprises the passage 3502b, the question 3504a and the answer choices 3506a-3510a. The passage 3502b is the same as passage 3502a except passage 3502b includes a blank 3522b in place of the made up word 3522a. The second stimulus also comprises instructions directing the learner to insert each answer choice 3506a-3510a in place of the blank 3522b and determine the answer choice that makes sense in the passage 3502b.

Accordingly, the third stimulus depicted in FIG. 35C comprises passage 3502c with highlighted sentence 3532c that previously included the made up word 3522a. However, the highlighted sentence 3532c now includes answer choice 3506a in place of the made up word 3522a. Additionally, the third stimulus includes the question 3504a and the three answer choices 3506a-3510a. The third stimulus also includes visual or audio instructions (not shown) that direct the learner to read the highlighted sentence 3532c with the answer choice 3504a and determine if it makes sense. Next, the instructions direct the learner to select the next answer choice 3508a.

The third stimulus is then modified, the answer choice 3506a is removed from the highlighted sentence 3532c and answer choice 3508a is inserted in its place. The instructions then direct the learner to read the highlighted sentence 3532c with the answer choice 3508a and determine if it makes sense. The third stimulus is then modified again for the remaining answer choice 3510a and the instructions again direct the learner to read sentence 3532c. After the third stimulus has been modified for all answer choices 3506a-3510a, the third stimulus does not need to be modified anymore and the execution controller 352 moves to steps in FIG. 12B.

Referring to FIG. 12B, after the execution controller 352 determines that the third stimulus does not need to be modified any more, the execution controller performs steps 1222-1230 for the fourth stimulus. These steps are similar to others described above and entail: a) presenting a stimulus set and determining whether the learner responds within the predetermined time frame (1222 and 1224); b) determining whether the learner's response was correct (1226); c) transmitting the appropriate feedback for the correct or incorrect response, including feedback about why the incorrect response was incorrect with respect to one or more missing critical features (1228 and 1230); and d) determining whether the exit criterion for this instructional sequence was met, whereupon either a new section of the sequence is introduced or more stimulus sets are presented as necessary to meet the exit criterion. After transmitting the feedback for the correct response, the execution controller 352 determines 1232 if the exit criterion for the routine has been met. An example of exit criterion is correctly answering two consecutive vocabulary questions. Moreover, the exit criterion can be based on factors described above. If the exit criterion is not met, the execution controller 352 performs steps 1202-1232 again with different stimulus sets. Otherwise, the execution controller 352 updates the rewards based on the received responses in the routine, transmits 1234 the updated rewards and directs the teaching client 106 to present the rewards to the learner.

FIG. 35D depicts an example of the fourth stimulus set used in step 1222. The fourth stimulus set in FIG. 35D comprises the passage 3502a, made up word 3522a, question 3504a and answer choices 3506a-3510a. The fourth stimulus also comprises visual or audio instructions directing the learner to select the correct answer choice based on what the learner learned from the first, second and third stimulus sets. After the learner selects the answer, the rewards are updated based on the answer being correct or incorrect.

FIG. 12C is a flow chart that illustrates the execution controller 352 performing 1200B a second routine designed to develop the learner's vocabulary skill. This routine is similar to the routine of FIGS. 12A-B. However, this routine does not direct the learners through each analytical step and expects the learners to perform those analytical steps themselves. The execution controller 352 performs steps 1242-1258. These steps are similar to steps 752-768 described above.

FIG. 35E depicts an example of the first stimulus set used in the routine of FIG. 12C. The first stimulus set in FIG. 35E comprises passage 3502d, made up word 3522d, question 3504d, answer choices 3506d-3510d, and vocabulary icon 3516. The first stimulus set also includes visual or audio instructions directing the learner to read passage 3502d, question 3504d, answer choices 3506d-3510d, and then select the vocabulary icon 3516.

After the user selects the vocabulary icon 3516, the execution controller 352 transmits the second stimulus set to the teaching client 106. An example of the second stimulus set is depicted in FIG. 35F. The second stimulus set in FIG. 35F includes passage 3502d, made-up word 3522d, question 3504d and answer choices 3506d-3510d. The second stimulus set also includes instructions directing the user to determine the meaning of the made-up word 3522d and select a corresponding answer choice. After the learner selects the answer, feedback is presented based on the answer being correct or incorrect. The execution controller 352 then determines 1256 if the exit criterion for routine has been met and either updates the rewards (1258) or presents new stimulus sets as needed to meet the exit criterion. The remaining presentations of the first stimulus set in this routine are actual words with a low probability of being in the learner's repertoire (as opposed to made-up words).

FIG. 12D is a flow chart that illustrates the execution controller 352 performing 1200C a third routine designed to develop the learner's vocabulary skill. The execution controller 352 transmits 1262 the first stimulus set to the teaching client 106 and directs the teaching client 106 to present the first stimulus to the learner. The execution controller 352 then determines 1264 if a selection response or an exit response is received from the teaching client 106. If a selection response is received within a pre-determined amount of time (e.g. x seconds), the execution controller 352 transmits 1262 feedback for the selection response to the teaching client 106 and directs the teaching client 106 to present the feedback to the learner. If a selection response is not received, the execution controller 352 determines 1266 if an exit response is received within a pre-determined amount of time (e.g. x seconds). If exit response is not received, the execution controller 352 again transmits 1262 the first stimulus set to the teaching client 106 and/or directs the teaching client 106 to present the first stimulus set again to the learner. If the exit response is received, the execution controller exits the method of FIG. 12D.

The first stimulus set used in the method of FIG. 12D is meant to teach the learner the pronunciation and/or the meaning of various words. An example of such a stimulus set is depicted in FIG. 35G. The stimulus set in FIG. 35G comprises passage 3502g, highlighted words 3542g-3544g and exit icon 3552. The stimulus set also includes visual or audio instructions (not shown) directing the learner to select one of the highlighted words to hear the pronunciation and/or meaning of the highlighted word. If the learner selects one of the highlighted words, instructions inform the learner about the selected word's pronunciation and/or meaning. The instructions also inform the learner to select the exit icon 3552 to exit the routine. The learner can exit the routine by selecting the exit icon 3552.

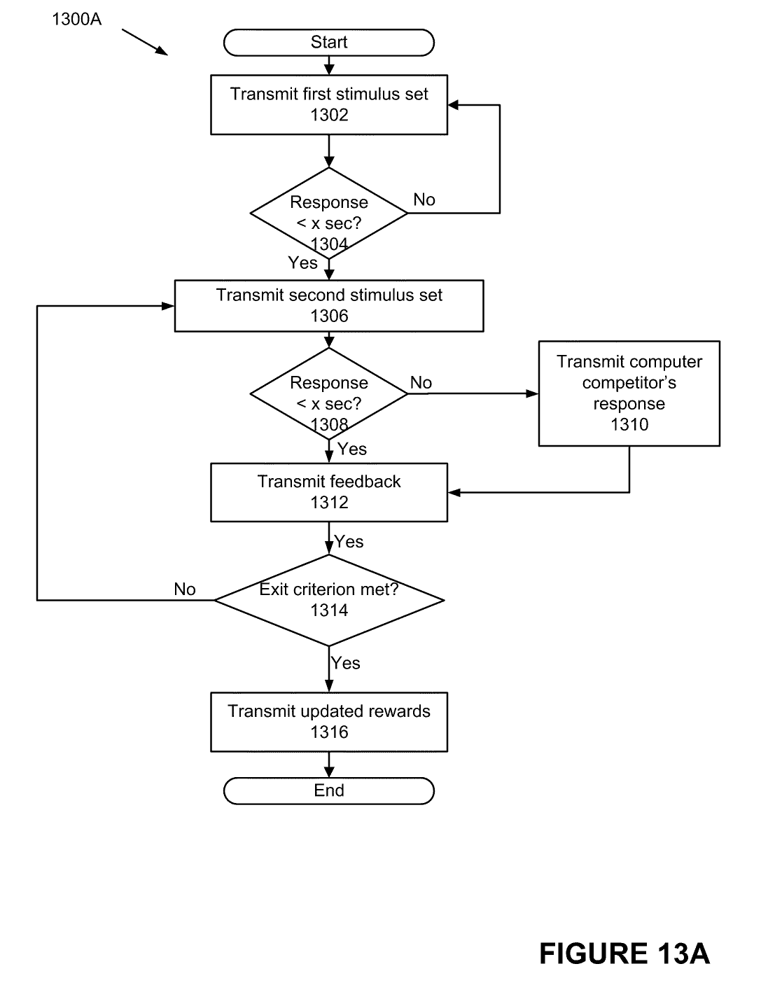

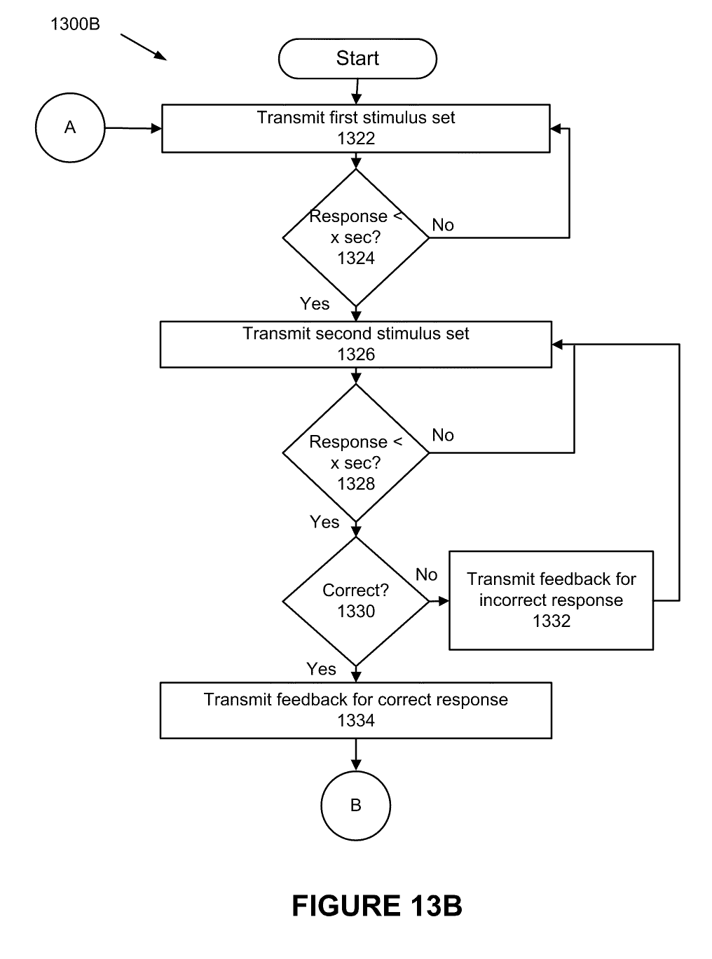

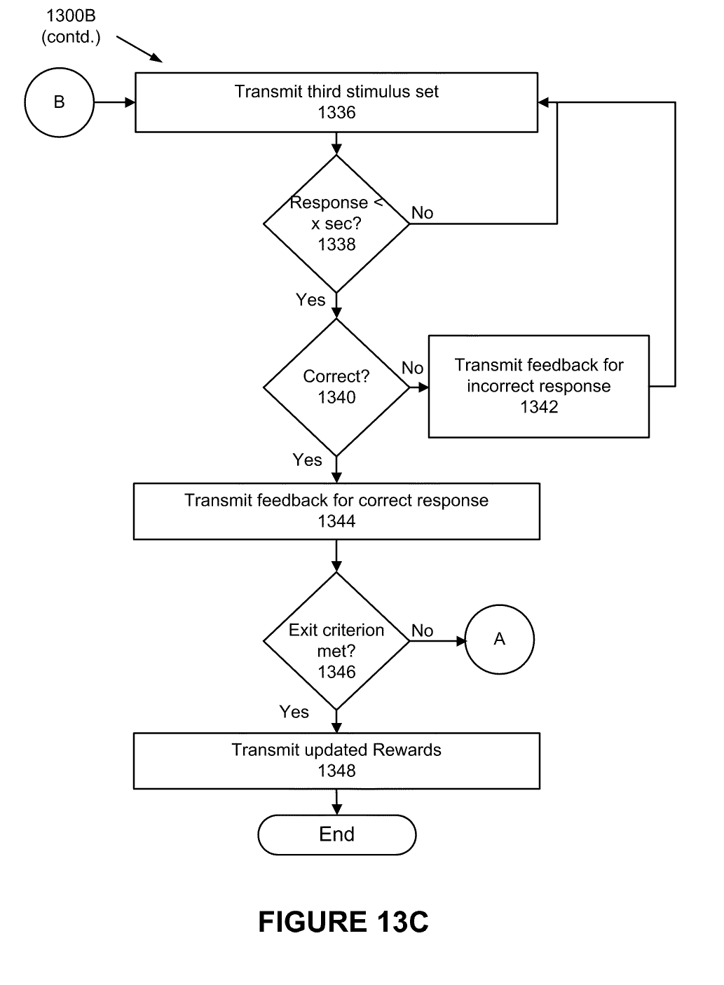

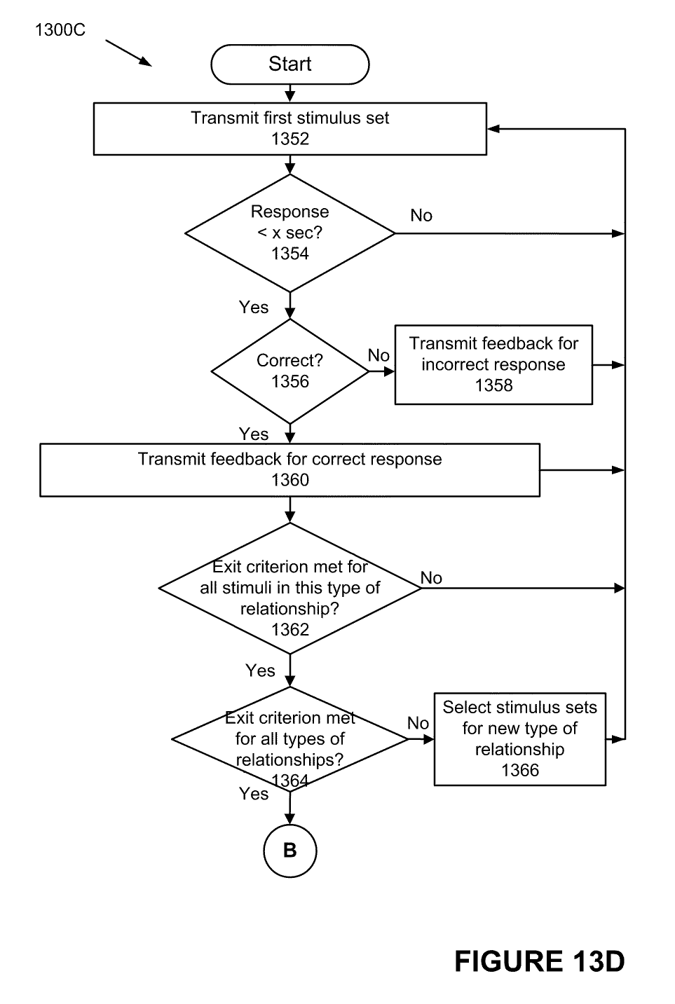

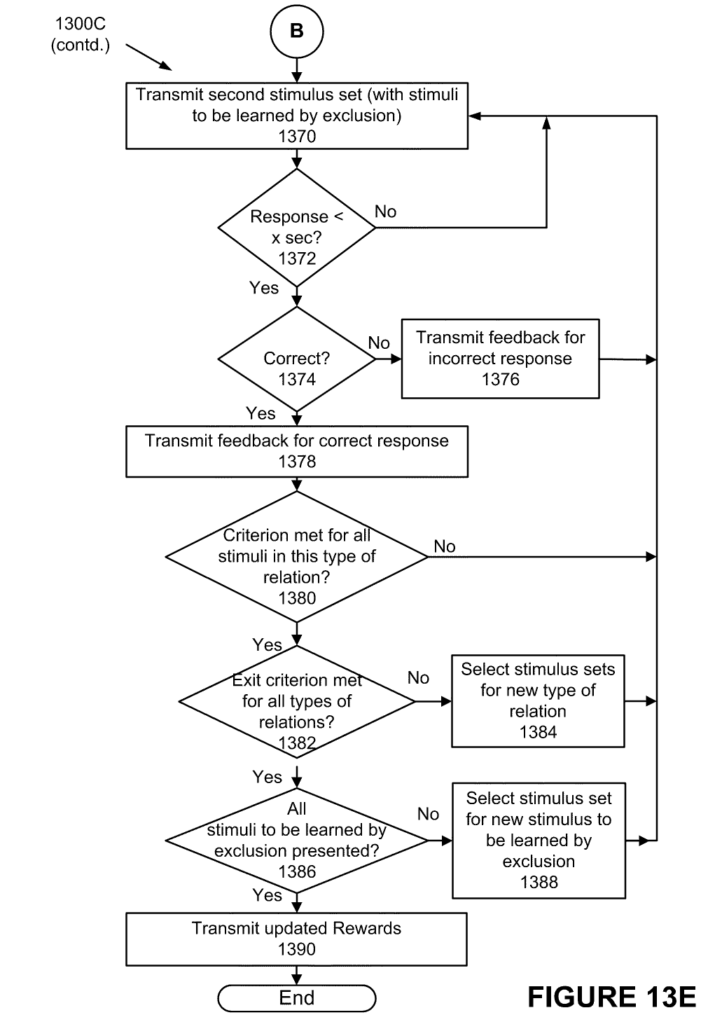

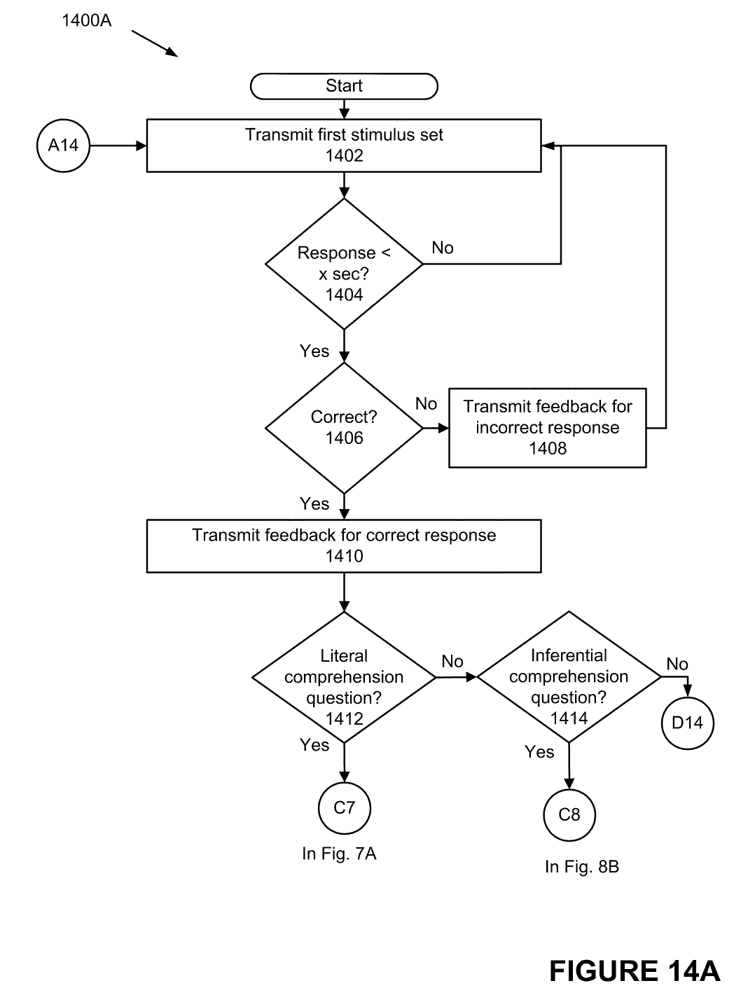

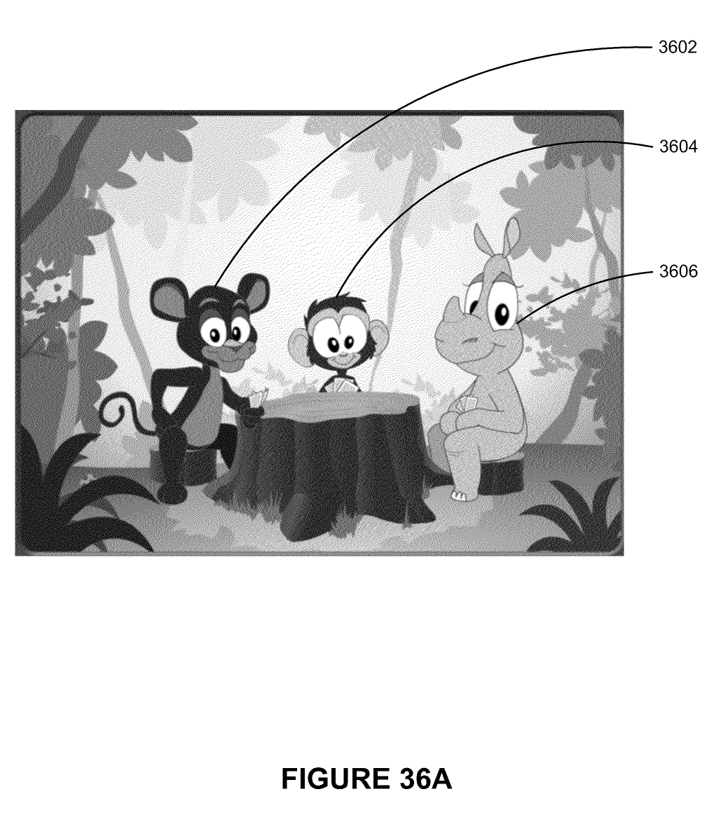

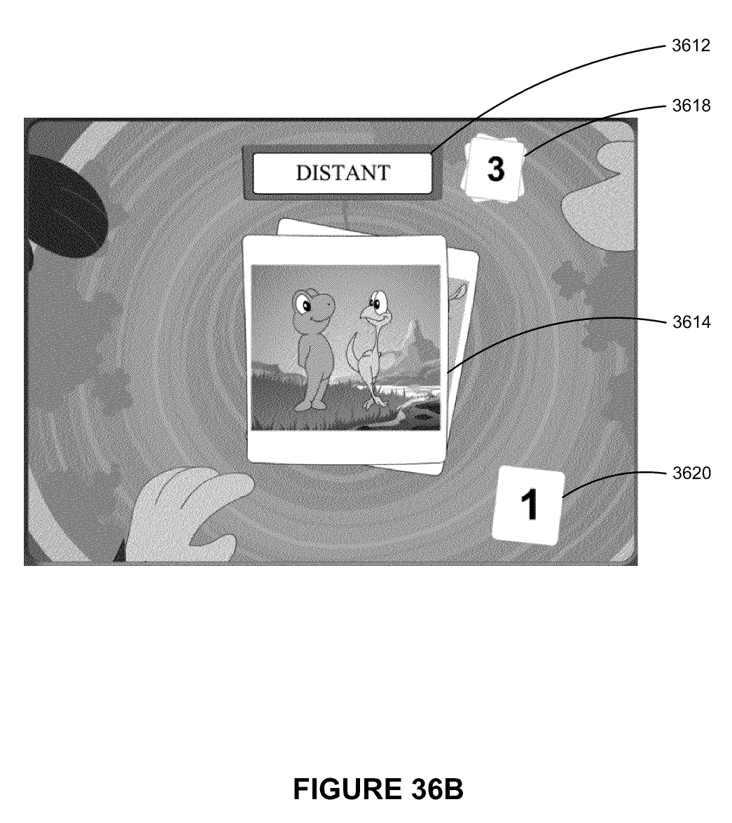

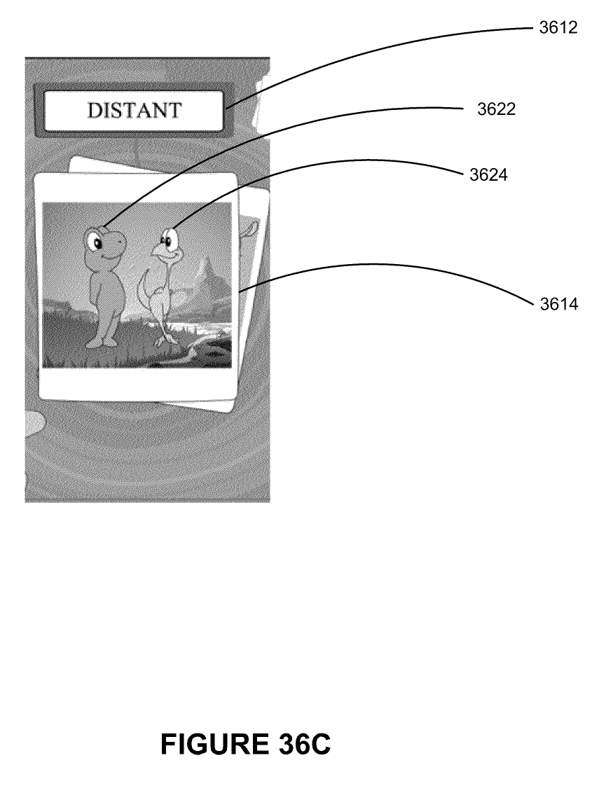

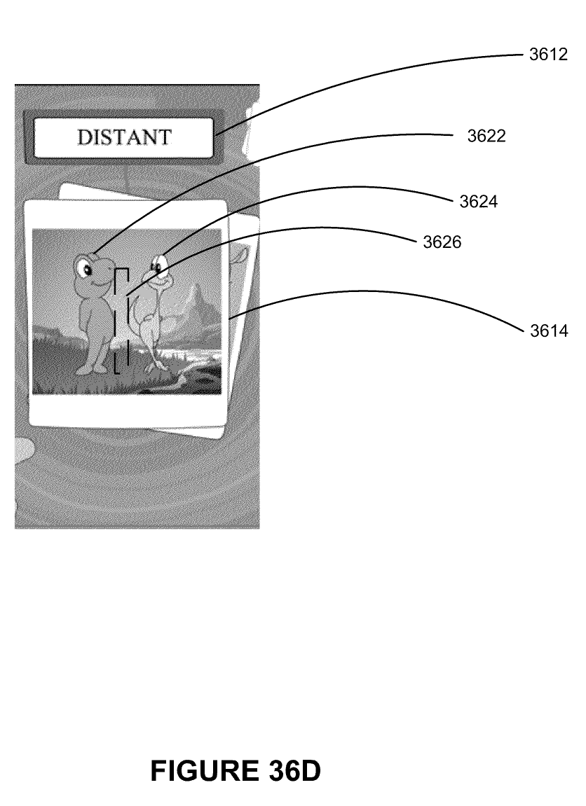

FIG. 13A is a flow chart that illustrates the execution controller 352 performing 1300A a first word game routine designed to develop the learner's vocabulary skills by having the learner respond to a multitude of varying features for that vocabulary word and therefore expand the range of stimuli to which a vocabulary word is applied. Simultaneously, the sequence restricts the range of stimuli to which a vocabulary word is applied by presenting instances that lack one or more critical features of the vocabulary word. The execution controller 352 transmits 1302 a first stimulus set to the teaching client 106 and directs the teaching client 106 to present the first stimulus to the learner. An example of the first stimulus set used in method of FIG. 13A is described below in FIG. 36A. The execution controller then determines 1304 if a learner's response has been received within a predetermined amount of time. If not, the execution controller 352 repeats steps 1302-1304.

FIG. 36A depicts an example of the first stimulus set transmitted in step 1302 above. The stimulus set in FIG. 36A comprises three characters 3602, 3604, 3606. The stimulus set also comprises audio or visual instructions (not shown) directing the learner to select one of the characters. If the learner does not select a character within a pre-determined amount of time the instructions for selecting a character are repeated.

After the execution controller 352 receives a response from teaching client 106, the execution controller 352 transmits 1306 a second stimulus set to the teaching client 106 and directs the teaching client 106 to present the stimulus set to the learner. An example of the second stimulus set is described in FIG. 36B. The execution controller 352 then determines 1308 if a learner's response to the second stimulus set is received within a predetermined amount of time. If a response has been received, the execution controller 352 transmits 1312 feedback for the response to the teaching client 106. Otherwise, the execution controller 352 transmits 1310 a computer competitor's response to the teaching client 106 and then transmits 1312 the feedback for competitor's response.

The execution controller 352 then determines 1314 if the exit criterion for the word game routine has been satisfied 1314. If the exit criterion has been satisfied, the execution controller 352 updates the rewards based on the received responses, transmits 1316 the updated rewards to the teaching client 106 and directs the teaching client 106 to present the rewards to the learner. If not, the execution controller 352 performs steps 1306-1314 with a new instance of the second stimulus set.

FIG. 36B depicts an example of the second stimulus set used above. The second stimulus set in FIG. 36B comprises a word 3612, an image 3614, a computer competitor's score 3618 and the learner's score 3620. The stimulus set also includes audio or visual instructions (not shown) that direct the learner to select the image 3614 when the image matches the word 3612. If the learner selects the image within a predetermined amount of time, the learner receives audio or visual feedback informing the learner if the selected image 3614 matches the word 3612. The learner's score is also updated based on whether the selected image 3614 matches the word 3612.

If the learner does not select the image within the predetermined amount of time, the computer competitor can select the image and the computer competitor's score is adjusted accordingly (1310 and 1312 in FIG. 13A). The execution controller 352 then determines if the exit criterion has been met. If not, another word 3612 is presented and the game of selecting the matching image continues. After the learner or computer competitor has correctly matched a predetermined number of images, the exit criterion for the game is met and the game is finished.

FIGS. 13B-C are a flow chart that illustrates the execution controller 352 performing 1300B a second word game routine designed to develop the learner's vocabulary skill. The execution controller 352 performs steps 1322-1334 and these steps are similar to steps 702-714 described above. An example of the first stimulus set transmitted at step 1322 is described in FIG. 36C and an example of the second stimulus set transmitted at step 1326 is described in FIG. 36D.

FIG. 36C illustrates an example of the first stimulus set used in steps 1322-1324. The first stimulus set in FIG. 36C comprises a word 3612 “distant” and an image 3614. The image comprises two characters 3622, 3624 standing next to each other. The stimulus set also includes audio or visual instructions (not shown) that instruct the learner to determine if the word 3612 “distant” matches the image 3614 and to click on the image 3614 after the learner has made the determination. If the learner does not respond in a predetermined amount of time, the instructions are repeated to the learner. After the learner clicks on the image, the second stimulus set is transmitted to teaching client 106 and presented to the learner.

FIG. 36D illustrates an example of the second stimulus set transmitted in step 1326. The second stimulus set in FIG. 36D comprises a word 3612 “distant” and an image 3614. The image comprises two characters 3622, 3624 standing next to each other and a relevant part 3626 that is invisible to the learner. The stimulus set also includes audio or visual instructions (not shown) that instruct the learner to identify part of the image that is relevant to the word 3612 “distant.”

If the learner correctly identifies the relevant part as the part between the two characters 3622, 3624, the instructions give the learner feedback about the correctly chosen answer. The feedback can include encouragement and explanation for why the chosen answer is correct. If the learner does not correctly identify the relevant part, the instructions provide the learner with feedback for incorrect answer. The feedback informs the learner about the incorrect answer and the reasons why the answer is incorrect.

Referring to FIG. 13C, after the execution controller 352 transmits 1334 feedback for correct response, the execution controller 352 performs steps 1336-1348 using a third stimulus. These steps are similar to steps 722-734 described above. An example of third stimulus is described below.

An example of third stimulus transmitted in step 1336 comprises the word 3612 “distant” and image 3614 as described for the example of second stimulus in FIG. 36D. The image 3614 also comprises characters 3622, 3624 and the invisible relevant part 3626. However, the instructions for the third stimulus example are different from the instructions for the second stimulus example. The third stimulus example includes visual or audio instructions that direct the learner to modify the relevant part 3626 such that the image 3614 matches the word 3612 “distant.” The learner can therefore increase the width of the relevant part 3626 by selecting a part of the relevant part and dragging the part to increase the size of the relevant part 3626. Accordingly, the resultant image (not shown) would include characters 3622, 3626 separated by a greater distance than in FIG. 36D. If the learner correctly increases the size of the relevant part 3626, the instructions provide feedback for correct answer. The feedback affirms that the chosen answer is correct. Additionally, the feedback can include the reasons why the answer is correct and the resultant image after learner's modifications. If the learner does not increase the size of the relevant part 3626, the instructions provide feedback for incorrect answer. The feedback informs the learner that the chosen answer is incorrect. The feedback can also include the reasons for incorrect answer.

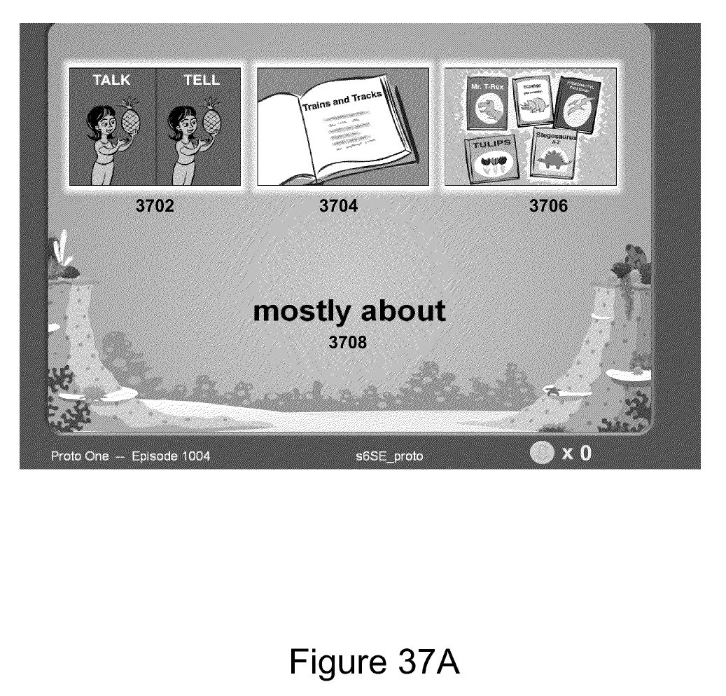

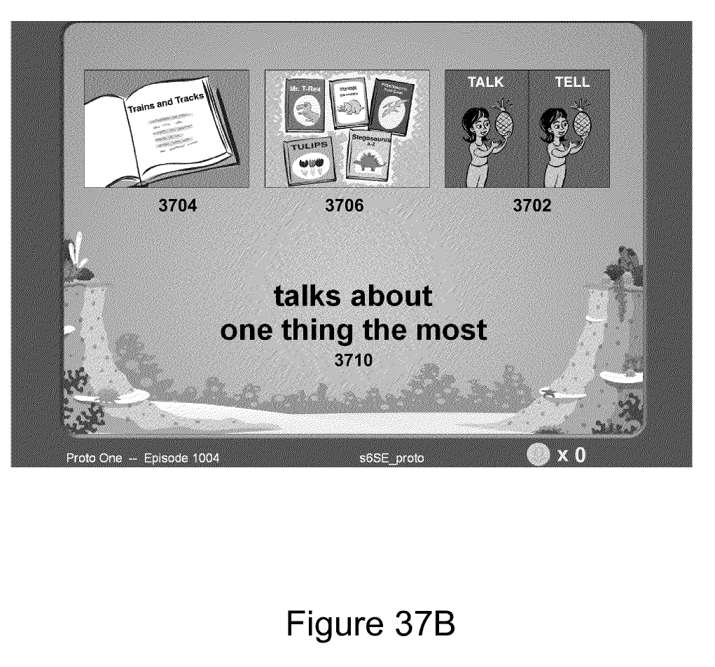

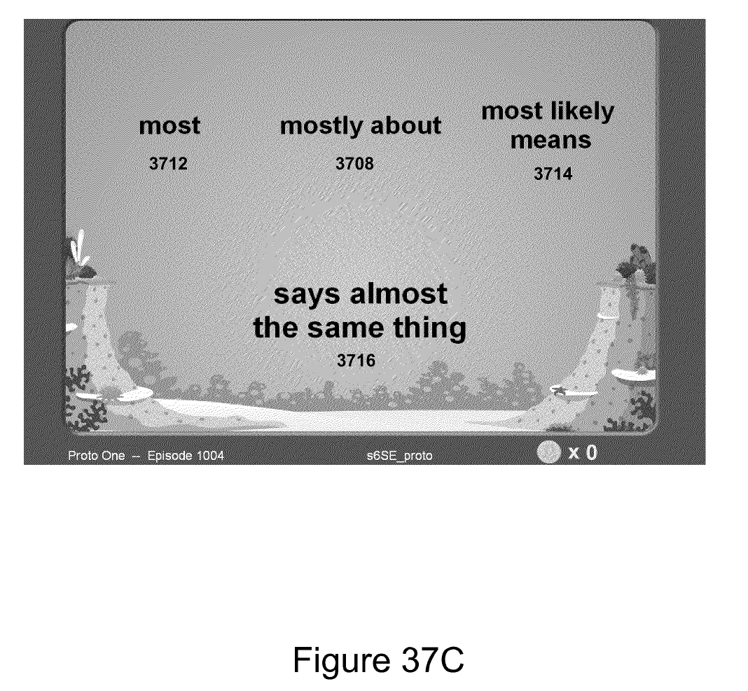

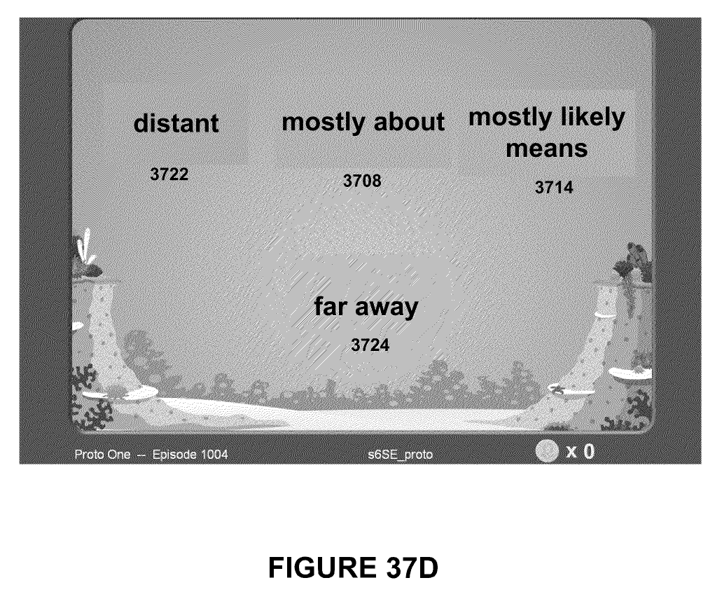

FIGS. 13D-E are a flow chart that illustrates the execution controller 352 performing 1300C a routine designed to develop learner's vocabulary skills through associated illustrations and definitions. This sequence is organized so as to establish reliable relations between stimuli with minimal explicit instruction (for example, but not limited to, the relations between words, their definitions, and their graphic illustrations). The sequence explicitly establishes the relation between a selected sub-group of those stimuli by presenting them together with audio and visual instructions as necessary. All the possible combinations and permutations of the relations established in this way are then introduced and evaluated. Novel stimuli (i.e. those who were not part of the original explicit instruction) are later incorporated in the sequence with minimal explicit instruction but with restricted possible responses in order to maximize the probability of the learner responding correctly. The execution controller 353 performs steps 1352-1360. These steps are similar to steps 722-730 described above. Three examples of the first stimulus set are described below in FIGS. 37A-C.

FIGS. 37A-C depict three examples of the first stimulus steps used in steps 722-730. The three examples show three different relations between a word or a phrase (collectively referred to as “word”), an illustration and a definition of the word. FIG. 37A illustrates an example of the first stimulus illustrating the relations of a word to an illustration associated with the word. The example stimulus in FIG. 37A comprises three illustrations 3702-3706 and the word 3708 “mostly about.” The stimulus set also comprises audio or visual instructions (not shown) directing the user to select the illustration that represents the word 3708. Another possible relation not illustrated by examples in FIGS. 37A-C is the relations of an illustration to the word. A stimulus set illustrating such a relation comprises three words and an illustration. The instructions in that stimulus set direct the learner to select the word that represents the illustration.

FIG. 37B illustrates an example of the first stimulus illustrating the relationship of a definition to an illustration. The example stimulus in FIG. 37B comprises three illustrations 3702-3706 and the definition 3710. The stimulus set also comprises audio or visual instructions (not shown) directing the user to select the illustration that represents the definition 3710. Another possible relation not illustrated by examples in FIGS. 37A-C is the relation of an illustration to the definition. A stimulus set illustrating such a relation comprises three definitions and an illustration. The instructions in that stimulus set direct the learner to select the definition that represents the illustration.

FIG. 37C illustrates an example of the first stimulus illustrating the relation of a word's definition to the word. The example stimulus of FIG. 37C comprises three words 3712, 3708, 3714 and a definition 3716. The stimulus set also comprises audio or visual instructions (not shown) directing the user to select the word that represents the definition 3716. Another possible relation not illustrated by examples in FIGS. 37A-C is the relation of a word to its definition. A stimulus set illustrating such a relation comprises three definitions and a word. The instructions in that stimulus set direct the learner to select the definition that represents the word.

After transmitting the instructions, the execution controller 352 receives a response from teaching client 106. The execution controller 352 then transmits the feedback for the response.

Referring to FIG. 13D, after the execution controller 352 transmits 1360 feedback for correct answer to teaching client 106, the execution controller 352 determines 1362 if exit criterion for all stimulus sets illustrating a particular relationship has been met. An example of this exit criterion is receiving two or more correct responses for stimulus sets illustrating the same relation. Moreover, the exit criterion can be based on one or more factors described above. If the exit criterion has not been met, the execution controller repeats step 1352-1362 using another stimulus set that illustrates the same relation as the stimulus set used in the previous loop of steps 1352-1362.

If the exit criterion has been met, the execution controller 352 determines 1364 if exit criterion for all types of relations has been met. If not, the execution controller 352 selects stimulus sets illustrating another relation and repeats steps 1352-1364 with stimulus sets illustrating the new relation. If the exit criterion has been met, the execution controller 352 moves to exclusion trials stage described below.

In this stage, the execution controller 352 performs steps 1370-1378 with second stimulus set that includes a new stimulus in addition to previously presented stimuli. These steps are similar to steps 1352-1360 described above, with the difference that in the present sequence the stimulus set contains stimuli to be learned by exclusion trials. In exclusion trials, novel stimuli are presented for learners to select a stimulus to be associated with it, without previous explicit instruction with any of these stimuli. Typically, learners select the correct stimulus even in the absence of explicit instruction because the correct stimulus is the only stimulus that has not been previously associated with another corresponding stimulus. An example of the second stimulus set is described below in FIG. 37D.

FIG. 37D illustrates an example of the second stimulus that includes new stimulus not previously used in teaching the learner words and their associated illustrations or definitions. The stimulus set in FIG. 37D includes a new word 3722 and a new definition 3724 and illustrates the relation of a word's definition to the word. This type of stimulus set is used to teach the learner about deducing the meaning of a new word through exclusion of already learnt words and their meanings. The stimulus set in FIG. 37D comprises three words 3722, 3708, 3714 and definition 3724. The execution controller 352 then receives the learner's response to the directions from the teaching client 106. The execution controller 352 next transmits appropriate feedback at steps 1378 or 1376 for the correct or incorrect response.

Referring to FIG. 13E, after the execution controller 352 transmits 1378 feedback for correct answer to teaching client 106, the execution controller 352 performs steps 1380-1384. These steps are similar to steps 1362-1366 described above. After the exit criterion for all types of relationship has been met for stimulus sets corresponding to the new stimulus, the execution controller 352 determines 1386 if all stimuli to be learned by exclusion has been presented at the teaching client 106 to the learner. If not, the execution controller 352 selects 1388 stimulus set for the new stimulus and repeats steps 1370-1386 for the new stimulus. If all stimuli have been presented, the execution controller 352 updates the rewards for the learner, transmits 1390 the updated rewards to the teaching client 106 and directs the teaching client 106 to present the updated rewards to the learner.

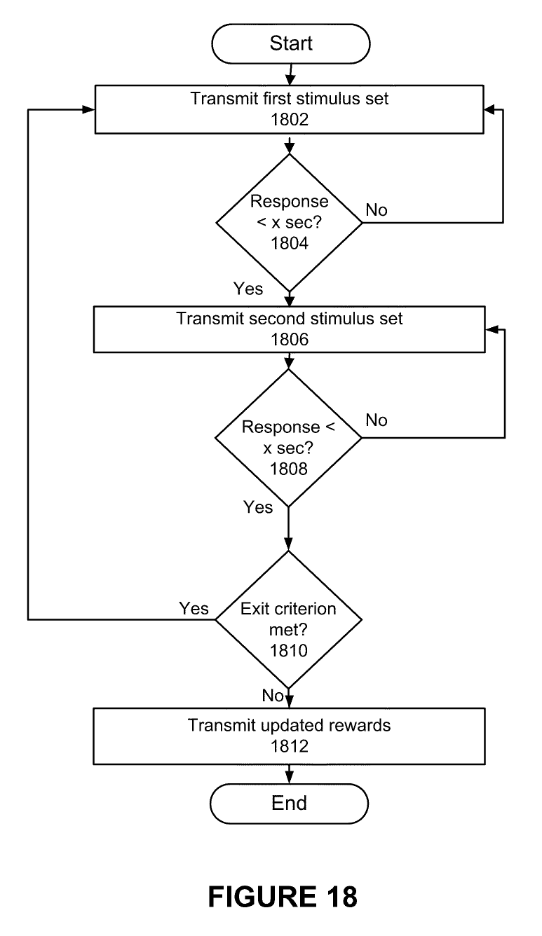

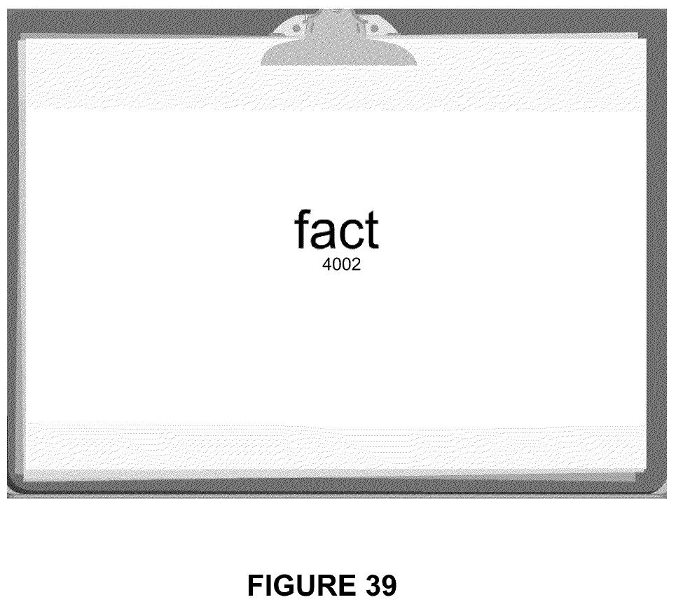

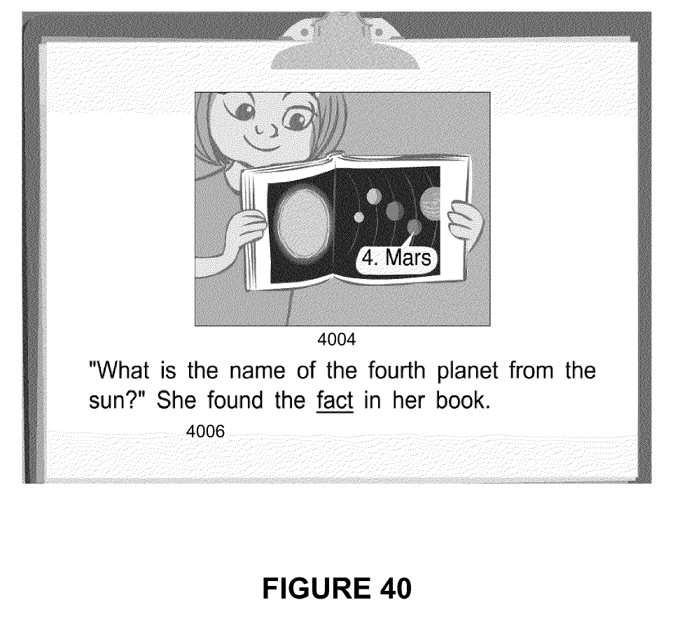

FIG. 18 is a flow chart that illustrates the execution controller 352 performing 1300D a routine designed to develop a learner's vocabulary skills including pronunciation skills. The execution controller 352 performs steps 1802-1808. These steps are similar to steps 852-858 and example of first stimulus set and second stimulus set are described below in FIGS. 39-40.

FIG. 40A illustrates an example of the first stimulus set. The first stimulus set comprises a word 4002 and visual or audio instructions (not shown). The instructions pronounce the word 4002 and then direct the learner to pronounce the word. In other examples of the first stimulus set word 4002 can be a set of words. The instructions next direct the learner to click on word 4002 after the learner has pronounced the word.

After the learner, clicks on word 4002, the second stimulus set is presented to the learner. FIG. 40 illustrates an example of the second stimulus set. The second stimulus set in FIG. 40 comprises an illustration 4004 and sentence 4006. The illustration 4004 is an illustration that helps the learner in learning how to use the word 4002. Similarly, the sentence 4006 is a sentence that includes the word 4002 and helps the learner in learning how to use the word in a sentence. The second stimulus set also includes audio or visual instructions (not shown) directing the learner to read the sentence. Additionally, the instructions can explain how word 4002 is used in the sentence. The instructions then direct the learner to click on the sentence 4006 after the learner has read the sentence 4006.

After receiving a response for the second stimulus set, the execution controller 352 determines 1810 if the exit criterion for the routine of FIG. 18 has been satisfied. An example of exit criterion is transmitting a pre-determined amount of stimulus sets. If the exit criterion is not satisfied, the execution controller 352 performs steps 1802-1810 with another pair of stimulus sets similar to the first and second stimulus sets. Otherwise, the execution controller 352 updates the learner's rewards based on the received responses, transmits 1812 the updated rewards and directs the teaching client 106 to present the rewards.

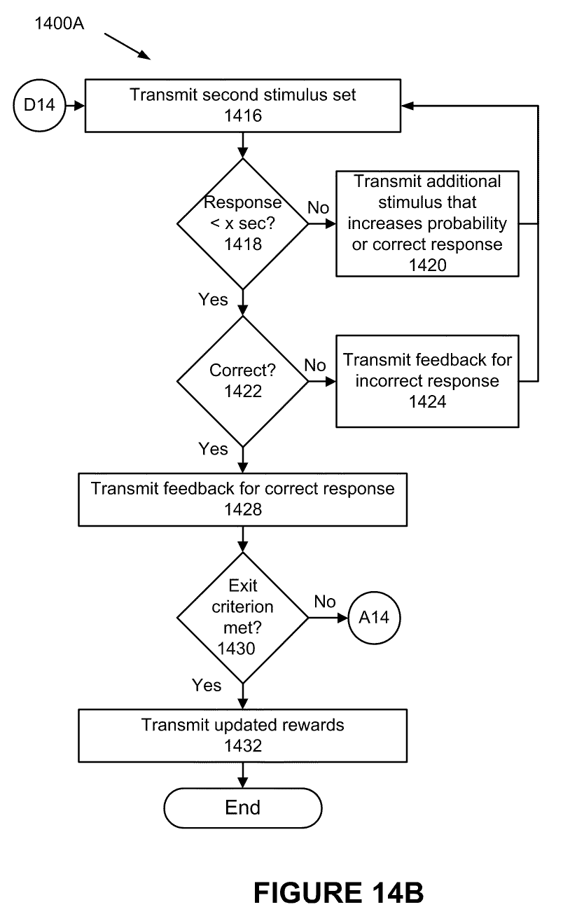

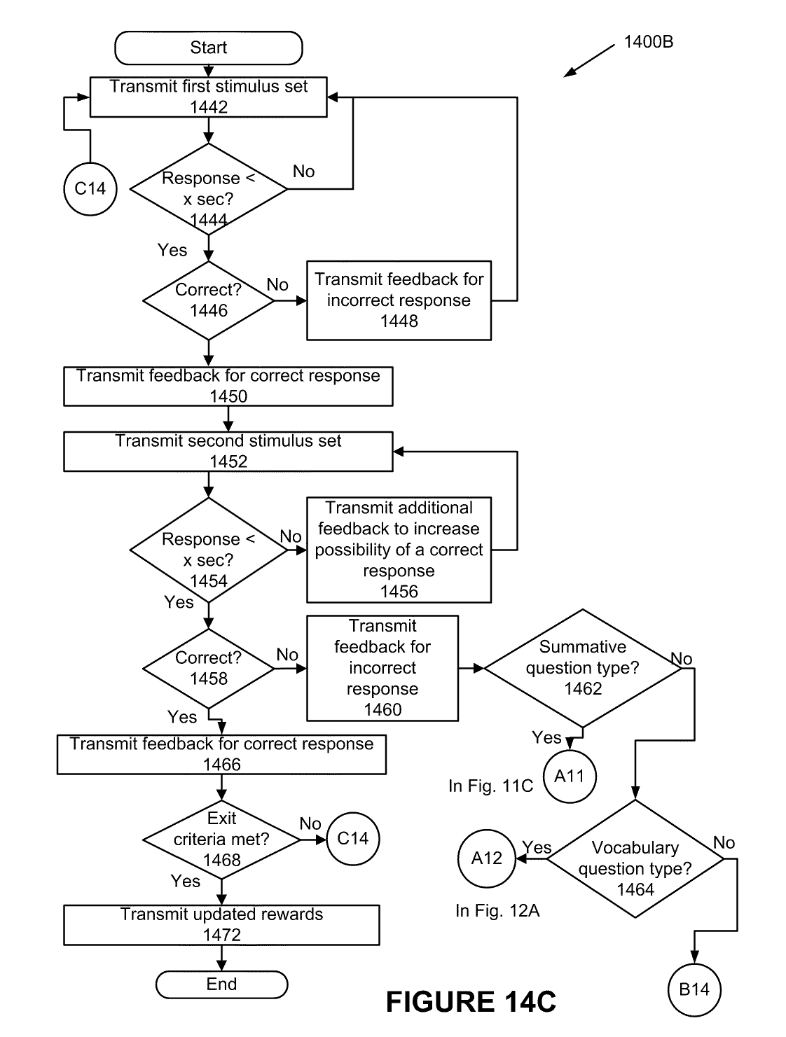

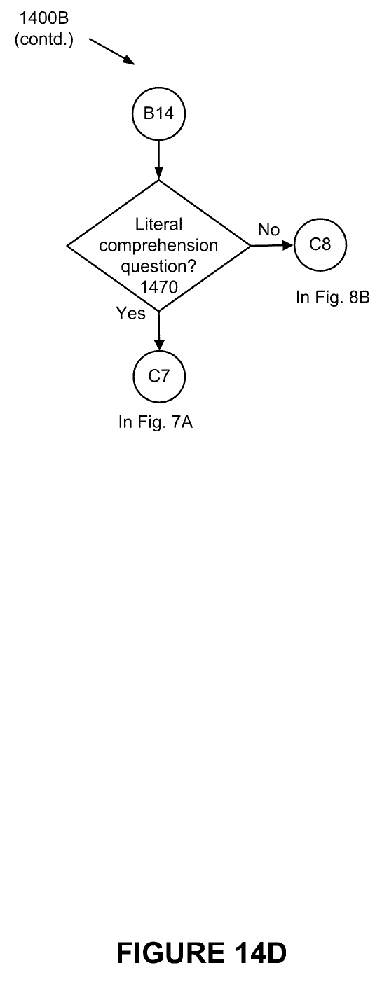

FIGS. 14A-B are a flow chart that illustrates the execution controller 352 performing 1400A a first routine designed to develop the learner's skill for differentiating between various comprehension problems and addressing the problem using one of the learner's comprehension skill. This routine provides learners with a mixed bag of stimulus sets that test the learner's literal comprehension skill, inferential comprehension skill, vocabulary skill and summative skill. If the learner incorrectly answers a question requiring literal or inferential comprehension skills, the routine also directs the learner through analytical steps for determining the correct answer to the question in stimulus set.

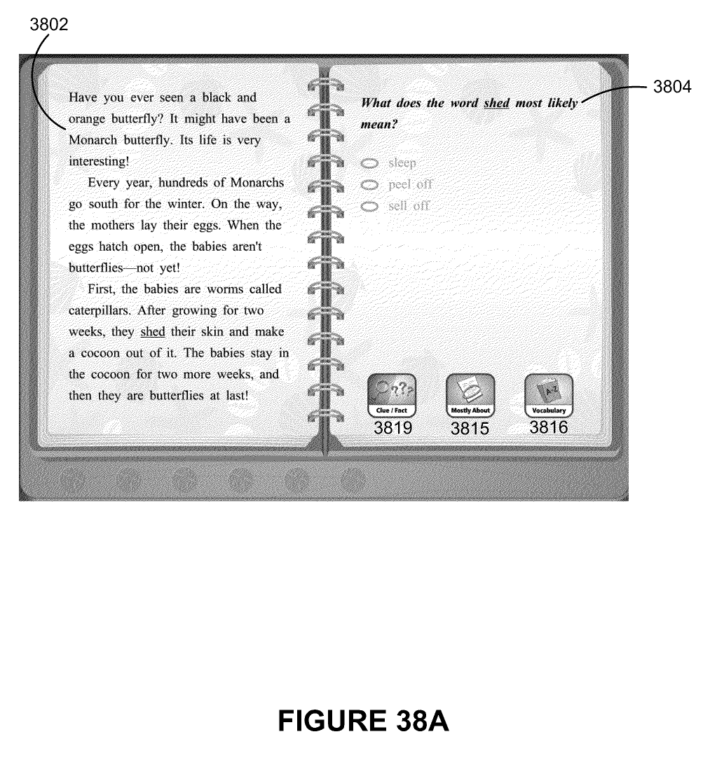

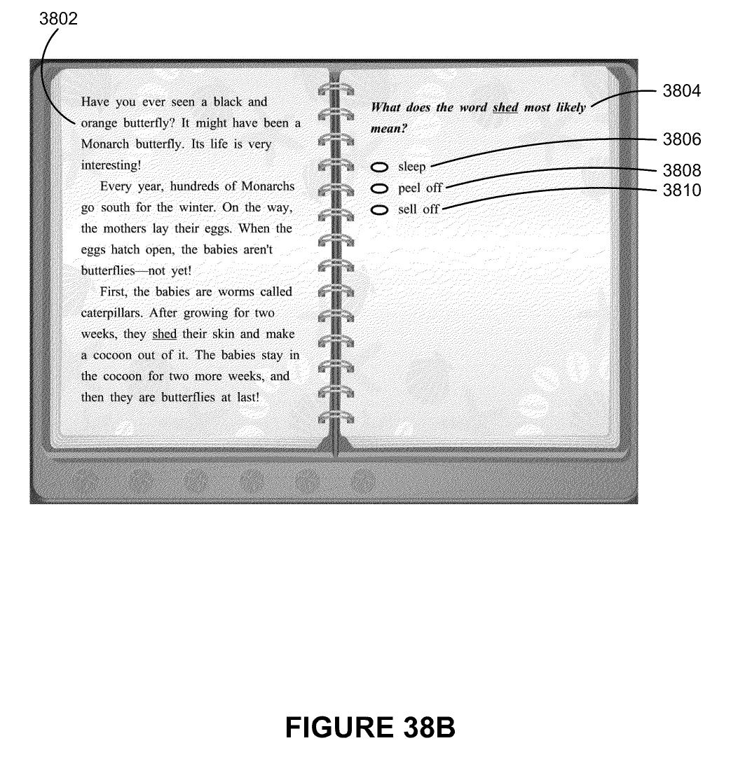

In this first routine, the execution controller 352 performs steps 1402-1410 using a first stimulus set. These steps are similar to steps 706-714 described above. An example of the first stimulus set is illustrated in FIG. 38A.

The first stimulus set in FIG. 38A comprises passage 3802, question 3804, mostly about icon 3815, vocabulary icon 3816 and clue/fact icon 3819. The first stimulus also includes audio or visual instructions (not shown) that direct the learner to read the passage 3802, question 3804 and determine the skill set required to answer the question 3804. The instructions then direct the learner to select appropriate icon corresponding to the determined skill. After receiving the learner's selection, the instructions provide feedback to the learner informing the learner whether the received selection is correct or incorrect. Additionally, the instructions can provide the learner with reasons why the received selection is correct or incorrect.

Referring to FIG. 14A, after transmitting 1410 the feedback for correct answer, the execution controller 352 determines 1412 if the first stimulus set includes a literal comprehension question. If yes, the execution controller 352 directs the learner through the analytical steps of answering a literal comprehension question. Accordingly, the execution controller 352 performs steps similar to steps 706-734 described in FIGS. 7A-B above. The stimulus sets used in these analytical steps are similar to stimulus sets of FIGS. 22-23 described above.

On the other hand, if the first stimulus set does not include a literal comprehension question, the execution controller 352 next determines 1414 if the first stimulus set includes an inferential comprehension question. If yes, the execution controller 352 directs the learner through the analytical steps of answering an inferential comprehension question. Accordingly, the execution controller 352 performs steps similar to steps 816-838 described in FIG. 8B above. The stimulus sets used in these analytical steps are similar to stimulus sets of FIGS. 27-28.

If the stimulus set does not include an inferential comprehension question either, the execution controller 352 does not direct the learner through the analytical steps discussed above. Instead, the execution controller 352 performs steps 1416-1428 using a second stimulus set. These steps are similar to steps 706-714 described in FIG. 7A above. An example of second stimulus set is described below in FIG. 38B.

The second stimulus set in FIG. 38B comprises passage 3802, question 3804 and three answer choices 3806-3810. The stimulus set also includes audio or visual instructions (not shown) directing the learner to determine the answer to question 3804 and select a corresponding answer choice. If the learner selects an incorrect answer, the instructions provide feedback for incorrect answer to the learner. The feedback informs the learner that the selected answer choice is incorrect. Additionally, the feedback can inform the learner why the selected answer is incorrect. If the learner selects the correct answer, the instructions provide feedback for correct answer to the learner. The feedback informs the learner that the selected answer choice is correct. Additionally, the feedback can inform the learner why the selected answer is correct.

After transmitting 1428 the feedback for correct answer, the execution controller 352 determines if the exit criterion for the routine has been met. An example of exit criterion for this routine is receiving a correct response for a literal comprehension question, an inferential comprehension question, a summative question and a vocabulary question. Moreover, the exit criterion can be based on one or more factors described above. If the exit criterion is not met, the execution controller 352 repeats steps 1402-1430 for another stimulus set. If the exit criterion is met, the execution controller 352 updates the rewards for learner's responses, transmits 1432 the updated rewards to teaching client 106 and directs the teaching client 106 to present the rewards to the learner.

FIGS. 14C-D are a flow chart that illustrates the execution controller 352 performing 1400B a second routine designed to develop the learner's skill for differentiating between various comprehension problems and addressing the problems using the learner's comprehension skills. This routine, like the routine of FIGS. 14A-B, also provides learners with a mixed bag of stimulus sets that test the learner's literal comprehension skill, inferential comprehension skill, vocabulary skill and summative skill. This routine, unlike the routine in FIGS. 14A-B, directs the learner through the analytical process of answering a question for any of the four comprehension skills mentioned above.

The execution controller 352 performs steps 1442-1450 using a first stimulus set. These steps are similar to steps 706-714 described above. An example of the first stimulus set is illustrated in FIG. 38A and described above. Next, the execution controller 352 transmits 1452 a second stimulus set similar to the stimulus set illustrated in FIG. 38B and described above. The execution controller 352 then determines 1454 if it has received a learner's response to the second stimulus set in a predetermined time period. If not, the execution controller 352 transmits additional feedback to help the learner respond to the second stimulus set. For example, the additional feedback can direct the learner to read the question or the passage again and answer the question in second stimulus set. The execution controller 352 then repeat steps 1452-1456 until it receives a learner's response from teaching client 106.

After receiving the learner's response, the execution controller 352 determines 1458 if the received response is correct. If correct, the execution controller 352 transmits 1466 the feedback for correct response. This feedback informs the learner that the learner's answer is correct. Additionally, the feedback can inform the learner why the learner's answer is correct. The execution controller 352 then determines 1468 if the exit criterion for the routine of FIGS. 14C-D has been met. An example of exit criterion for this routine is receiving a correct response for a literal comprehension question, an inferential comprehension question, a summative question and a vocabulary question. Moreover, the exit criterion can be based on one or more factors described above. If the exit criterion has not been met, the execution controller 352 repeats steps 1442-1472. Otherwise, the execution controller 352 updates the rewards for the received learner's responses, transmits 1472 the updated rewards to teaching client 106 and directs the teaching client 106 to present the rewards to the learner.

If, at step 1458, the execution controller 352 determines 1458 that the received response is not correct, the execution controller 352 transmits 1460 feedback for incorrect response to the teaching client 106. The execution controller 352 next determines 1462 if the question in the second stimulus set requires summative skills. If yes, the execution controller 352 directs the learner through analytical steps of determining the correct answer using summative skills. Accordingly, the execution controller 352 performs steps similar to steps 1142-1156 described in FIG. 11C above. The stimulus set used for these steps is similar to stimulus set described in FIG. 34C above.

If the question in the second stimulus set does not require summative skills, the execution controller 352 determines 1464 if the question requires vocabulary skills. If yes, the execution controller 352 directs the learner through analytical steps of determining the correct answer using vocabulary skills. Accordingly, the execution controller 352 performs steps similar to steps 1202-1234 described in FIG. 12A above. The stimulus sets used for these steps are similar to the stimulus sets described in FIGS. 35A-D.

If the question in the second set does not require vocabulary skills either, the execution controller 352 determines 1470 if the question requires literal comprehension skills. If yes, the execution controller 352 directs the learner through the analytical steps of answering a literal comprehension question. Accordingly, the execution controller 352 performs steps similar to steps 706-734 described in FIGS. 7A-B above. The stimulus sets used in these analytical steps are similar to stimulus sets of FIGS. 22-23 described above.

If the question in the second set does not require literal comprehension skills either, the execution controller 352 determines that the question requires inferential comprehension skill. The execution controller 352 therefore directs the learner through the analytical steps of answering an inferential comprehension question. Accordingly, the execution controller 352 performs steps similar to steps 816-838 described in FIG. 8B above. The stimulus sets used in these analytical steps are similar to stimulus sets of FIGS. 27-28.

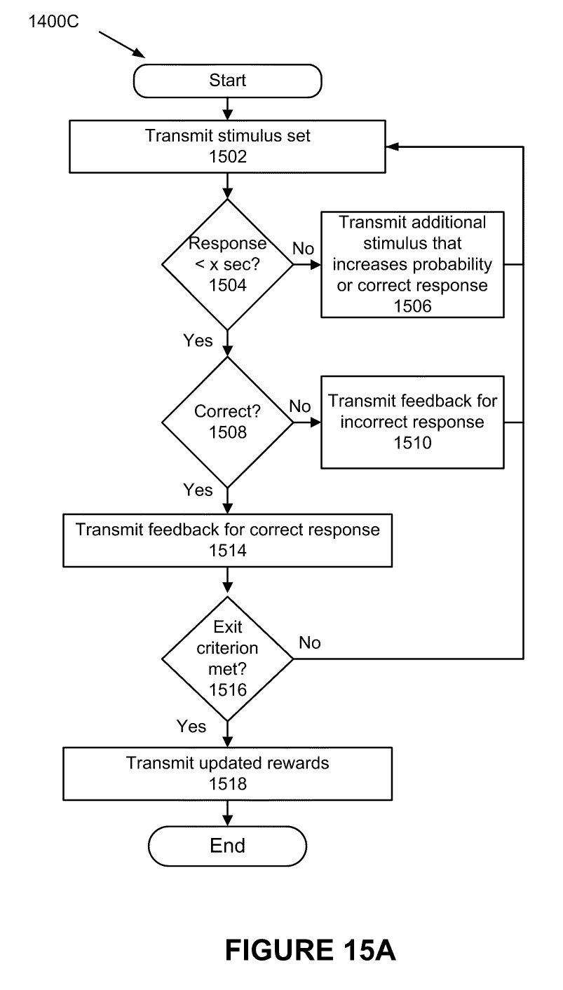

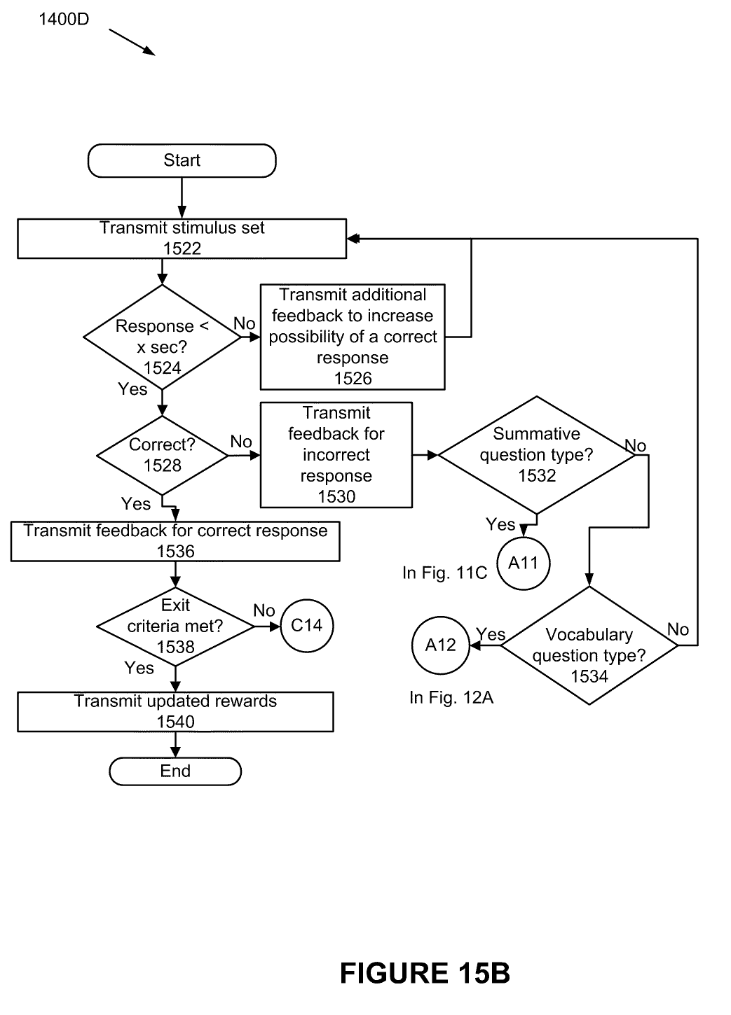

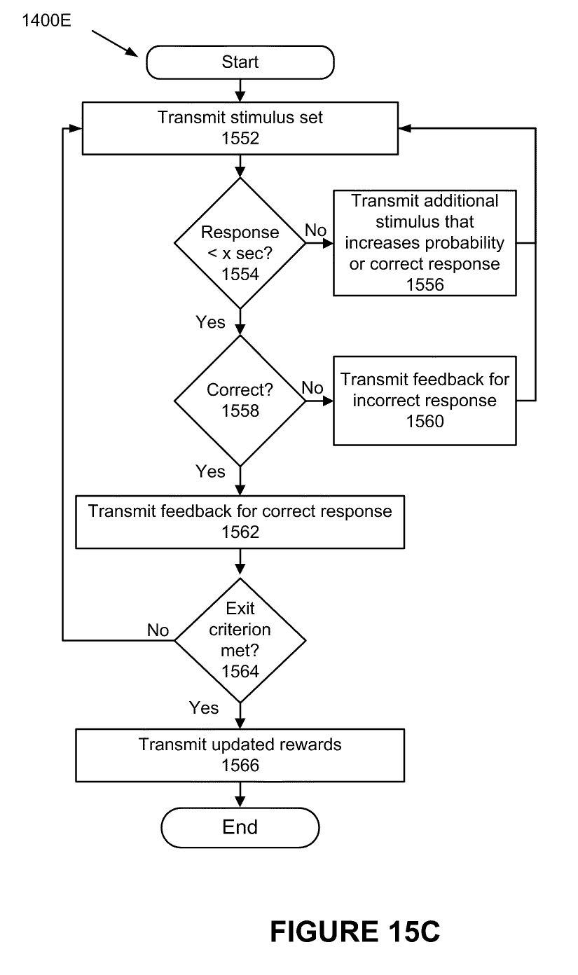

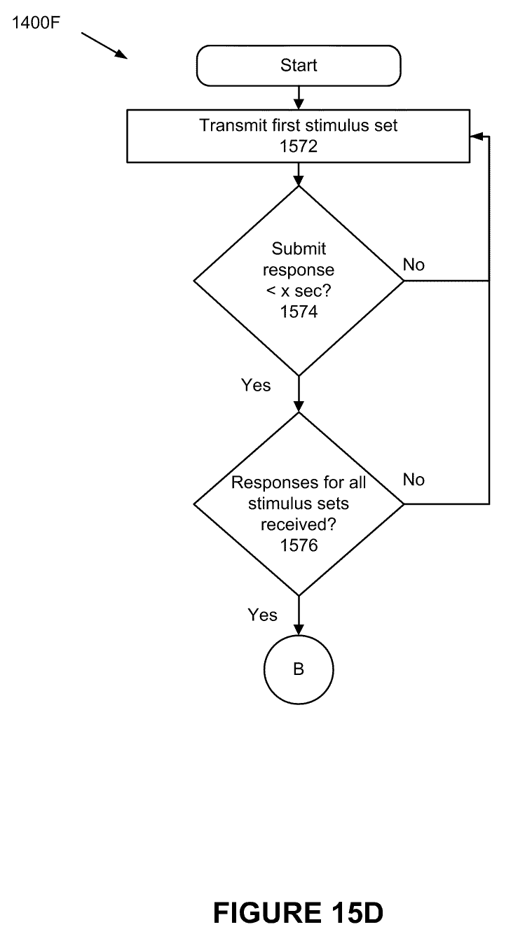

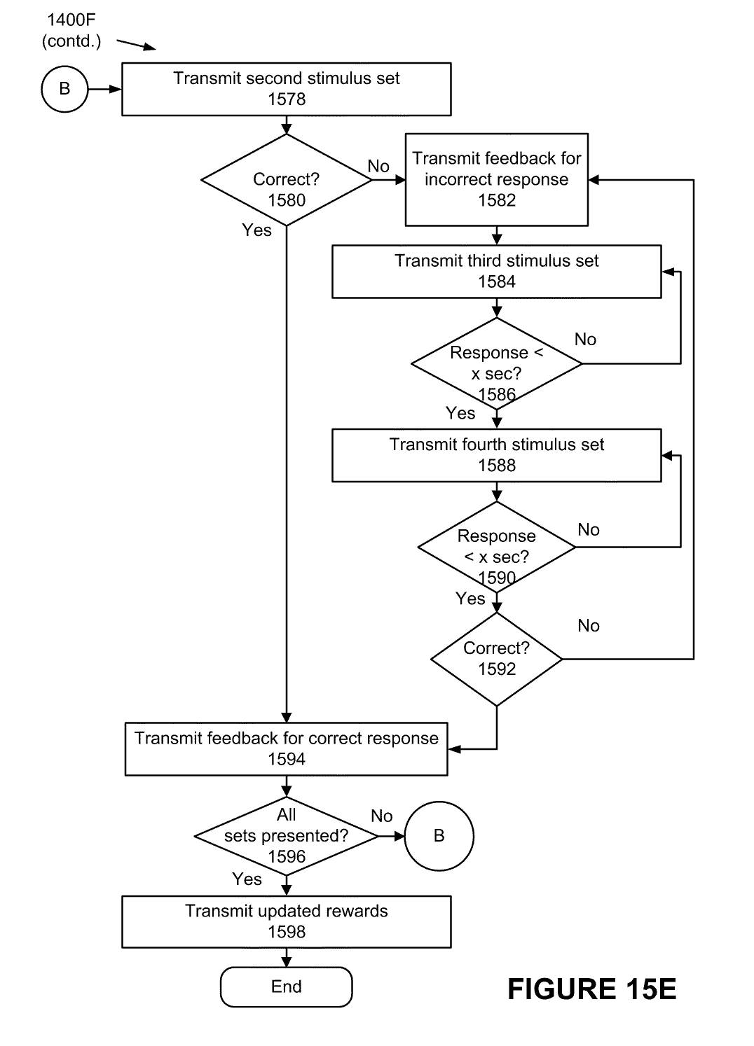

FIG. 15A is a flow chart that illustrates the execution controller 352 performing 1400C a third routine designed to develop the learner's skill for differentiating between various comprehension problems and addressing the problems using the learner's comprehension skills. This routine, like the routines of FIGS. 14A-B and FIGS. 14C-D, also provides learners with a mixed bag of stimulus sets that test the learner's literal comprehension skill, inferential comprehension skill, vocabulary skill and summative skill. However, this routine does not direct the learner through the analytical process of answering a question for any skill.

The execution controller 352 performs steps 1502-1514. These steps are similar to steps 722-730 of FIG. 7B described above. The stimulus set transmitted at step 1502 is similar to stimulus set illustrated in FIG. 38B. However, the stimulus set can include a literal comprehension question, an inferential comprehension question, summative question or a vocabulary question.

After the execution controller 352 receives a learner's response to the stimulus set, the execution controller 352 determines 1516 if the exit criterion for the routine of FIG. 15A has been met. An example of exit criterion is receiving one correct response for each type of skill tested: literal comprehension skill, inferential comprehension skill, vocabulary skill and summative skill. If the exit criterion is not met, the execution controller 352 repeats steps 1502-1516. Otherwise, the execution controller 352 updates the rewards for the received response, transmits 1518 the updated rewards and direct the teaching client 106 to present the rewards to the learner.

FIG. 15B is a flow chart that illustrates the execution controller 352 performing 1400D a fourth routine designed to develop the learner's skill for differentiating between various comprehension problems and addressing the problems using the learner's comprehension skills. This routine also provides learners with a mixed bag of stimulus sets that test the learner's literal comprehension skill, inferential comprehension skill, vocabulary skill and summative skill. However, this routine does not direct the learner through the analytical steps of answering a question for literal comprehension skill or inferential comprehension skill. This routine does direct the learner through the analytical steps of answering a question for vocabulary skill and summative skill.

In the routine of FIG. 15B, the execution controller 352 performs steps 1522-1540. These steps are similar to steps 1452-1472 except the determination step 1534 (equivalent of step 1464). At step 1534, if the execution controller 352 determines 1534 that the question in stimulus set does not require vocabulary skill, the execution controller 352, unlike step 1470, does not further determine if the question requires literal comprehension skill or inferential comprehension skill. Because this routine does not direct the learner through analytical steps for literal comprehension skill or inferential comprehension skill, this routine does not include the equivalent of step 1470. Instead, the execution controller 352 transmits the stimulus set again at step 1522 and let the learner determine the correct answer for the question in the stimulus set.

The stimulus sets used in this routine are similar to corresponding stimulus sets used in steps 1450-1472.

FIG. 15C is a flow chart that illustrates the execution controller 352 performing 1400E a fifth routine designed to develop the learner's skill for differentiating between various comprehension problems and addressing the problems using the learner's comprehension skills. This routine also provides learners with a mixed bag of stimulus sets that test the learner's literal comprehension skill, inferential comprehension skill, vocabulary skill and summative skill. However, this routine does not provide the learner with a second chance of answering a question after the learner incorrectly answers the question.

In this routine, the execution controller 352 performs steps 1552-1556. These steps are similar to steps 1502-1506 and the stimulus set transmitted at step 1552 is similar to stimulus set transmitted at step 1502. After receiving a response at step 1554, the execution controller 352 determines 1558 if the receive response is correct. If the received response is not correct, the execution controller 352 transmits 1560 feedback for the incorrect answer. The feedback informs the learner that the learner's answer is incorrect. Additionally, the feedback can inform the learner why the learner's answer is incorrect. Moreover, at step 1560, in addition to feedback for the incorrect answer, the execution controller 352 adds to the routine another stimulus set testing the same skill as the incorrectly answered question in the stimulus set transmitted at step 1552.

The execution controller 352 then transmits 1552 another stimulus set. This stimulus comprises a different question than the one presented in previously transmitted stimulus set. The learner therefore does not get the opportunity to determine the correct answer for the previous incorrectly answered question. The execution controller 352 then repeats steps 1554-1558 until the execution controller 352 receives a correct answer for a transmitted stimulus set. As apparent, the learners need to provide a correct answer to a question in a stimulus set on their first try to exit the loop of steps 1552-1558.

After the execution controller 352 receives a correct answer, the execution controller 352 transmits 1562 feedback for correct answer. The feedback informs the learner about the correct answer and optionally about the reasons why the answer is correct. Next, the execution controller 352 determines 1564 if the exit criterion for the routine has been met. An example exit criterion is receiving one correct response for each type of skill: literal comprehension, inferential comprehension, vocabulary and summative. Moreover, the exit criterion can be based on one or more factors described above. If the exit criterion is note met, the execution controller 352 performs steps 1552-1564 again. Otherwise, the execution controller 352 updates the rewards based on received responses, transmits 1566 the updated rewards and direct the teaching client 106 to present the rewards to the learner.

FIGS. 15D-E are a flow chart that illustrates the execution controller 352 performing 1400F a sixth routine designed to develop the learner's skill for differentiating between various comprehension problems and addressing the problems using the learner's comprehension skills. This routine also provides learners with a mixed bag of stimulus sets that test the learner's literal comprehension skill, inferential comprehension skill, vocabulary skill and summative skill. However, this routine does not provide feedback immediately after the learner answers a question incorrectly. Instead, this routine is divided into two phases. During the first phase, the routine collects responses to various stimulus sets from the learner and does not provide feedback for the responses. After the first phase is complete for all the stimulus sets, the routine provides the learner with feedback for responses received in the first phase.

In the first phase, the execution controller 352 transmits 1572 a first stimulus set to the teaching client 106 and directs the teaching client 106 to present the first stimulus set to the learner. An example of the first stimulus set is illustrated in FIG. 38B. The stimulus set in FIG. 38B comprises a passage 3802, a question 3804, three answer choices 3806-3810. The stimulus set also includes a submit icon (not shown). Additionally, the stimulus set includes audio or visual instructions (not shown) directing the learner to review the stimulus set, select one of the answer choices, and select submit icon after the learner is ready to submit the selected answer choice.

The execution controller 352 then determines if it has received a selected answer choice and the selection of submit icon from the teaching client 106 within a predetermined amount of time. If not, the execution controller 352 repeats steps 1572 and 1574. After receiving the submit icon selection response, the execution controller 352 determines 1576 if it has received responses for all stimulus sets. If not, the execution controller 352 repeats steps 1572-1576 with the next stimulus set. This next stimulus set is similar to the first stimulus set, but the next stimulus set can include a different passage 3802, question 3804 and answer choices 3806-3810. The execution controller 352 repeats steps 1572-1576 with various stimulus sets testing a learner's literal comprehension skills, inferential comprehension skills, summative skills and vocabulary skills.

After the execution controller 352 has received responses for all stimulus sets, the execution controller 352 enters the second phase of the routine. In this phase, the execution controller 352 transmits each passage/question/answer set previously transmitted in the stimulus sets of first phase. The execution controller 352 also provides feedback to the learners about their selected answer in the second phase. Accordingly, the execution controller 352 begins the second phase and transmits 1578 a second stimulus set to the teaching client 106. The second stimulus set includes the set of previously transmitted passage 3802, question 3804, answer choices 3806-3810, an indicator of learners' previously selected answer choice and submit icon. The second stimulus also includes audio or visual instructions (not shown) that direct the learner to review the passage 3802, question 3804 and previously selected answer choice. The instructions then direct the learner to select the submit button after the learner has finished reviewing.

Next, the execution controller 352 determines 1580 if the learner's response for the second stimulus is correct. If correct, the execution controller 352 transmits 1594 feedback for correct response. The feedback informs the learner that the learner's response in the first phase to the currently presented stimulus set is correct. Additionally, the feedback can inform the learner why the response is correct. On the other hand, if the response is not correct, the execution controller 352 transmits 1582 feedback for the incorrect response. The feedback informs the learner that the received response is incorrect. Additionally, the feedback can also inform the learner why the received response is incorrect. The execution controller 352 then transmits 1584 a third stimulus set to the teaching client 106 and directs the teaching client 106 to present the third stimulus set to the learner.

The third stimulus includes passage 3802, question 3804, answer choices 3806-3810 from second stimulus set and the submit icon from the second stimulus set. The stimulus set also includes audio or visual instructions (not shown) that direct the learner to focus on one or more specific parts of the passage 3802 and/or question 3804. The instructions then direct the learner to select the submit icon 3810 after the learner has read those parts.

After transmitting 1584 the third stimulus set, the execution controller 352 determines 1586 if it has received a learner's response to the third stimulus set in a predetermined time period. If not, the execution controller 352 repeats steps 1584-1586. Otherwise, the execution controller 352 transmits 1588 a fourth stimulus set. The fourth stimulus set includes passage 3802, question 3804, answer choices 3806-3810 from the second stimulus set. The fourth stimulus set also includes audio or visual instructions (not shown) directing the learner to select the correct answer based on the learner's determination from the third stimulus set.

The execution controller 352 then determines 1590 if it has received the learner's answer from teaching client 106 within a predetermined time period. If not, the execution controller 352 repeats steps 1588-1590. Otherwise, the execution controller 352 determines 1592 if the received answer is correct. If not, the execution controller 352 repeats steps 1582-1592. Otherwise, the execution controller 352 transmits 1594 the feedback for correct answer to the teaching client 106 and directs the teaching client 106 to present the feedback to the learner.

The execution controller 352 next determines 1596 if feedback for all stimulus sets that were answered by the learner in first phase have been presented to the learner. If not, the execution controller 352 repeats steps 1578-1596 for the next stimulus set from the first phase. Otherwise, the execution controller 352 updates the learner's rewards based on the received responses, transmits 1598 the updated rewards to teaching client 106 and directs the teaching client to present the updated rewards to the learner.

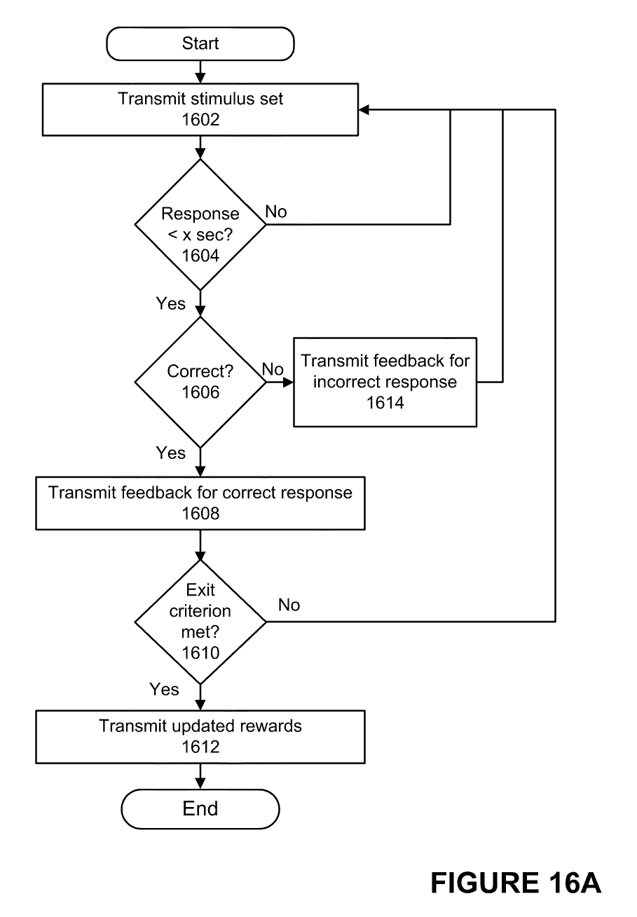

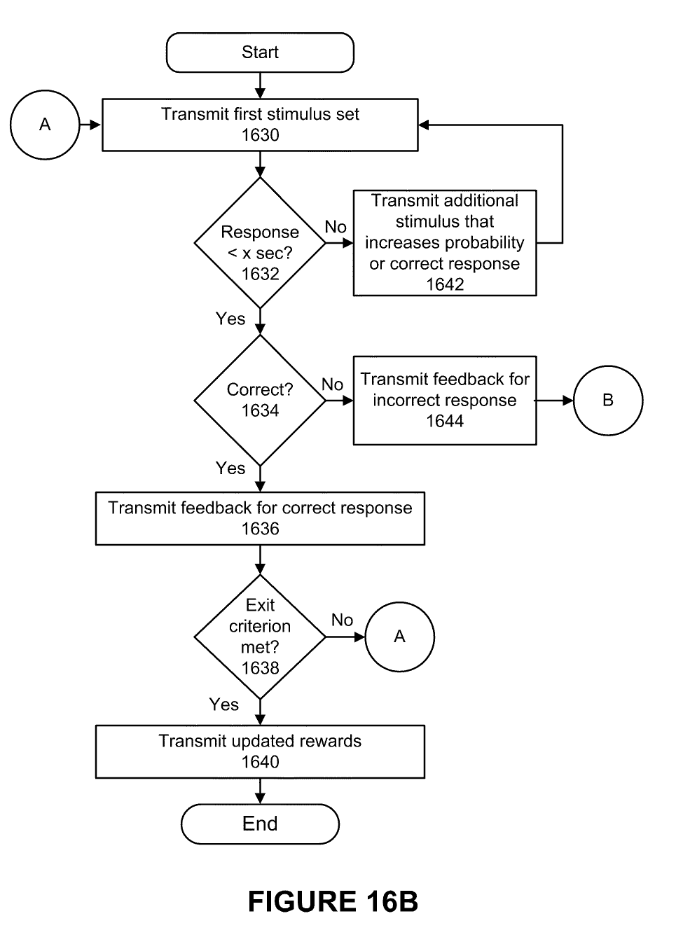

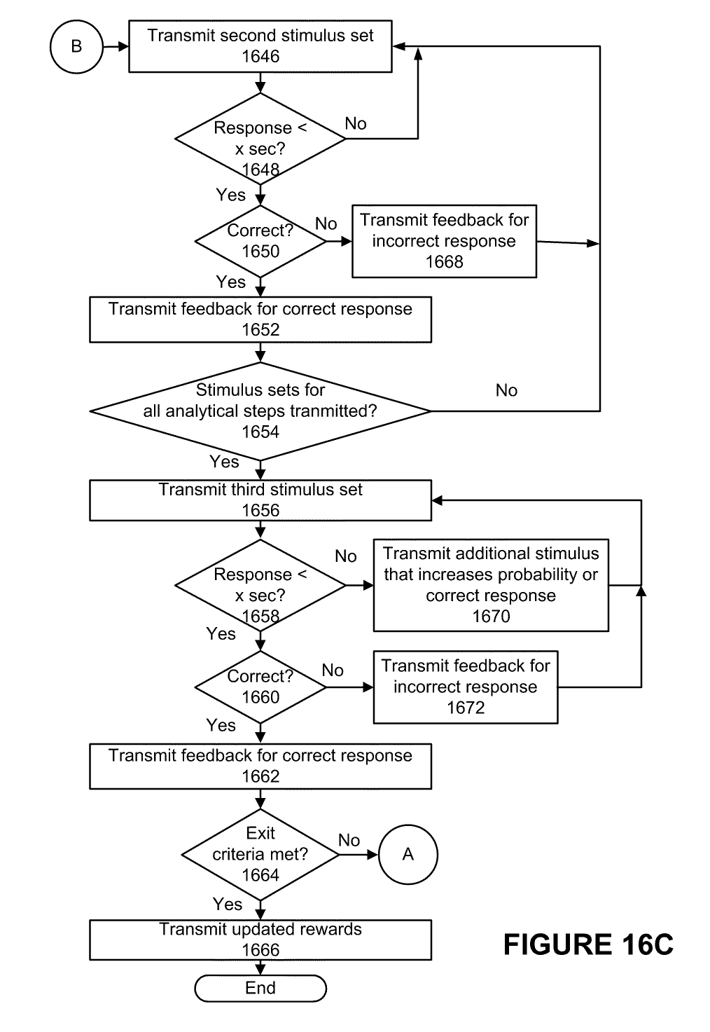

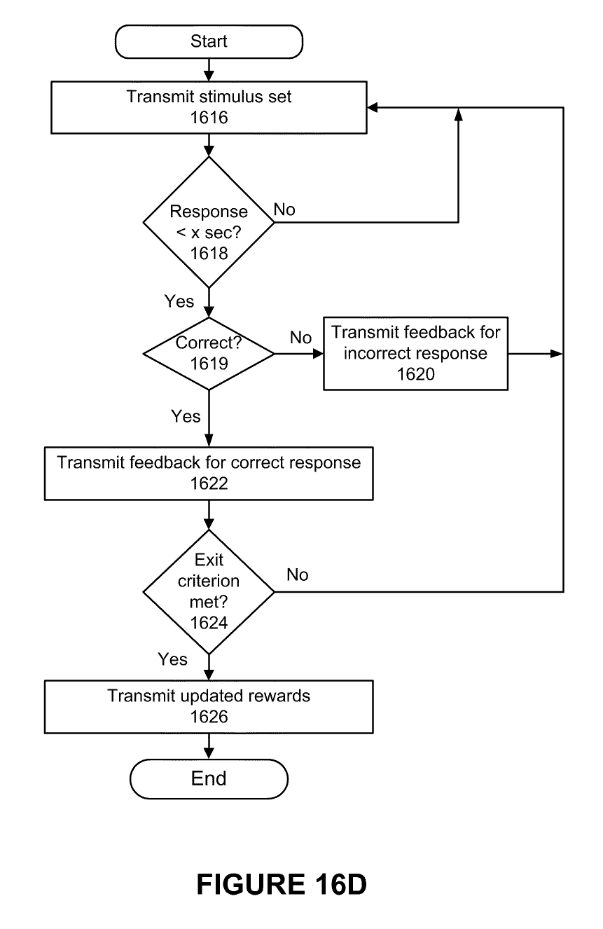

FIG. 16A is a flow chart that illustrates the execution controller 352 performing 506 a routine designed to teach the learner about using resources such as a table of contents, a ruler, a balance scale or a diagram. The execution controller 352 performs steps 1602-1612 with different stimulus sets to teach a learner about using specific resources. These steps are similar to others described above and entail: a) presenting a stimulus set and determining whether the learner responds within the predetermined time frame (1602 and 1604); b) determining whether the learner's response was correct (1606); c) transmitting the appropriate feedback for the correct or incorrect response, including feedback about why the incorrect response was incorrect with respect to one or more missing critical features (1608 and 1614); and d) determining whether the exit criterion for this instructional sequence was met, whereupon either the updated rewards are transmitted or more stimulus sets are presented as necessary to meet the exit criterion. Examples of stimulus sets are described below.

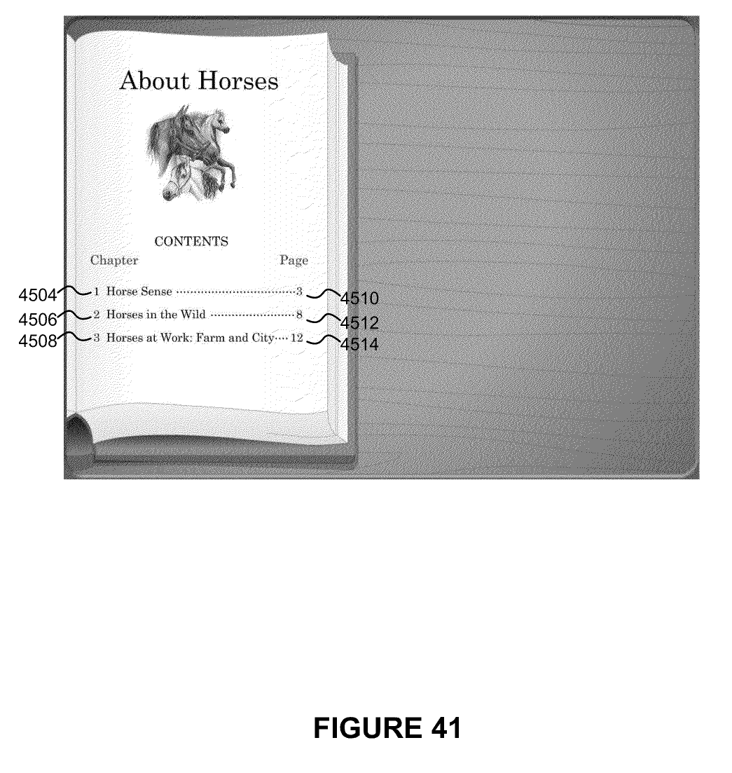

FIG. 41 depicts an example of a stimulus set used for teaching a learner about using a table of contents. The stimulus set comprises chapters 4504-4508 and corresponding start pages 4510-4514 for the chapters. The stimulus set also comprises audio or visual instructions (not shown) that direct the learner to select the chapter that describes a particular topic. The instructions also direct the learner to select the corresponding start page for the chapter. The instructions then provide feedback to the learner regarding why the chosen answer was correct or incorrect. In this manner, the stimulus set teaches the learner about using a table of content.

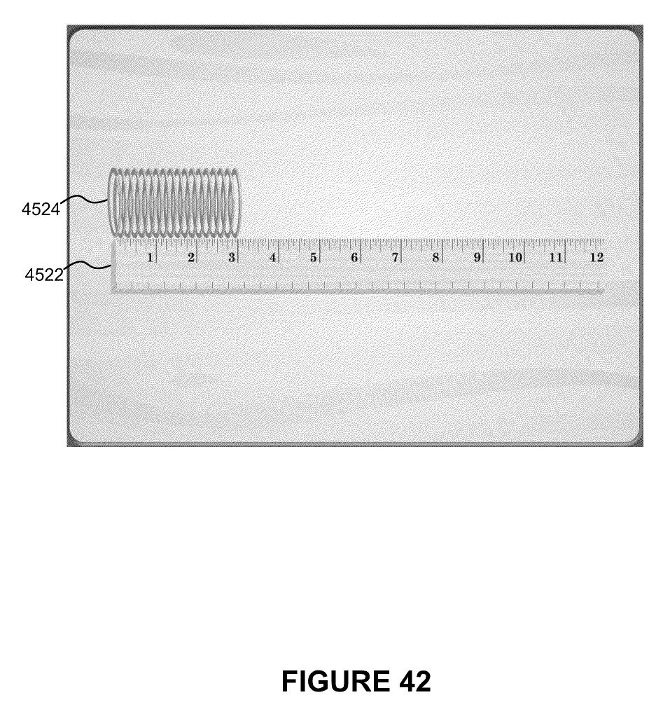

FIG. 42 depicts an example of a stimulus set used for teaching a learner about using a ruler. The stimulus set in FIG. 42 comprises a ruler 4522 and an object 4524. The stimulus set also comprises audio or visual instructions (not shown) that direct the learner to place the ruler 4522 next to the object. The instructions then direct the learner to select the measurement marking on ruler 4522 that corresponds to the length of the object 4524. The instructions then provide feedback to the learner regarding why the chosen answer was correct or incorrect. In this manner, the stimulus set teaches the learner about using a ruler.

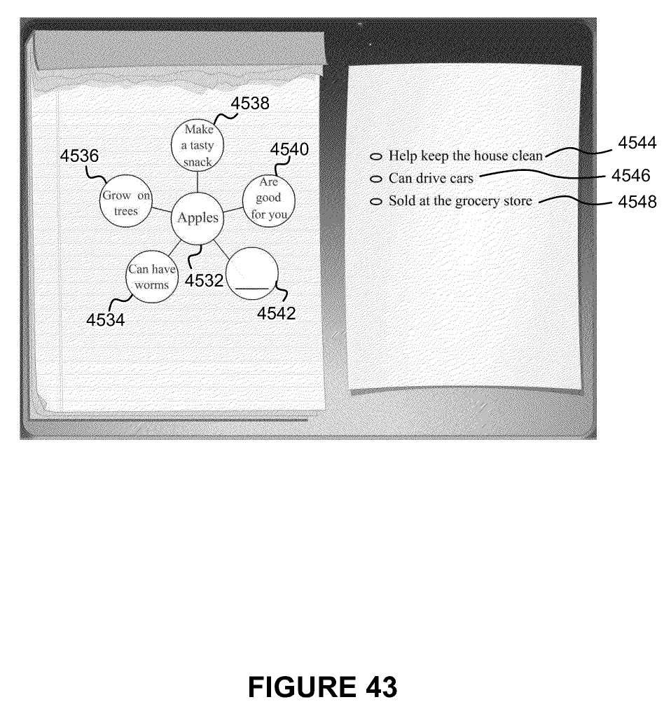

FIG. 43 depicts an example of a stimulus set used for teaching a learner about using diagrams. The stimulus set comprises a central object 4532 surrounded by objects 4534-4542 related to the central object 4532 and three answer choices 4544-4548. The stimulus set also comprises audio or visual instructions (not shown) informing the learner about the central object 4532 and objects 4534-4542 related to the central object 4532. The instructions then direct the learner to select one of the answer choices 4544-4548 that is related to the central object 4542. The instructions then provide feedback to the learner regarding why the chosen answer was correct or incorrect. In this manner, the stimulus set teaches the learner about using a diagram.

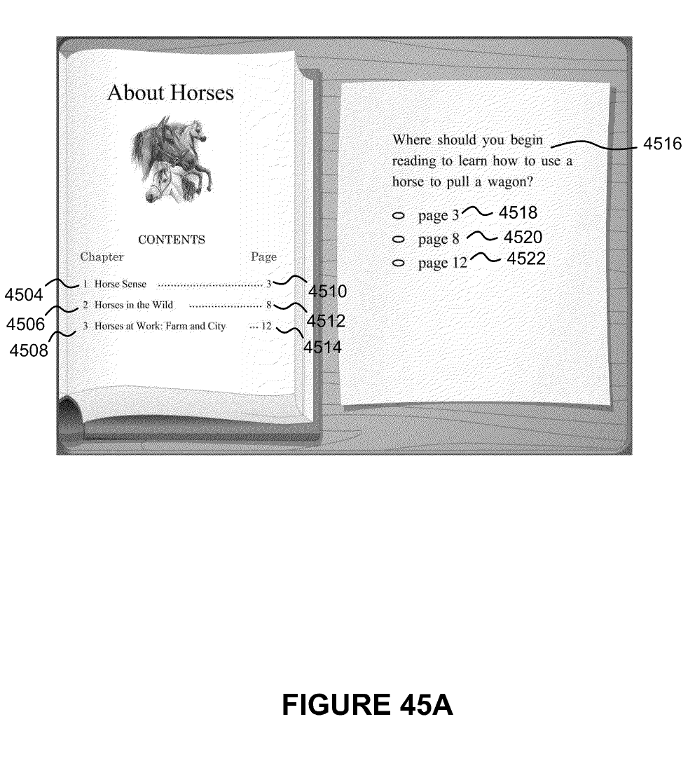

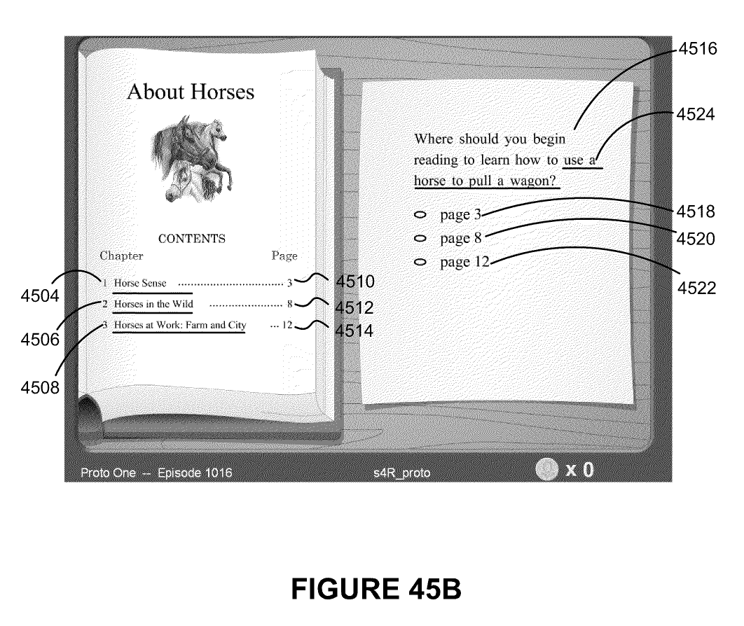

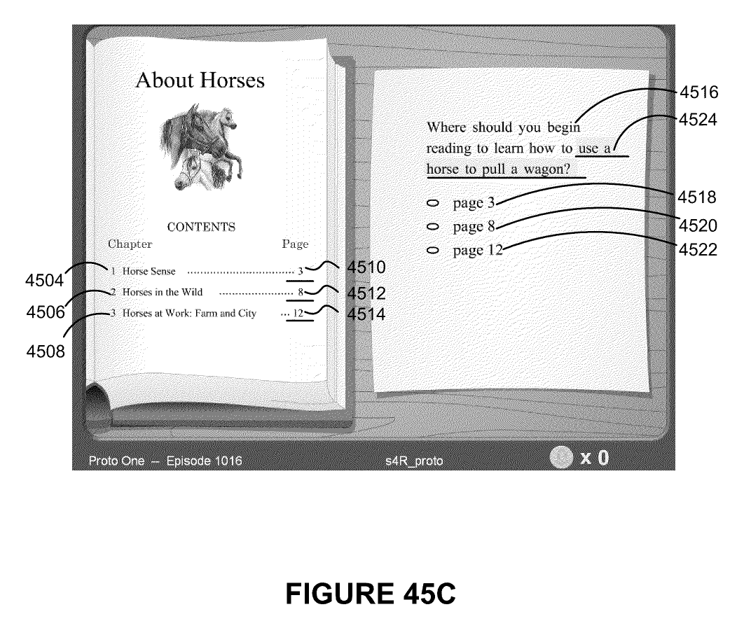

FIGS. 16B-C are a flow chart that illustrates the execution controller 352 performing 506 another routine designed to teach a learner about using resources such as tables of contents, maps, and measurement instruments. The execution controller 352 transmits 1630 first stimulus set to the teaching client 106 and directs the teaching client 106 to present the first stimulus to the learner. An example of the first stimulus set is described below in FIG. 45A. The execution controller 352 then determines 1632 if it has received a response from the teaching client 106 in a predetermined amount of time. If not, the execution controller 352 transmits 1642 additional stimulus to the teaching client 106 to increase the probability of getting a correct response from the learner. The execution controller 1630 then repeats step 1630-1632 again.

FIG. 45A depicts an example of the first stimulus set. The first stimulus set in FIG. 45A comprises chapters 4504-4508, corresponding start pages 4510-4514 for the chapters, question 4516 regarding the table of contents and three answer choices 4518-4522. The first stimulus set also comprises audio or visual instructions (not shown) that direct the learner to read the table of content and answer question 4516.

If the learner does not respond within a predetermined amount of time, the execution controller 352 transmits 1642 additional stimulus to the teaching client 106. The additional stimulus includes additional instructions that direct the learner to look at specific parts of table of content and determine the answer from those specific parts. For example, the additional stimulus can direct the learner to look at the chapters in the table of content and determine the answer. The execution controller 352 then repeats steps 1630-1632 until the execution controller 352 receives a response from the learner in a pre-determined amount of time at step 1632.

After the learner responds within the predetermined amount of time, the execution controller 352 determines 1634 if the received response is correct. If correct, the execution controller 352 transmits 1636 feedback for the correct response. The feedback informs the learner that the received response is correct. Additionally, the feedback can inform the learner about the reasons why the learner's response is correct. The execution controller next determines 1638 if exit criterion for the routine has been met. An example of exit criterion is receiving two correct responses at step 1634. Additionally, the exit criterion can be based on one or more factors described above. If the exit criterion is not met, the execution controller 352 repeats steps 1630-1638 with another stimulus set. Otherwise, the execution controller 352 updates rewards based on received responses, transmits 1640 the updated rewards and directs the teaching client 106 to present the rewards to the learner.

If at step 1634, the received answer is not correct, the execution controller transmits 1644 feedback for the incorrect answer. The feedback can inform the learner that the learner's response is incorrect. Additionally, the feedback can include reasons why the learner's response is incorrect. The execution controller 352 next directs the learner through an analytical process of determining the answer.

For this analytical process, the execution controller 352 performs steps 1646-1652 using a second stimulus set. These steps are similar to others described above and entail: a) presenting a stimulus set and determining whether the learner responds within the predetermined time frame (1646 and 1648); b) determining whether the learner's response was correct (1650); and c) transmitting the appropriate feedback for the correct or incorrect response, including feedback about why the incorrect response was incorrect with respect to one or more missing critical features (1652 and 1668). An example of the second stimulus set is described in FIG. 45B below.

FIG. 45B depicts an example of second stimulus transmitted at step 1646. The second stimulus set in FIG. 45B comprises highlighted chapters 4504-4508, corresponding start pages 4510-4514 for the chapters, question 4516 regarding the table of contents, highlighted part 4524 in the question 4516, and three answer choices 4518-4522. The stimulus set also includes audio or visual instructions (not shown) that direct the learner to read the highlighted question part 4524, read the title of the highlighted chapters 4504-4508 and select the chapter whose title corresponds to the highlighted question part 4524. The execution controller 352 then receives the learner's response from teaching client 106 and transmits feedback for correct answer if the received answer is correct or feedback for incorrect answer if the received answer is incorrect. FIG. 45B therefore presents the learner with an analytical step that helps the learner determine the answer.

FIG. 45C depicts another analytical step or another example of second stimulus transmitted at step 1646. The second stimulus in FIG. 45C comprises chapters 4504-4508, corresponding highlighted start pages 4510-4514, question 4516 regarding the table of contents, highlighted part 4524 in the question 4516, and three answer choices 4518-4522. The stimulus set also includes audio or visual instructions (not shown) that direct the learner to read the highlighted question part 4524, the title of chapter that corresponds to the highlighted question part 4524 and select the page number corresponding to the chapter title. The execution controller 352 then receives the learner's response from teaching client 106 and transmits feedback for correct answer if the received answer is correct or feedback for incorrect answer if the received answer is incorrect. FIG. 45C therefore presents the learner with another analytical step that helps the learner determine the answer.

Referring to FIG. 16C, after transmitting 1652 the feedback for correct answer, the execution controller 352 determines 1654 if stimulus sets for all analytical steps have been transmitted to teaching client 106. If not, the execution controller 352 repeats steps 1646-1654 for next analytical step stimulus set. Otherwise, the execution controller 352 transmits 1656 the third stimulus set to the teaching client 106.

An example of the third stimulus set includes the same visual parts as the example of FIG. 45A. The example of third stimulus set includes chapters 4504-4508, corresponding start pages 4510-4514 for the chapters, question 4516 regarding the table of contents and three answer choices 4518-4522. Additionally, the example includes visual or audio instructions (not shown) that direct the learner to use the answers selected in previous analytical steps to determine the answer for question 4516.

The execution controller 352 then determines 1658 if the execution controller 352 has received the learner's response from teaching client 106. If not, the execution controller 352 transmits 1670 additional instructions to the teaching client 106. For example, the instructions can direct the learner to look at the title of chapters 4504-4508 again. The execution controller 352 then repeats steps 1656, 1658 and 1670 until the execution controller 352 receives a response within pre-determined amount of time.

After receiving a response, the execution controller 352 determines 1660 if the received answer is correct. If not, the execution controller 352 transmits 1672 feedback for incorrect answer to teaching client 106. The feedback can inform the learner that the chosen answer is incorrect. Additionally, the feedback can provide reasons why the chosen answer is incorrect. On the other hand, if the received answer is correct, the execution controller 352 transmits 1662 the feedback for correct response to teaching client 106. The feedback can inform the learner that the chosen answer is correct. Additionally, the feedback can provide reasons why the chosen answer is correct.

The execution controller 352 next determines 1664 if the exit criterion for the routine of FIGS. 16B-C has been met. An example of exit criterion is receiving two consecutive correct responses at step 1660 or 1634. Additionally, the exit criterion can be based on one or more factors described above. If the exit criterion is not met, the execution controller 352 repeats steps 1630-1664 with additional stimulus sets. Otherwise, the execution controller 352 updates rewards for correct responses and transmits 1666 the updated rewards to the teaching client 106.

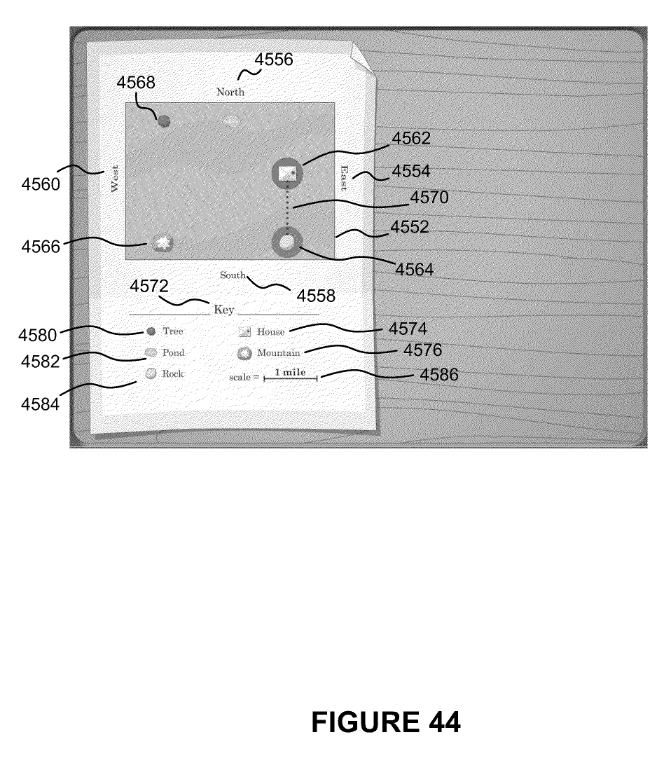

FIG. 16D is a flow chart that illustrates the execution controller 352 performing 506 a routine designed to teach the learner about using a map. The execution controller 352 transmits 1616 a stimulus set to the teaching client 106 and directs the teaching client 106 to present the stimulus to the learner. An example of the stimulus set is described below in FIG. 44. The execution controller 352 then determines 1618 if the learner has responded to the stimulus. If not, the execution controller 352 again transmits the stimulus to the teaching client 106 and/or directs the teaching client 106 to present the stimulus to the learner.

If the learner does not respond to the stimulus set within a predetermined time, the execution controller 352 directs the teaching client 106 to again present the stimulus set and any accompanying instructions. If the learner has responded to the stimulus, the execution controller 352 determines 1619 the accuracy of the learner's response. The execution controller 352 then transmits the feedback for learner's response to the teaching client 106 and directs the teaching client 106 to present the feedback to the learner. The execution controller 352 next determines if the exit criterion for the routine has been satisfied. An example of exit criterion is to require one correct response per stimulus set presented. Moreover, the exit criterion can be based on a number of factors discussed above. If the exit criterion has not been met, the execution controller 352 performs steps 1616-1624. Otherwise, the execution controller 352 updates the learner's rewards and transmits 1626 the updated rewards to the teaching client 106.

FIG. 44 depicts an example of a stimulus set used for teaching the learner about maps. The stimulus set comprises a map 4552 surrounded by four directions of the map 4554-4560 and a key 4572. The map 4554 comprises various locations 4562-4568 on the map 4552 and a line 4570 connecting location 4562 and 4564. The key 4572 comprises a scale 4586 and descriptions 4574-4584 corresponding to locations 4562-4568 on the map. The scale 4586 describes the ratio of distance illustrated on map 4552 to actual distance between various locations. The stimulus set also comprises visual or audio instructions (not shown) that inform the learner regarding various objects on the map. The instructions also inform the learner regarding the scale 4586. The instructions then describe the line 4570 as the distance between location 4562 and 4564. Next, the instructions direct the learner to use the scale 4586 and estimate the actual distance between location 4562 and location 4564. The instructions then direct the learner to select the scale 4586 to get the actual distance. After receiving the learner's selection, the instructions provide feedback to the learner about the actual distance between location 4562 and location 4564. In this manner, the stimulus set teaches the learner about using a map.

FIG. 17 is a flow chart that illustrates a method for analyzing learner data. A user requests through a client machine data satisfying a search criterion and the user interface controller 376 receives 1702 the search criterion. The search criterion can be based on one or more data categories in learner database 210 described above. An example of search criterion is percentage of learners that responded to a stimulus set correctly in their first try wherein the stimulus set had certain critical and/or varying features.

After user interface controller 376 receives the search criterion, the learner analytics controller 372 directs the learner database controller 374 to query learner database 210 for data that meets the search criterion. The learner database controller 374 then retrieves 1704 the data that meets the search criterion. Next, the learner database controller 374 transmits the data to learner analytics controller 372 or stores the data in a storage accessible by learner analytics controller 372. The learner analytics controller 372 then optionally directs the user interface controller 376 to prepare the retrieved data into a presentation format for the user. Next, the learner analytics controller 372 transmits 1706 the retrieved data for display or storage on the user's machine.

### APPENDIX A

### I. Literal Comprehension: Critical Features and Variable Features

### A. Critical Features

1. Answer must appear in passage
2. Answer-passage match meets criteria specified in question
3. Answer overlap has nearly 1 to 1 topographic correspondence with words of passage

### B. Variable Features

1. Type of passage
   a. Narrative: In the form of a story, account, or tale
   b. Expository: Informs or explains an event, concept, or idea using facts
   c. Poetic: Most often written in stanzas, two or more words may rhyme
   d. Illustration
2. Length of passage (for illustrative-type questions, the “passage” is the illustration)
   a. One paragraph
   b. Two-three paragraphs
   c. Four+ paragraphs
   d. Simple illustration (i.e., measurement, table of contents)
   e. Complex illustration (i.e., maps with several features; cross-sections)
3. Number of sentences in passage that contain full answer (some reference to the question & the answer).
   a. One: One sentence contains the full answer.
   b. Two: Two sentences are required to obtain the full answer
   c. Three+: Three or more sentences are required to obtain the full answer.
   d. Illustration: 1 part of the illustration is needed to obtain the full answer
   e. Illustration+: More than 1 part of illustration or illustration plus text (not including the question) is needed.
4. Narrator (position from which story is being told)
   a. First person (I, we)
   b. Second person (you or understood you)
   c. Third person or expository impersonal (he, she, it, they), illustrations
5. Type of characteristic asked about in question
   a. Personal quality
      The answer to the question refers to a person's feelings, thoughts, desires, etc.
   b. Sequence
      Question or answer must include a word referring to a portion of the sequence in the story (e.g., next, after, before, first, last, etc.).
   c. Actions, events (as verbs), & descriptions of them
      a. The word in the sentence indicating the answer refers to a verb or word to describe a verb. If the answer refers to an event or action & also meets requirements to be scored as a sequence (5b or c), score as the appropriate sequence.
   d. Objects, & descriptions of them
      The word in the sentence indicating the answer refers to an object or an adjective describing an object.
   e. People, animals & descriptions of them
      The word in the sentence indicating the answer refers to a person or an adjective describing a person
   f. Places & descriptions of them
      The word in the sentence indicating the answer refers to a place or an adjective describing a place
   g. Events, other nouns & descriptions of them
      The word in the sentence indicating the answer refers to an event (used as a noun) or an adjective describing an event
   h. Time & descriptions of them
      The word in the sentence indicating the answer refers to time or an adjective describing time
6. Question type
   a. Why 1 (someone or something did something)
   b. Why 2 (other: something happened, etc.)
   c. When 1 (temporal)
   d. When 2 (under what conditions)
   e. What
   f. Where
   g. Which
   h. Who
   i. How 1 (process)
   j. How 2 (others: how many, how long, et al.)
   k. How 3 (a person feels)
7. Degree to which answer-passage pair shares characteristic in word form.
   a. Exact match in word form: All words in the answer correspond to words in the passage. Use of inflectional suffixes -s, -es, -ed, -ing constitute a change in word form. Disregard auxiliary verbs (do, did, does), prepositions, articles, and conjunctions. For illustrations, there is 1:1 correspondence, topographic or otherwise (e.g., picture of a book—the written word book).
   b. Not exact match in word form: Some (at least 1, but not all) words in the answer correspond to words in the passage. Or, when word form changes due to the use of inflectional suffixes (-s, -es, -ed, -ing).
8. Degree to which answer-passage pair shares characteristic in word order
   a. Exact match in word order: All words in the answer that correspond to words in the passage are in the same order as in the passage, although other words may be between them.
   b. Not exact match in word order: Words in the answer that correspond to words in the passage are in a different order from how they appear in the passage.
9. Question Phrasing
   a. Standard: Begins with a “wh . . . ” or “how” question word and ends with a question mark
   b. Not: “Which of these is NOT . . . ”
   c. Cloze: Question includes a blank space(s) to which the reader must insert the appropriate word(s)
   d. Spatial (use of a shape or illustration such as a diagram that the learner must fill in)
10. Degree to which question-passage pair shares characteristics (same words).
   a. Literal: Following the “wh-or how” part of the question (see #6), all words correspond to words in the passage. Disregard word form (e.g., inflectional suffixes -s, -es, -ed, -ing) and order, auxiliary verbs (do, did, does), prepositions, articles, conjunctions, pronouns, & the word “thing” to describe an event.
   b. Interpretive (word or phrase meaning): Different words/phrases are used in the question & passage that indicate or describe the same item, event, etc.
   c. Interpretive (sequence): The question asks about a sequence, but the sequence is not explicitly stated in the passage. For example: “Which is the correct order of events?” when the passage does NOT say “The events occurred in the following order . . . ”
   d. Interpretive (prediction): The question asks a learner to predict the outcome of a series of events.
   e. Interpretive (likelihood): The question asks a learner to hypothesize about the most likely cause of an event.

### II. Inferential Comprehension: Critical Features and Variable Features

### A. Critical Features

1. Answer category must appear in passage
2. Answer-passage category match meets criteria specified in question
3. Answer overlap does not have 1 to 1 correspondence with words of passage

### B. Variable Features

1. Type of passage
   a. Narrative: In the form of a story, account, or tale
   b. Expository: Informs or explains an event, concept, or idea using facts
   c. Poetic: Most often written in stanzas, two or more words may rhyme
2. Length of passage
   a. one paragraph
   b. two-three paragraphs
   c. four+ paragraphs
3. Number of sentences in passage that contain answer or allow the reader to derive the full answer (some reference to the question & the answer).
   a. one: One sentence contains the full answer
   b. two: Two sentences are required to derive in the full answer
   c. three+: Three or more sentences are required to derive the full answer
4. Narrator (position from which story is being told)
   a. first person (I, we)
   b. second person (you or understood you)
   c. third person or expository impersonal (he, she, it, they)
5. Type of characteristic asked about in question
   a. Personal quality
      The answer to the question refers to a person's feelings, thoughts, desires, etc.
   b. Sequence: what followed
      Question or answer must include a word referring to a portion of the sequence in the story (e.g., next, after, before, first, last, etc.).
      The answer to the question refers to an event that happened last or followed/will follow an event. This can include people, events, etc.
   c. Sequence: what preceded
      Question or answer must include a word referring to a portion of the sequence in the story (e.g., next, after, before, first, last, etc.).
      The answer to the question refers to an event that happened first or preceded the event indicated in the question. This can include people, events, etc.
   d. Actions, events (as verbs), & descriptions of them
      b. The word in the sentence indicating the answer refers to a verb or word to describe a verb. If the answer refers to an event or action & also meets requirements to be scored as a sequence (5b or c), score as the appropriate sequence.
   e. Objects, & descriptions of them
      The word in the sentence indicating the answer refers to an object or an adjective describing an object.
   f. People, animals & descriptions of them
      The word in the sentence indicating the answer refers to a person or an adjective describing a person
   g. Places & descriptions of them
      The word in the sentence indicating the answer refers to a place or an adjective describing a place
   h. Events, other nouns & descriptions of them
      The word in the sentence indicating the answer refers to an event (used as a noun) or an adjective describing an event
   i. Time & descriptions of them
      The word in the sentence indicating the answer refers to time or an adjective describing time
6. Question type
   a. why 1 (someone or something did something)
   b. why 2 (other: something happened, etc.)
   c. when 1 (temporal)
   d. when 2 (under what conditions)
   e. what
   f. where
   g. which,
   h. who
   i. how (process)
   j. how (others: how many, how long, et al.)
   k. how (a person feels, what a person thinks, etc.)
7. Degree to which answer-passage pair shares characteristic
   a. One-category variation: (word/phrase meaning only) Different words/phrases are used in the answer & passage to indicate or describe the same event, item, etc.
   b. One-category variation: (sequence & word/phrase variation) Different ‘sequence’ words are used in the answer & passage to indicate order of events (for example, ‘second’ is the answer, but it says ‘next’ in the passage.
   c. One-category variation: (prediction, [involves next, sense of time] & word/phrase variation). Answer is a result of the reader predicting what occurred next
   d. One-category variation: (likelihood & word/phrase variation) Answer is the result of the reader predicting the likelihood that something will occur
   e. Two plus-category variations: Two or more of the above are combined. For example, answer is the result of the reader predicting the likelihood of an item in a sequence (where the learner also has to infer the step of the sequence.)
8. Question Phrasing
   a. Standard: Begins with a “wh . . . ” or “how” question word and ends with a question mark
   b. Not: “Which of these is NOT . . . ”
   c. Cloze: Question includes a blank space(s) to which the reader must insert the appropriate word(s)
   d. Spatial (use of a shape or illustration such as a diagram that the learner must fill in)
9. Degree to which question-passage pair shares characteristics (same words).
   a. Literal: Following the “wh-or how” part of the question (see #6), all words correspond to words in the passage. Disregard word form (e.g., inflectional suffixes -s, -es, -ed, -ing) and order, auxiliary verbs (do, did, does), prepositions, articles, conjunctions, pronouns, & the word “thing” to describe an event.
   b. Interpretive (word or phrase meaning): Different words/phrases are used in the question & passage that indicate or describe the same item, event, etc.
   c. Interpretive (sequence): Question includes a word referring to a portion of the sequence in the story (e.g., next, after, before, first, last, etc.)
   d. Interpretive (prediction): The question asks a learner to predict the outcome of a series of events.
   e. Interpretive (likelihood): The question asks a learner to hypothesize about the most likely cause of an event.

### III. Summative or Mostly About Skill: Critical Features and Variable Features

### A. Critical Features

1. Themes described in answer reflect characteristics in passage
2. More instances of one theme than of others

### B. Variable Features

1. Type of passage
   a. Narrative: In the form of a story, account, or tale
   b. Expository: Informs or explains an event, concept, or idea using facts
   c. Poetic: Most often written in stanzas, two or more words rhyme
2. Length of passage
   a. one paragraph
   b. two-three paragraphs
   c. four+ paragraphs
   d. Simple illustration (measurement, table of contents, etc.)
   e. Complex illustration
3. Number of items in passage that contain answer in proportion to items of other themes
   a. Large ratio of eg items to two neg items (5/1/0): Five sentences/phrases are about one theme (the eg); one sentence/phrase is about a second theme (a neg item); no sentence/phrases are about the third theme (a neg item). Ratio is approximate.
   b. Medium ratio of eg items to two neg items (5/3/1): Five sentences/phrases are about one theme (the eg); three sentences/phrases are about a second theme (a neg item); one sentence/phrase is about a third theme (a neg item). Ratio is approximate.
   c. Small ratio of eg items to two neg items (5/4/3): Five sentences/phrases are about one theme (the eg); four sentences/phrases are about a second theme (a neg item); three sentence/phrases are about a third theme (a neg item). Ratio is approximate.
4. Narrator (position from which story is being told)
   a. first person (I, we)
   b. second person (you or understood you)
   c. third person or expository impersonal (he, she, it, they), illustrations
5. Type of theme
   a. Personal quality
      The theme of the passage is about a person's feelings, thoughts, desires, etc.
   b. Actions, events (as verbs), & descriptions of them
      The theme of the passage is about actions or events
   c. Objects, & descriptions of them
      The theme of the passage is about an object or an adjective describing an object.
   d. People & descriptions of them
      The theme of the passage is about a person or an adjective describing a person
   e. Places & descriptions of them
      The theme of the passage is about a place or an adjective describing a place
   f. Events, other nouns & descriptions of them
      The theme of the passage is about an event (used as a noun) or an adjective describing an event
   g. Time & descriptions of them
      The theme of the passage is about time or an adjective describing time
6. Question Phrasing
   a. Standard: Begins with a “wh . . . ” or “how” question word and ends with a question mark
   b. Not: “Which of these is NOT . . . ”
   c. Cloze: Question includes a blank space(s) to which the reader must insert the appropriate word(s)
   d. Spatial (use of a shape or illustration such as a diagram that the learner must fill in)

### IV. Vocabulary Skill: Critical Features and Variable Features

### A. Critical Features

1. Words in answer categorically overlap with identified words in passage
2. Categorical overlap can be derived from sentence context

### B. Variable Features

1. Type of passage
   a. Narrative: In the form of a story, account, or tale
   b. Expository: Informs or explains an event, concept, or idea using facts
   c. Poetic: Most often written in stanzas, two or more words rhyme
   d. Illustration
2. Length of passage
   a. one paragraph
   b. two-three paragraphs
   c. four+ paragraphs
   d. Simple illustration (measurement, table of contents, etc.)
   e. Complex illustration
3. Number of sentences in passage required to derive answer
   a. One: One sentence contains the full answer.
   a. Two: Two sentences are required to obtain the full answer. (reference to question & answer)
   b. Three+: Three or more sentences are required to obtain the full answer.
   c. Illustration: 1 part of the illustration is needed to obtain the full answer
   d. Illustration+: More than 1 part of illustration or illustration plus text (not including the question) is needed.
   e. Not derivable: The surrounding context does not provide sufficient information for the learner to derive the answer.
4. Narrator (position from which story is being related)
   a. first person (I, we)
   b. second person (you or understood you)
   c. third person or expository impersonal (he, she, it, they)
5. Part of speech represented by new word being taught
   a. noun
   b. verb
   c. adjective
   d. adverb
   e. other (conjunction, pronoun, article)
6. Number of words being defined
   a. one
   b. two-three
   c. four+
7. Question Phrasing
   a. Standard: Begins with a “wh . . . ” or “how” question word and ends with a question mark
   b. Not: “Which of these is NOT . . . ”
   c. Cloze: Question includes a blank space(s) to which the reader must insert the appropriate word(s)
   d. Spatial (use of a shape or illustration such as a diagram that the learner must fill in)

### V. Skill for Using Resources Like Table of Contents, Rulers, Balance Scales, Diagrams, Maps or Measurement Instruments: Critical Features and Variable Features

1. The critical features and varying features for these skills are the same as one or more features for literal or inferential comprehension skills.

### APPENDIX B

Sequence 1:
JB
Vocab 3
Vocab 4
QTf prep
QTf
Sequence 2:
Vocab 3
Vocab 4
QTi Prep
QTf
Sequence 3:
QTd intro
QTd
Sequence 4:
Vocab 3
SE
QTs prep intro
Sequence 5:
QTs prep
Qts
Sequence 6
Vocab 4
QTn prep
QTn
QTd SV
QTd
Sequence 7
QTf
QTs
QTi
QTn
Sequence 8
QTd
QTdC
Sequence 9
Vocab 3
JB
Qv
Qdc4c
Qv
Qdc4
Sequence 10-14:
Vocab3
SE
Qv
Qdc4c
Qv
Qdc4
Sequence 15
Vocab 3
SE
R intro
R
R
Sequence 16, 17
Vocab 3
SE
Qv
Qdc4c
Qv
Qdc4
Sequence 18
Vocab 3
SE
RM intro
R
RM intro
R
Sequence 19
Qv
R
Qv
R
W2
Sequence 20
Vocab 3
SE
RM intro
R
W2
Sequence 21
Qv
R
Qv
QDc5
WG3
Sequence 22
Vocab 3
SE
Qv
Qdc5
Qv
Qdc5
Sequence 23
Vocab 3
SE
RR intro
R
Qv
Qdc5
R
Sequence 24
Vocab 3
SE
Qv
Qdc6
Qv
Qdc7

1. A system for creating routines to teach a learner a comprehension skill, the system comprising:
a skill identifier module configured to identify a skill to be taught;
an initial analysis module, communicatively coupled to the skill identifier module, configured to receive the identified skill and determine a feature of the skill; and
a routine sequencing module, communicatively coupled to the initial analysis module, configured to receive the determined feature and determine a sequence of one or more routines based on the determined feature.

2. The system of claim 1 wherein the determined feature is a critical feature or a varying feature of the identified skill and the initial analysis module comprises:
a critical feature identifier module for identifying the critical feature; and
a varying feature identified module for identifying the varying feature.

3. The system of claim 1 wherein the identified skill is literal comprehension.

4. The system of claim 1 wherein the identified skill is inferential comprehension.

5. The system of claim 1 wherein the identified skill is vocabulary or summative.

6. A system for performing routines to teach a learner a comprehension skill, the system comprising:
a skill identifier module configured to identify a skill to be taught;
a routine sequence determination module, communicatively coupled to the skill identifier module, configured to receive the identified skill and determine a routine sequence for the skill;
a controller, communicatively coupled to the routine sequence determination module, configured to transmit the determined routine sequence for presentation to the learner; and
a feedback module, communicatively coupled to the controller, configured to receive learner's response to the transmitted routine sequence and transmit appropriate feedback for presentation to the learner.

7. The system of claim 6 wherein the routine sequence determination module is communicatively coupled to the feedback module, the feedback module determines if the received learner's response is correct and transmits a result of response's determination to the routine sequence determination module, and the routine sequence determination module modifies the determined routine sequence based on the received result.

8. The system of claim 6 wherein the identified skill is literal comprehension.

9. The system of claim 6 wherein the identified skill is inferential comprehension.

10. The system of claim 6 wherein the identified skill is vocabulary or summative.

11. A method for creating routines to teach a learner a comprehension skill, the method comprising:
identifying a skill to be taught;
determining a feature of the identified skill; and
determining a sequence of one or more routines based on the determined feature.

12. The method of claim 11 wherein determining the feature comprises determining a critical feature or a varying feature of the identified skill.

13. The method of claim 11 wherein the identified skill is literal comprehension.

14. The method of claim 11 wherein the identified skill is inferential comprehension.

15. The method of claim 11 wherein the identified skill is vocabulary or summative.

16. A method for performing routines to teach a learner a comprehension skill, the method comprising:
identifying a skill to be taught;
determining a routine sequence for the identified skill;
transmitting a part of the determined routine sequence for presentation to the learner;
receiving learner's response to the transmitted part of the routine sequence; and
transmitting appropriate feedback for the received learner's response.

17. The method of claim 16 comprising:
determining if the received learner's response is correct; and
modifying the determined routine sequence based on whether the received learner's response is correct.

18. The method of claim 16 wherein the identified skill is literal comprehension.

19. The method of claim 16 wherein the identified skill is inferential comprehension.

20. The method of claim 16 wherein the identified skill is vocabulary or summative.
